(19) United States
(12) Patent Application Publication
(10) Pub. No.: US 2014/0178835 A1
(43) Pub. Date: Jun. 26, 2014

(54) Multi Functional Implanting Suite and Implanting Method Thereof

(71) Applicant: Chen-Yi Lin, Taichung City (TW)

(72) Inventor: Chen-Yi Lin, Taichung City (TW)

(21) Appl. No.: 14/080,730

(22) Filed: Nov. 14, 2013

(30) Foreign Application Priority Data
Nov. 14, 2012 (TW) 101142423

(51) Int. Cl. A61C 1/08; A61C 9/00; A61C 13/34; A61C 8/00

(52) U.S. Cl. CPC A61C 1/084; A61C 8/0089; A61C 8/008; A61C 8/0001; A61C 9/0053; A61C 13/34
USPC 433/173

(57) ABSTRACT

A multi functional implanting suite for an implant utilized in tooth reconstruction, artificial tooth implanting or dental restoration is disclosed. The implanting suite comprises a cap and a fastening member, in which it may be equipped with multi functions including healing abutment, scan jig, mold taking suite, temporary crown or UCLA abutment, so that the dental clinics may merely purchase one dental tool and then solve may tooth reconstruction, artificial tooth implanting or dental restoration situations.

### CROSS-REFERENCE TO RELATED APPLICATION

This application claims priority to and the benefit of Taiwan Patent Application No. 101142423 filed in the Taiwan Intellectual Property Office (TIPO) on Nov. 14, 2012, the entire contents of which are incorporated herein by reference.

### BACKGROUND OF THE INVENTION

1. Field of the Invention

The present invention relates to an implanting suite utilized in tooth reconstruction, artificial tooth implanting or dental restoration, and particularly to a multi functional implanting suite and the implanting method thereof, which have multi functions including implanting abutment, healing abutment, scan jig, modeling transfer and UCLA abutment.

2. Description of Related Art

Human eat and take food for their life relying on teeth. However, people normally treat the teeth with carelessness and don't seriously take care of teeth, therefore decayed tooth or missing tooth are sometimes occurred. In this reason, dental restoration is more and more popular, so that the dental clinics also come into vogue.

Traditionally, taking mold from mouth for fabricating a dental crown or a customized abutment normally needs the technology of impression coping, placing an implant into the underlying bone of mouth arch, taking mold of arch contour so as to recognize the position of the implant, plaster modeling through the plaster cast, and then disposing the UCLA abutment on a working model to pile up the wax. In this manner, the dental crown or the customized abutment are eventually achieved. When 3D scan for tooth contour of mouth arch is desired, additional scan jig is inevitably required so that the mold taken is able to be precise. Besides, the healing abutment covered on the implant which engages with the underlying bone is also needed, so that the healing or recovery of the gingival tissue may be ensured with safety. The arrangement of the healing abutment may also have function of preventing some small pieces from entering the underlying bone or the implant. In some better oral condition of the mouth, a temporary crown could be directly connected on the implant, such that the patient might chew some soft food to have normal eating.

However, the aforementioned healing abutment, scan jig, mold taking suite, temporary crown or UCLA abutment traditionally needs to be equipped and then operated respectively; namely, each one of those tools merely can be exploited in one circumstance, lacking of universal and so that cannot be applied in all situation. All of those dental tools are small-volume production of a wide range of different items. In this manner, preparation of those dental tools is troublesome and the cost of dentistry is also higher.

Therefore, it is a critical issue to have a dental kit which may replace the healing abutment, scan jig, mold taking suite, temporary crown or UCLA abutment, so that the dental clinic may purchase only one tool and then be applied in many dentistry conditions, to achieve cost-down in the situation of tooth reconstruction, artificial tooth implanting or dental restoration.

### SUMMARY OF THE INVENTION

The primary object of the present invention is to have dental tool equipped with multi functions including healing abutment, scan jig, mold taking suite, temporary crown or UCLA abutment, so that the dental clinics may merely purchase one dental tool and then solve may tooth reconstruction, artificial tooth implanting or dental restoration situations.

To achieve the above purposes, a multi functional implanting suite for an implant utilized in tooth reconstruction, artificial tooth implanting or dental restoration is disclosed. The implanting suite comprises a cap and a fastening member. The cap has a main body, an inserting hole disposed in the main body and communicated to exterior of the main body, and a recognizing portion disposed around outside of the main body. The fastening member has a positioning portion, a flange and a connecting portion, wherein the positioning portion and the connecting portion are respectively disposed at both axial ends of the fastening member, with the positioning portion detachably inserted into the inserting hole in specific orientation or specific azimuth, so that the flange is abutted against the main body and the connecting portion is detachably inserted into the implant.

To achieve the above purposes, a multi functional implanting suite for an implant utilized in tooth reconstruction, artificial tooth implanting or dental restoration is disclosed. The implanting suite comprises a cap and a fastening member. The cap has a main body, an inserting hole disposed in the main body and connected to exterior of the main body, a recognizing portion disposed at outside of the main body, and a fitting portion faced toward and detachably engaged to the implant. The fastening member has an abutting portion and a connecting portion, wherein the abutting portion and the connecting portion are respectively disposed at both axial ends of the fastening member, with the fastening member detachably inserted into the inserting hole, the abutting portion abutted against the inserting hole, and the connecting portion detachably inserted into the implant.

To achieve the above purposes, a multi functional implanting method for an implant suite utilized in tooth reconstruction, artificial tooth implanting or dental restoration is disclosed. The implanting method comprises the following steps: step A11: placing the implant in the underlying bone; step A2: inserting the implanting suite into the implant, and engaging the fastening member and the implant; step A3: selectively grinding the cap in the mouth; step A4a: sewing the gingiva around the cap, to make appearance of the main body around the gingiva correspond to the gingiva mutually; step A4b: selectively filling the filling material into the inserting hole to adhere the cap and the fastening member.

To achieve the above purposes, a multi functional implanting method for an implant suite utilized in tooth reconstruction, artificial tooth implanting or dental restoration is disclosed. The implanting method comprises the steps: placing an implant in the underlying bone; engaging a cap with the implant; inserting a fastening member such that the cap and the implant is engaged and fastened; oral modeling through an impression material; separating the fastening member, impression material or the cap; engaging a replica with the cap; modeling the impression material.

In this manner, the multi functional implanting suite and the implanting method may have the following advantages:

1. The dentists may have simplified and convenient way to design a dental crown and a customized abutment, and be able to fabricate the dental prosthesis accurately, so that 3D (3-dimensions) dentistry digitization is hence achieved.

2. Patient's mouth arch and oral condition are easily copied and recorded through the plaster mold reconstruction, in which a simplified way with cost-down is achieved.

3. The multi functional implanting suite and implanting method may be served as healing abutment, scan jig, mold taking suite, temporary crown or UCLA abutment in prosthesis fabrication or dental restoration, so that the implanting suite and the implant method of the present invention may have many functions, to replace traditional utilization of plurality of dentistry kits.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1˜FIG. 4 are diagrams with sectional view of several embodiments of the implanting suite;

FIG. 5A, 5B and FIG. 6 are diagrams with perspective view of several embodiments of the implanting suite;

FIG. 7 is flow chart of implanting method of the 1st embodiment;

FIG. 8 is flow chart of implanting method of the 2nd embodiment;

FIG. 9 is flow chart of implanting method of the 3rd embodiment;

FIG. 10A˜10E are diagrams for decomposition movements of the implanting suite of the 1st embodiment;

FIG. 11A˜11M are diagrams for decomposition movements of the implanting suite of the 2nd embodiment;

FIG. 12A˜12B are diagrams for decomposition movements of the implanting suite of the 3rd embodiment;

FIG. 13A˜13D are diagrams for decomposition movements of the implanting suite of the 4th embodiment;

FIG. 14A˜14K are diagrams for decomposition movements of the implanting suite of the 5th embodiment;

FIG. 15A˜15D are diagrams for decomposition movements of the implanting suite of the 6th embodiment;

FIG. 16˜24 are diagrams with sectional view of yet some embodiments of the implanting suite;

FIG. 25˜28 are diagrams with sectional view of yet some embodiments of the cap;

FIG. 29A˜29E are diagrams for decomposition movements of the implanting suite of the 7th embodiment;

FIG. 30 is flow chart of implanting method of the 8th embodiment;

FIG. 31A˜31H are diagrams for decomposition movements of the implanting suite of the 8th embodiment;

FIG. 32˜34 are diagrams with sectional view of another embodiments of the implanting suite.

### DETAILED DESCRIPTION OF THE PREFERRED EMBODIMENTS

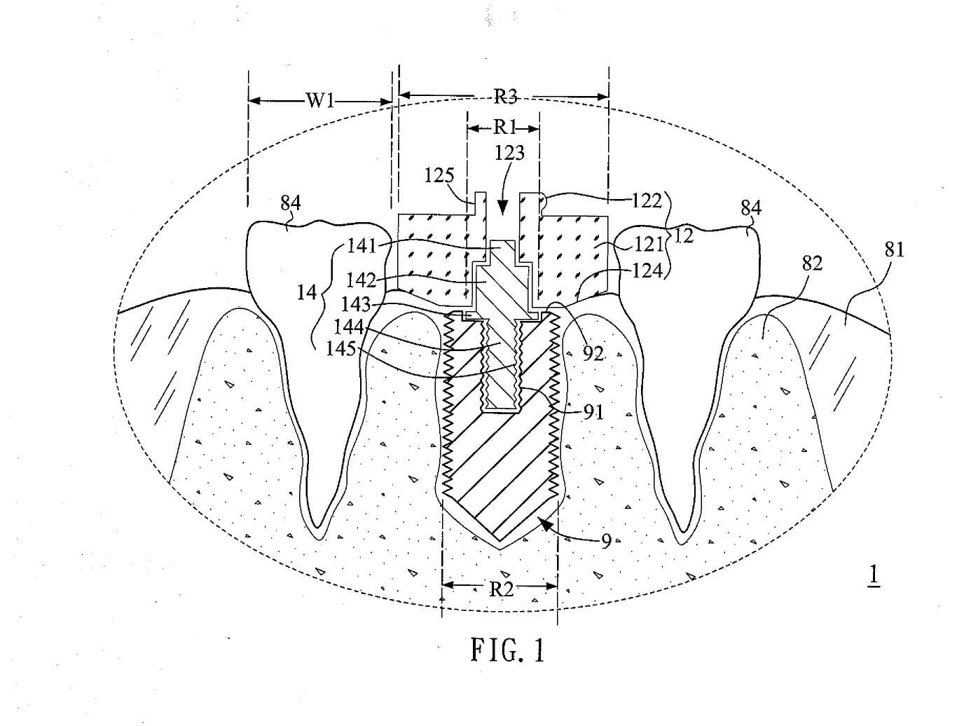

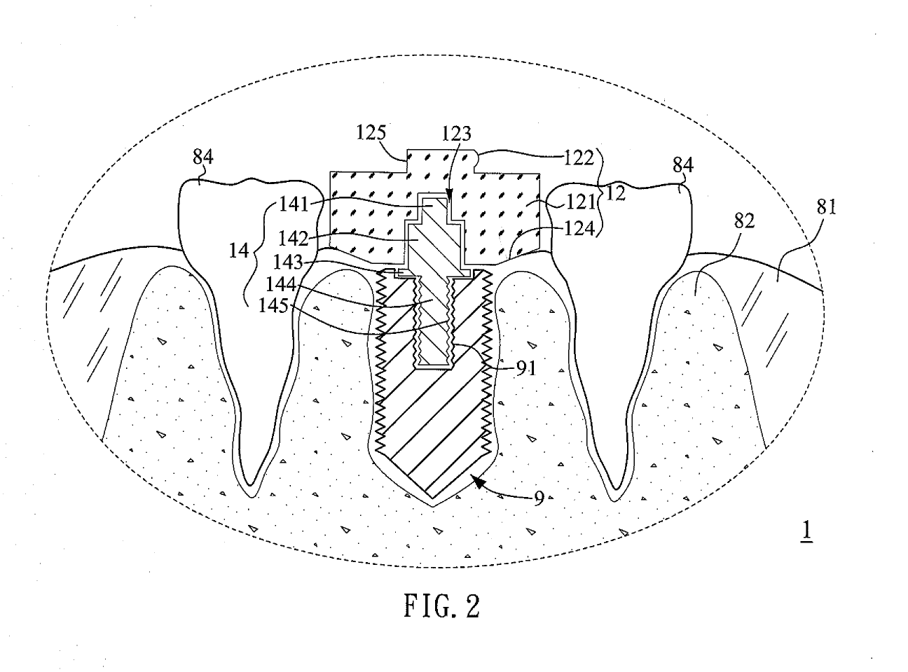

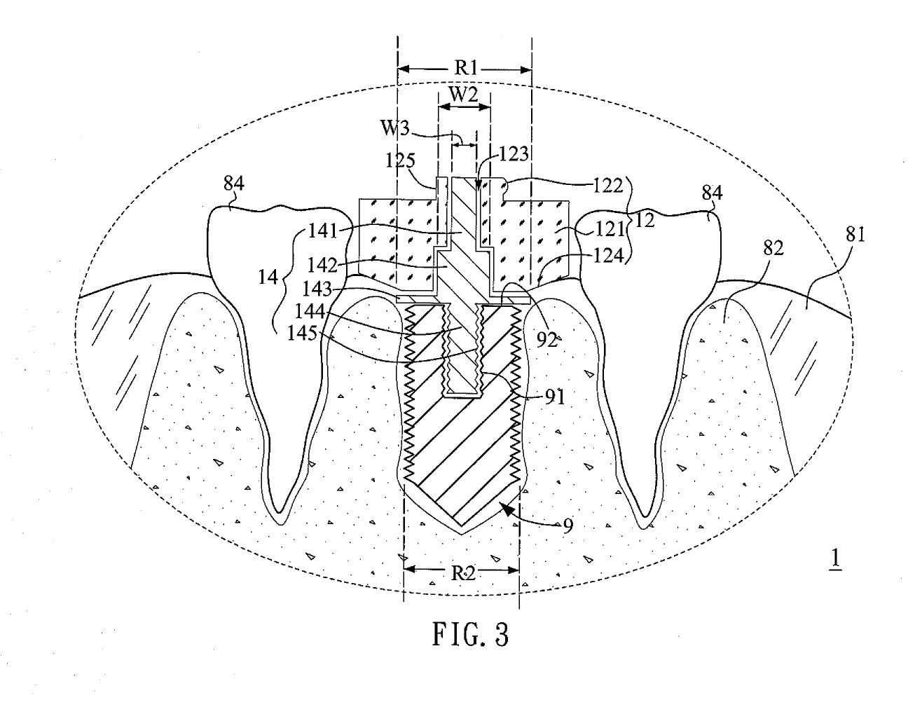

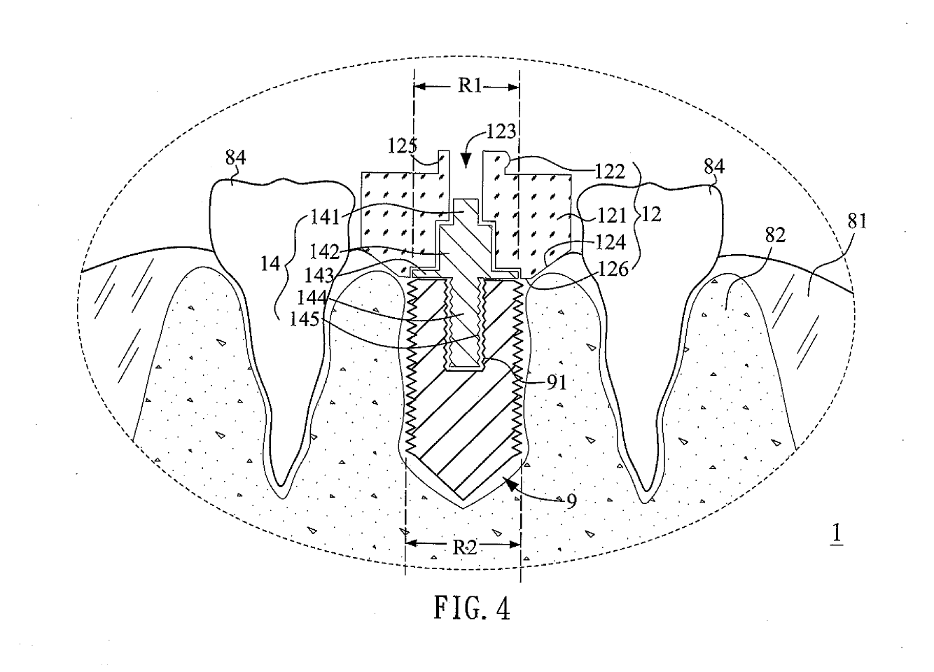

Please refer to FIG. 1, the present invention discloses an implanting suite 1 for an implant 9 utilized in tooth reconstruction, artificial tooth implanting or dental restoration. The implanting suite 1 has a cap 12 and a fastening member 14, in which the cap 12 and the fastening member 14 are detachably connected or separated; i.e. the cap 12 and the fastening member 14 are selectively fastened together or separated. The cap 12 has a recognizing portion 122, a inserting hole 123 and a main body 121. The recognizing portion 122 is disposed around upper outside of the main body 121 (preferably located at outer surface of the main body 121). The inserting hole 123 is disposed in the main body 121 and communicated to the exterior of the main body 121. In the embodiment of FIG. 1, the inserting hole 123 is vertically passed through both of the recognizing portion 122 and the main body 121; namely the inserting hole 123 is upwardly and downwardly communicated to the exterior of the main body 121. The fastening member 14 has a positioning portion 142, a flange 143, and a connecting portion 144. The positioning portion 142 and the connecting portion 144 are respectively disposed at two axial ends (i.e. vertically orientation) of the fastening member 14, with the positioning portion 142 disposed at upside of the fastening member 14 and the connecting portion 144 disposed at downside the fastening member 14. The positioning portion 142 is detachably inserted upwardly into the inserting hole 123, such that the flange 143 is able to abut the downside of the main body 121, and the connecting portion 144 is able to detachably insert into the implant 9. In this embodiment, the implant 9 has an internal bore 91 and the connecting portion 144 has a thread 145 disposed at outer surface of the connecting portion 144; the internal bore 91 and the thread 145 may be detachably engaged, such that the fastening member 14 may be selectively screwed and fastened on the implant 9, through the coupling (i.e. the engagement) of the connecting portion 144 and the internal bore 91 of the implant 9. Besides, the diameter R1 of the flange 143 is smaller than the diameter R2 of the implant 9. In this manner, the flange 143 may be received in the implant 9 if the connecting portion 144 is downwardly inserted into the implant 9. Namely the flange 143 may be disposed beneath the top area 92 of the implant 9 when the fastening member 14 is fastened to the implant 9 through the insertion of the connecting portion 144 (which is located at downside of the fastening member 14). Additionally, the fastening member 14 may be further has a head 141 disposed/connected at upside of the positioning portion 142, such that the head 141 and the connecting portion 144 are respectively disposed at different ends of the fastening member 14. In this manner, the outer surface/contour or surrounding of the head 141 may be matched with inner wall of the inserting hole 123 when the positioning portion 142 is moved upward to insert into the inserting hole 123, preferably with tightly fitted. This may have advantage for improving the mechanical strength of combination between the cap 12 and the fastening member 14, such that loosing or falling down of the cap 12 from the fastening member 14 is hence prevented. In some other embodiments, the head 141 could be omitted. Besides, the cap 12 may further have an adapting face 124 located at (preferably corresponded with) surrounding of the gingival 81 or disposed at site which is adjacent to/next to the implant 9, such that the cap 12 may be properly fitted to or suited to the lumpy (i.e. with irregular surface) gingival 81 through the adapting face 124 while the cap 12 of the implanting suite 1 is connected with the fastening member 14 or disposed on the implant 9. As shown in FIG. 1, the adapting face 124, could be flat or curve surface, is a chamfer structure with tilted surface disposed at downside of the main body 121, therefore the adapting face 124 may be matched with the lumpy gingival 81. Moreover, the cap 12 is cuttable, grindable or polishable, and could be made of plastics, resin, rubber, acrylic, polymer, macromolecular compounds, or Polymethylmethacrylate (PMMA), etc; therefore the appearance or outer contour of the cap 12 can be modulated, trimmed or regulated. The diameter R3 of the cap 12 is preferably greater than or equal to the cross-sectional width W1 of the tooth 84, such that the cap 12 may have enough volume to be cut, ground, trimmed or polished. In this manner, the outer contour or appearance of the cap 12 is able to be designed or formed. The function for cutting, grinding, trimming or polishing the cap 12 will be addressed later. Notice that tooth 84 is roughly pillar with irregular contour, and that the cross-sectional width W1 is the maximum width measured from sectional views of different orientations/vectors taken from the tooth 84.

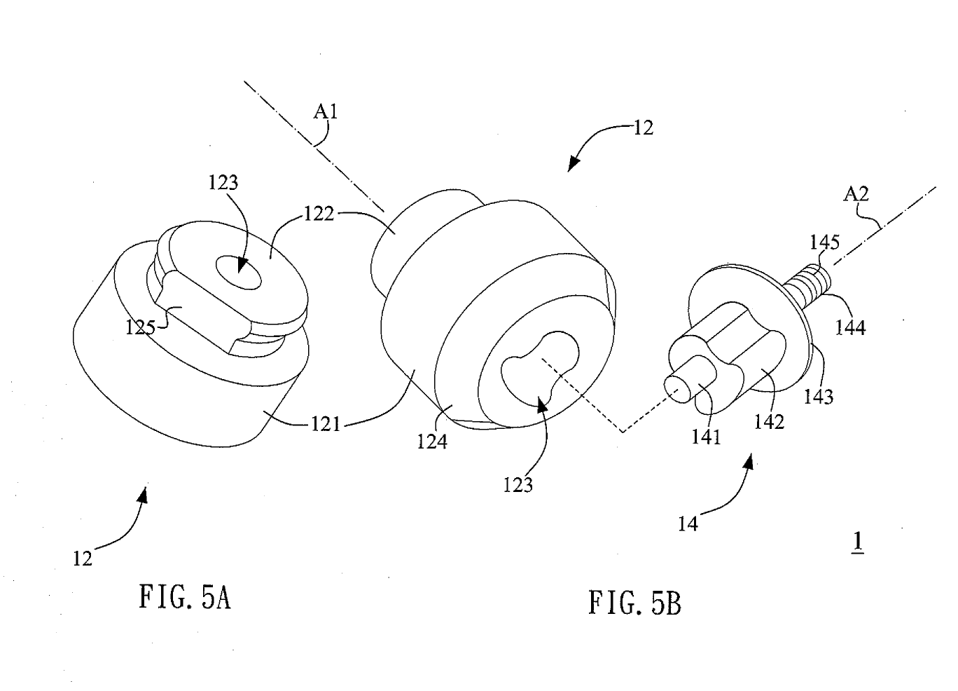

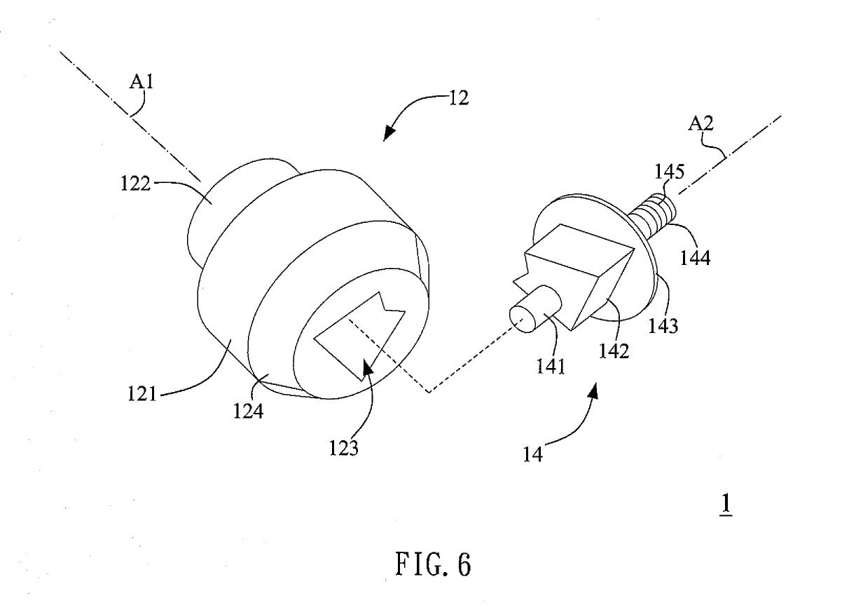

Please simultaneously refer to FIG. 5A and FIG. 5B, the recognizing portion 122 of the cap 12 further includes an information area 125 for positioning/guiding in location, position or orientation. The information area 125, could be extruded, hollow, caved, gapped, indent, breached or convex etc., reveals distinguishable and recognizable from the recognizing portion 122, such that the information area 125 may be verified or clarified through the computer software or human's eyes. Additionally, the inserting hole 123 may be tilted. As shown in FIGS. 1, 5A and 5B, the inserting hole 123 defines a first axle A1, and the fastening member 14 defines a second axle A2. The first axle A1, second axle A2 and the axial direction of the implant 9 are preferably kept in the same orientation if the cap 12 and the fastening member 14 are fastened/engaged with the implant 9. However in some specific oral condition, one of the first axle A1, the second axle A2 or the axial direction of the implant 9 may have intersection angle with the others, such as that the cap 12 of FIG. 1 may reveal slightly tilted. Besides, the inserting hole 123 disposed at beneath of the cap 12 may demonstrate calabash shaped (might be some other curve shaped) at the surrounding of the adapting face 124. Correspondingly, the positioning portion 142 of the fastening member 14 also demonstrates calabash shaped at outer contour. In this manner, the positioning portion 142 of the fastening member 14 is upwardly inserted into the inserting hole 123 along with the direction of the first axle A1 by specific orientation and specific azimuth. Namely the information area 125 is disposed at specific orientation, specific rotational orientation and specific location/position relative to the fastening member 14, if the cap 12 is connected with the fastening member 14. Therefore the positioning portion 142 may merely be inserted into the inserting hole 123 by particular vector and particular azimuth, which means that any arbitrary rotation of the positioning portion 142/fastening member 14 can not be made.

Please refer to FIG. 2, the inserting hole 123 of the cap 12 in this embodiment is only downwardly communicated with the exterior of the main body 121, without upwardly communicated. Namely the inserting hole 123 does not pass through the recognizing portion 122, therefore the head 141 of the fastening member 14 or the upside of the positioning portion 142 may be blocked, covered or encompassed through the recognizing portion 122 if the fastening member 14 is upwardly moved and inserted into the inserting hole 123.

Please refer to FIG. 3, the inserting hole 123 is vertically passed through the main body 121 and the recognizing portion 122 of the cap 12 in this embodiment. Besides, the head 141 of the fastening member 14 is longer than the embodiment of FIG. 1. Therefore the top of the head 141 and the top of the recognizing portion 122 may be approximately located at the same level (could be identical altitude) if the fastening member 14 is upwardly inserted into the inserting hole 123. Moreover, the diameter R1 of the flange 143 is greater than the diameter R2 of the implant 9. Therefore the flange 143 may be disposed above the top area 92 of the implant 9 while the connecting portion 144 is screwed and engaged with the implant 9. In this manner, the flange 143 is disposed between the cap 12 and the implant 9, such that the cap 12 is directly abutted against the upside of the flange 143, and the implant 9 is directly abutted against the beneath of the flange 143. In preferable embodiment, the diameter R1 of the flange 143 is greater than or equal to the cross-sectional width W2 of the positioning portion 142, and the cross-sectional width W2 of the positioning portion 142 is greater than or equal to the cross-sectional width W3 of the head 141; i.e. R1□W2□W3. In this manner, the flange 143, the positioning portion 142 and the head 141 may form stair-shaped (could be stagger or brick shaped) contour or appearance at the radial exterior of the fastening member 14. Therefore the fastening member 14 may contact with inner wall of the inserting hole 123 through larger exterior surface of the fastening member 14; larger contact surface means that greater friction is generated between the cap 12 and the fastening member 14, and hence the combination of the cap 12 and the fastening member 14 is also reinforced. Thus, loosing or falling down of the cap 12 or the fastening member 14 is prevented. In the embodiments of FIG. 5B and FIG. 6, the positioning portion 142 is a pillar with irregular or uneven shape, and the cross-sectional width W2 is the maximum width measured from sectional views of different orientations/vectors taken from the positioning portion 142. Likewise, the head 141 also could be a pillar with irregular or uneven shape, and the cross-sectional width W3 is the maximum width measured from sectional views of different orientations/vectors taken from the head 141. As shown in FIG. 5B and FIG. 6, the head 141 is a cylinder, and the cross-sectional width W3 of the head 141 is equal to the diameter of the head 141.

Please refer to FIG. 4, the diameter R1 of the flange 143 is equal to the diameter R2 of the implant 9. The flange 143 is received in the main body 121 if the positioning portion 142 is upwardly moved and inserted into the inserting hole 123 of the cap 12. Namely the flange 143 is disposed above the bottom area 126 of the main body 121.

Please refer to FIG. 6, the purpose of the positioning portion 142 is to help the fastening member 14 to match with the inserting hole 123 (or the cap 12) in a particular orientation and particular azimuth. As shown in FIG. 6, the inserting hole 123 has polygon shape and the positioning portion 142 is polygon pillar, such that the inserting hole 123 and the positioning portion 142 is able to be matched and therefore engaged, and then the fastening member 14 is able to be connected with the cap 12 in a specific orientation and specific azimuth. Notice that the contour of the inserting hole 123 or the outer shape of the positioning portion 142 might be some other shaped. In a word, the positioning portion 142, is a non-cylinder structure, matches with downside of the inserting hole 123 such that the fitting of the cap 12 and the fastening member 14 has specific directionality.

For more descriptively disclosing the functions or utilizations of the implanting suite 1, some other embodiments with different configurations or methods are addressed later. For simplifying the disclosure, the configuration of FIG. 1 is introduced to the following embodiments. Indeed, the embodiments of the FIG. 2˜6 can also be utilized in the following flow charts to address the implanting method of the present invention.

### 1st Embodiment

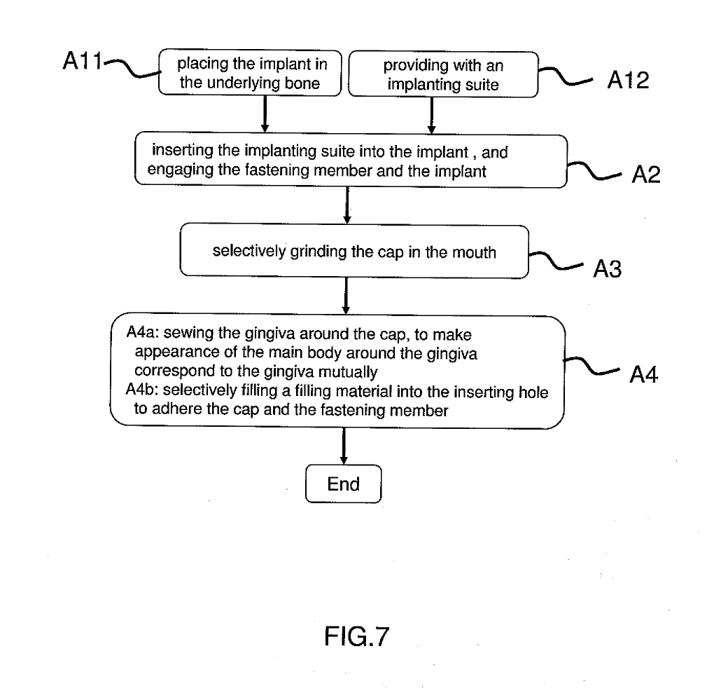

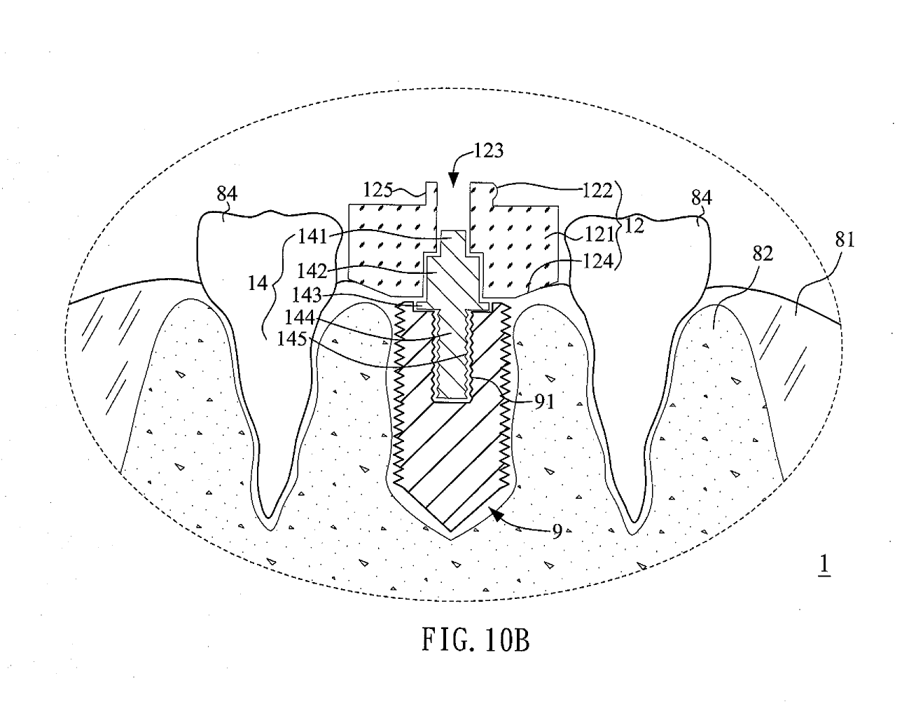

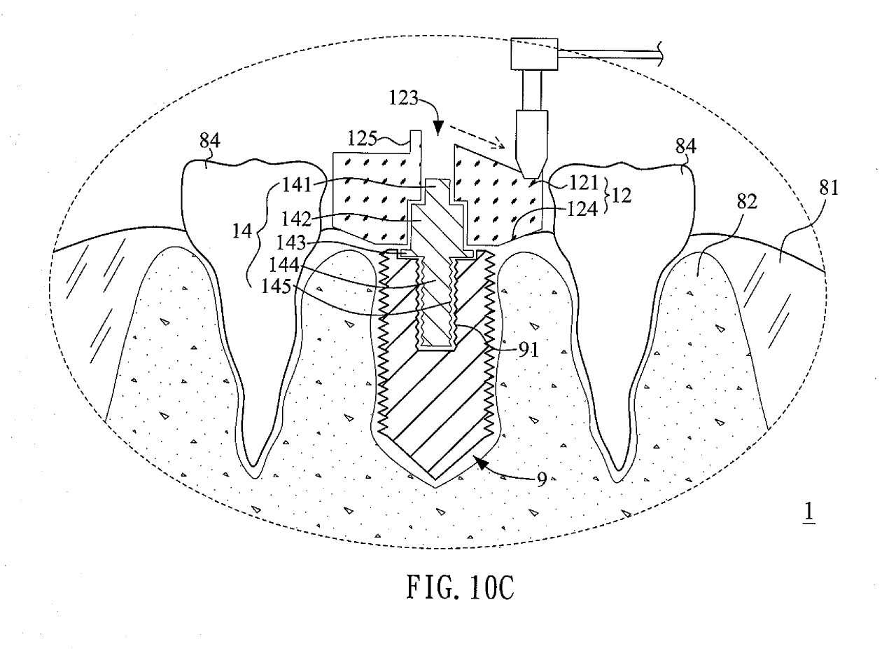

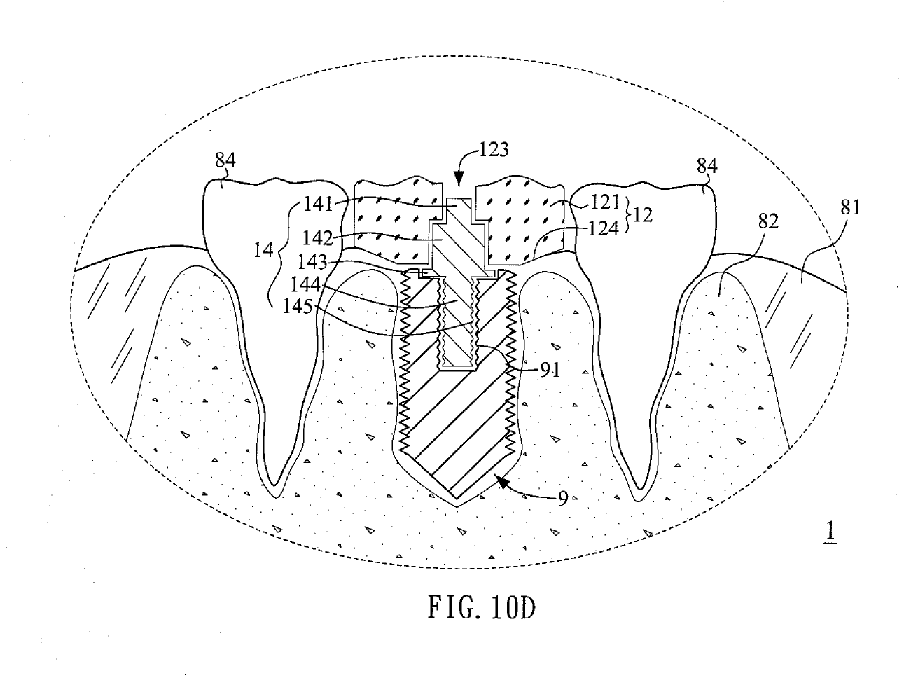

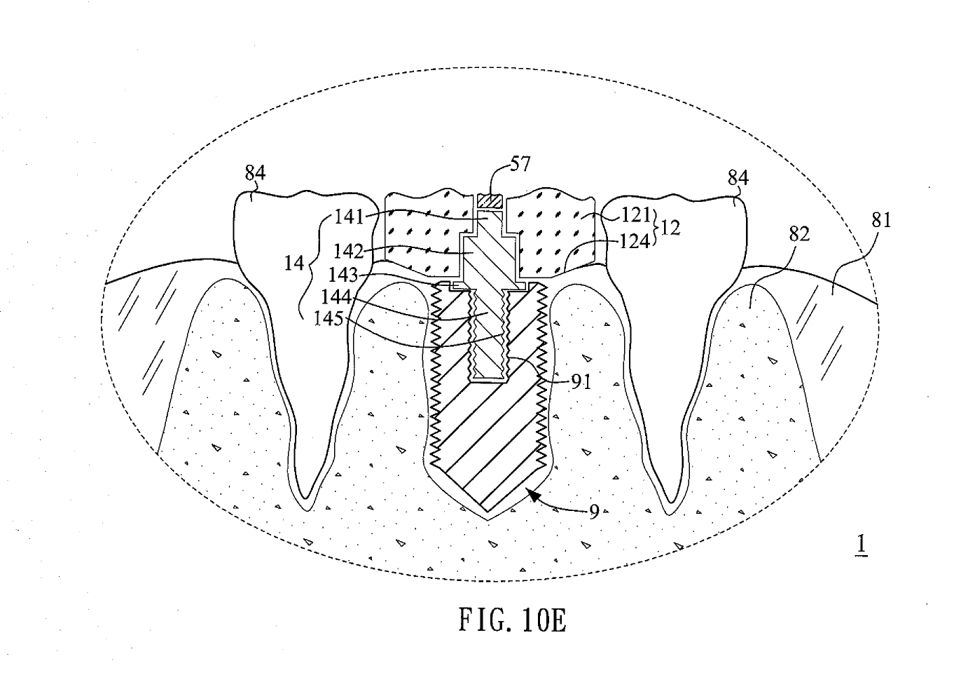

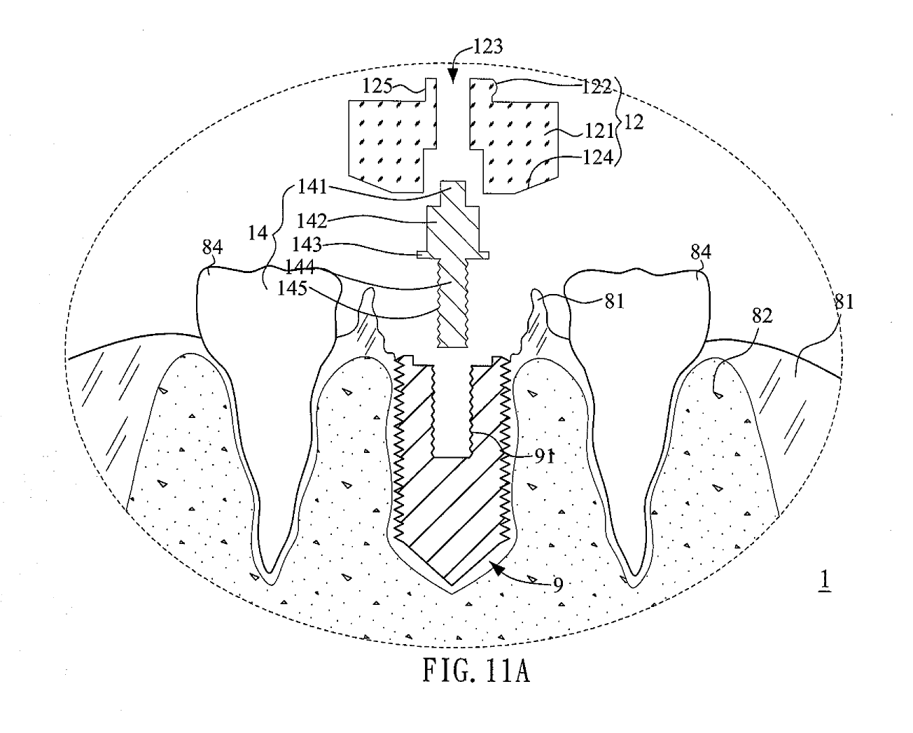

Please refer to FIG. 7 and FIG. 10A˜10E, the function or the purpose of the implanting suite 1 and the cap 12 is to achieve healing abutment in dentistry or dental clinics. As shown in FIG. 7, the implanting method of the first embodiment has the following steps:

Step A11: placing the implant 9 in the underlying bone 82. After the implant 9 is placed, the implant 9, as shown in FIG. 10A, is located in the underlying bone 82. More descriptively, the gingiva 81 tissue normally needs to be incised and then opened, so as to have the implant 9 placed in the underlying bone 82.

Step A12: providing with an implanting suite 1; wherein the implanting suite 1 provided in the dental clinics could be any embodiment disclosed in the present invention. Notice that the Step A12 could be progressed before/after the Step A11, or even concurrently progressed with the Step A11.

Step A2: inserting the implanting suite 1 into the implant 9, and engaging the fastening member 14 and the implant 9. After engagement, the cap 12 and the fastening member 14 of the implanting suite 1 will be disposed on the implant 9, which is demonstrated in FIG. 10B. The engaging step of Step A2 may have the cap 12 engaged with the fastening member 14 and afterward have the connecting portion 144 of the fastening member 14 downwardly inserted into the implant 9; alternatively, the Step A2 may have the connecting portion 144 of the fastening member 14 downwardly inserted into the implant 9 and afterward have the cap 12 engaged with the upside of the fastening member 14. Besides, the positioning portion 142 and the head 141 of the fastening member 14 are both located inside the inserting hole 123 of the cap 12. The matching/coupling of the cap 12 and the fastening member 14 is preferably tightly-fit. Moreover, the connecting portion 144 disposed at downside of the fastening member 14 is screwed to fasten to the implant 9 through thread.

Step A3: selectively grinding the cap 12 in the mouth; wherein grinding could means rubbing, cutting, polishing or trimming. In order to let the cap 12 of the implanting suite 1 have function of healing abutment in dentistry, the cap 12 needs to be properly ground (i.e. form the outer contour or appearance of the cap 12), so as to have the ground cap 12 suited with or corresponded to profile of the tooth 84 or the gingiva 81 tissue. As shown in FIG. 10C, upside of the cap 12 is ground, and the ground sites could be the recognizing portion 122 or merely part of the main body 121 (i.e. recognizing portion 122 is remained without ground). After ground, topside of the cap 12, as shown in FIG. 10D, may be suited with top surface of the neighboring tooth 84. In dental clinics, the Step A3 could be selectively made; namely the ground process may be omitted if the original profile of the cap 12 is already suitable. In practice, the Step A3 and Step A2 are exchangeable; namely part of the main body 121 is ground (i.e. Step A3) and afterward the implanting suite 1 is combined with implant 9 (i.e. Step A2).

Step A4: sewing the gingiva 81 around the cap 12, to make appearance of the main body 121 around the gingiva 81 correspond to the gingiva 81 mutually (Step A4a), and selectively filling a filling material 57 into the inserting hole 123 to adhere the cap 12 and the fastening member 14 (Step A4b). The filling material 57 filled into the inserting hole 123, to level up the inserting hole 123, is demonstrated in FIG. 10E. To be specifically, the gingiva 81 needed to be sewn is the area suffered incision and waited for implanting (shown in FIG. 10A); the gingiva 81 sewn may help the gingiva 81 tissue healing and prevent the tissue from further bleeding. Besides, the filling material 57 is preferably resin or some other sticking materials. In the circumstance of the cap 12 utilized and shown in FIG. 3, the top of the head 141 is approximately located at the same level with the top of the cap 12, therefore the filling material 57 merely have function for adhering the cap 12 to the fastening member 14, so as to prevent the cap 12 from loosing or falling down. In the circumstances of the cap 12 utilized and shown in FIG. 1 and FIG. 4, the head 141 is shorter or the even the head 141 is omitted, therefore the filling material 57 not only can adhere the cap 12 to the fastening member 14, but also can level the inserting hole 123 up. In the present invention, the Step A4a may be progressed before/after the Step A4b, or even concurrently progressed with the Step A4b. However in some other embodiments, the Step A4a for the gingiva 81 sewing may also be progressed before/after the Step A11, A12, A2 or Step A3, or even concurrently progressed with the Step A11, A12, A2 or Step A3. In this manner, the cap 12 or the implanting suite 1 may serve as healing abutment for gingiva 81 healing or recovery, if Step A4 is made in dentistry.

### 2nd Embodiment

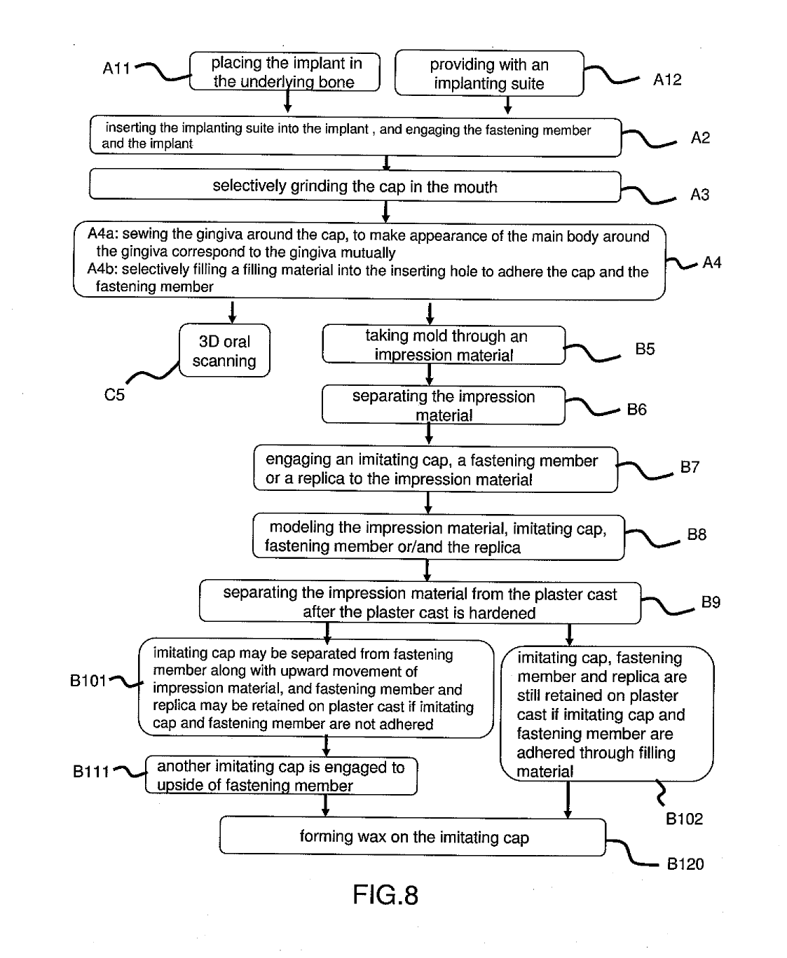

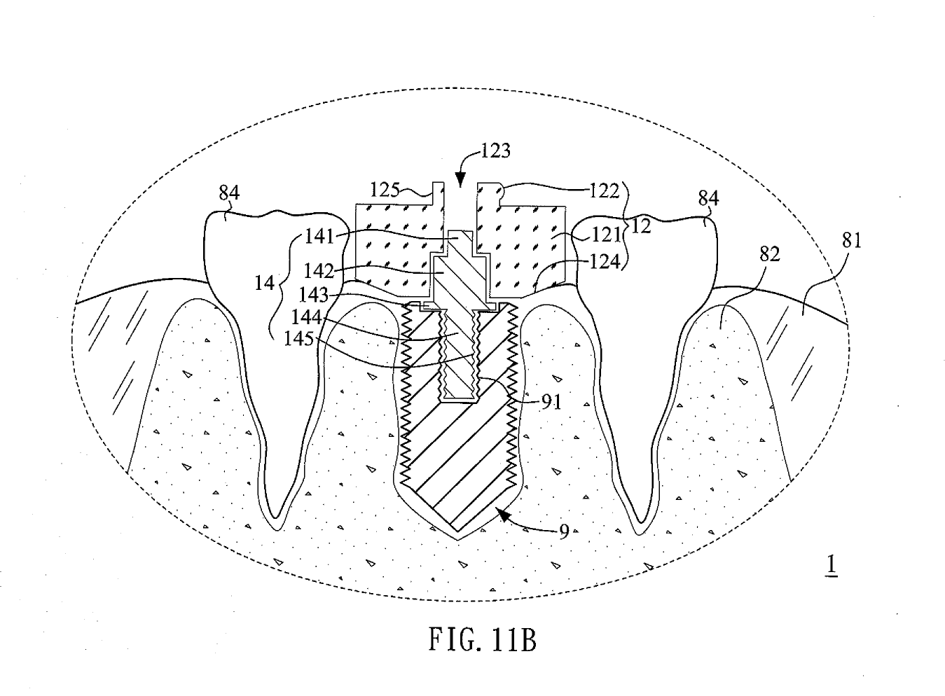

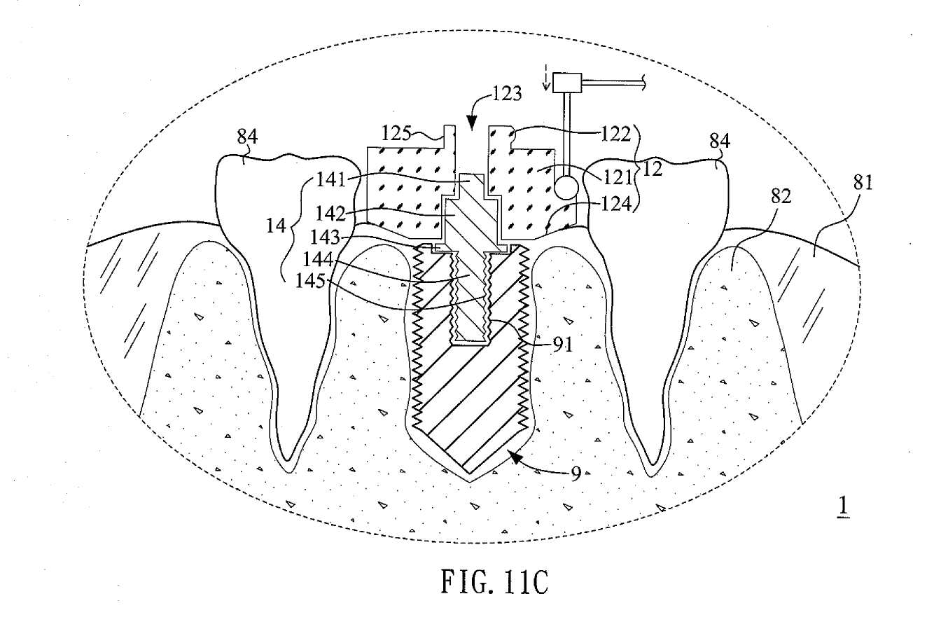

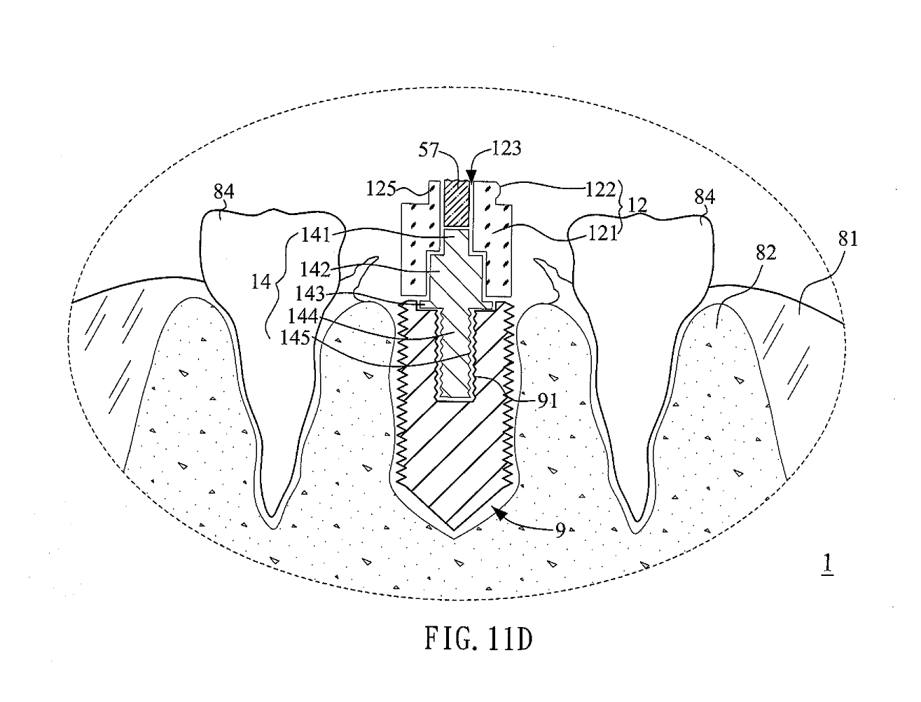

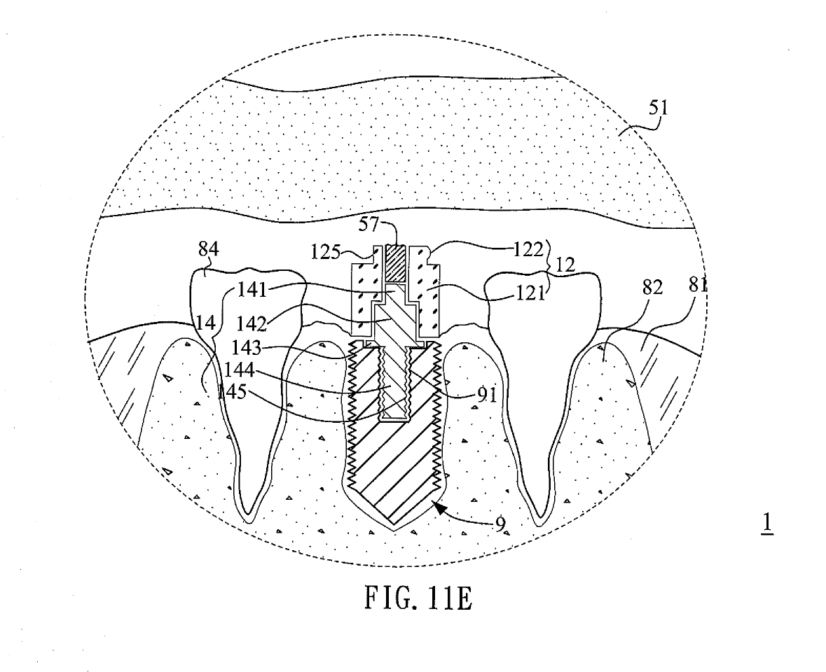

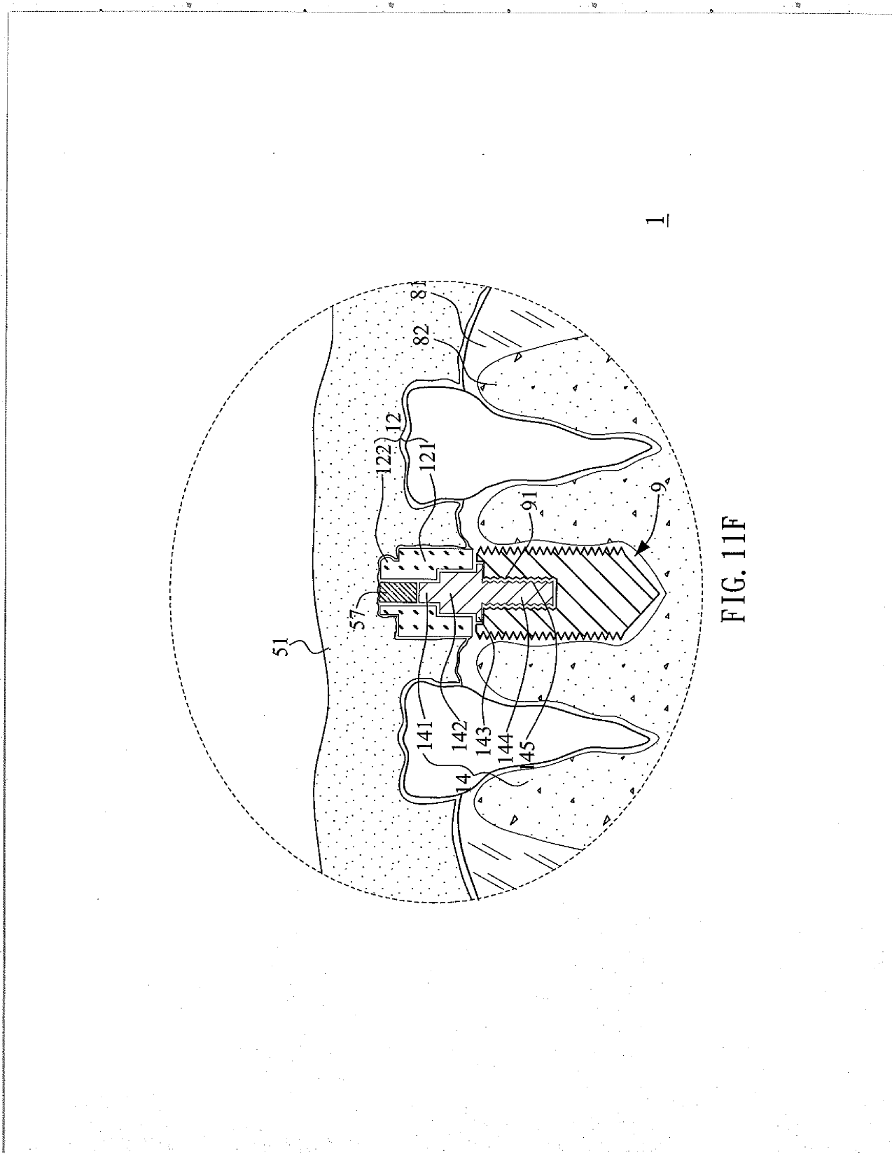

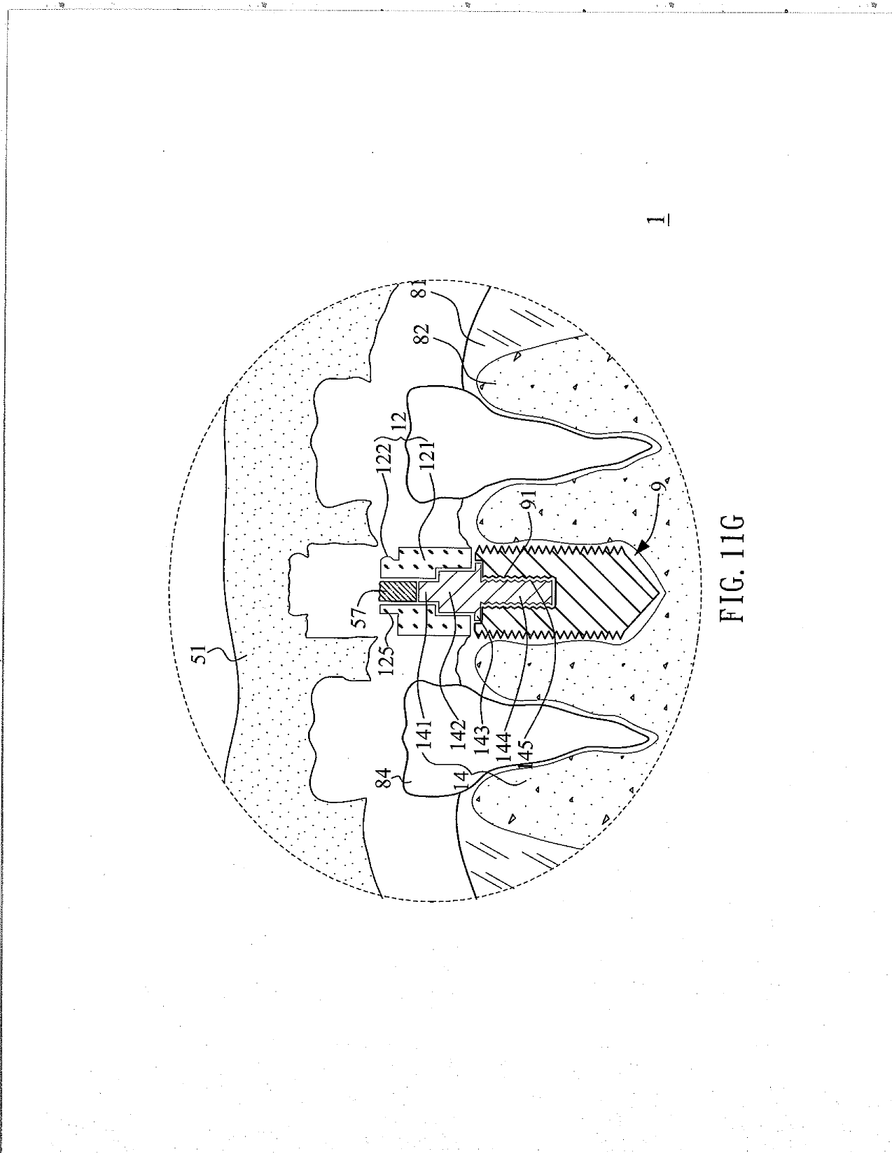

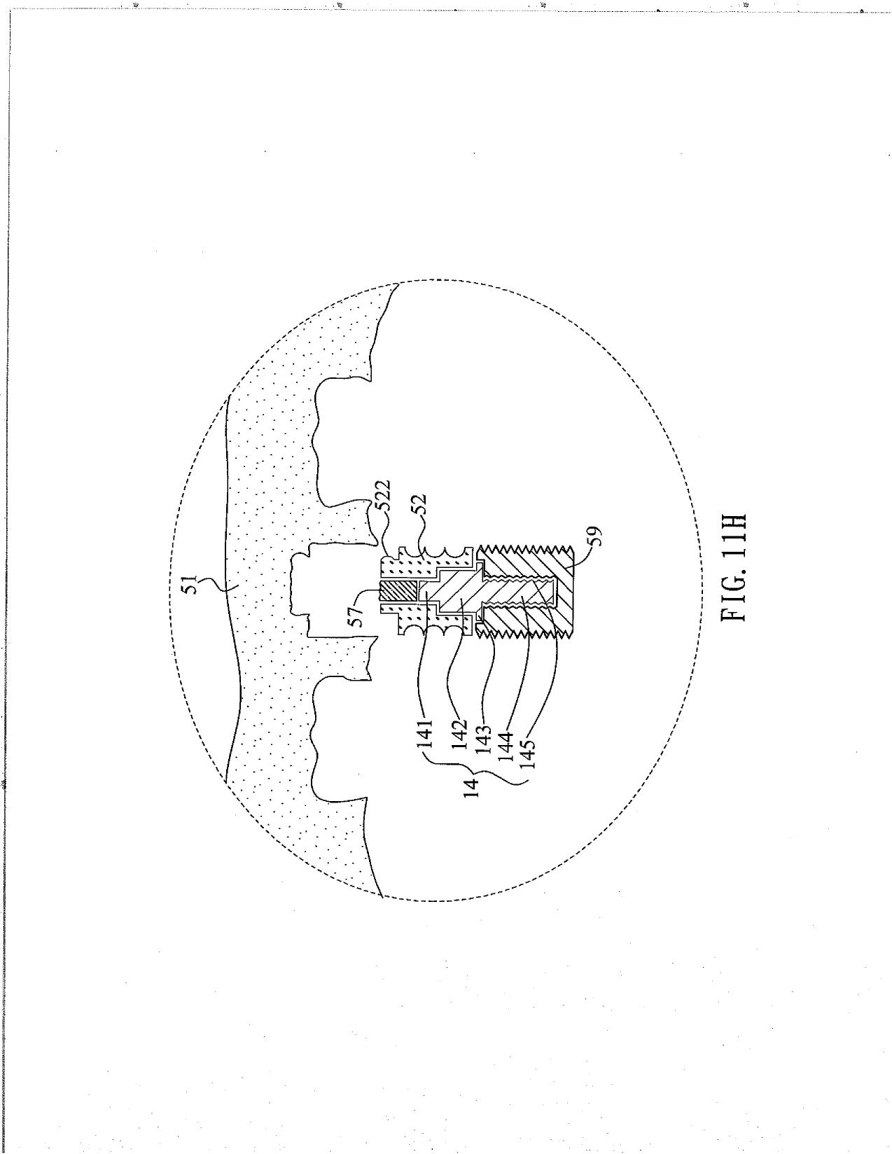

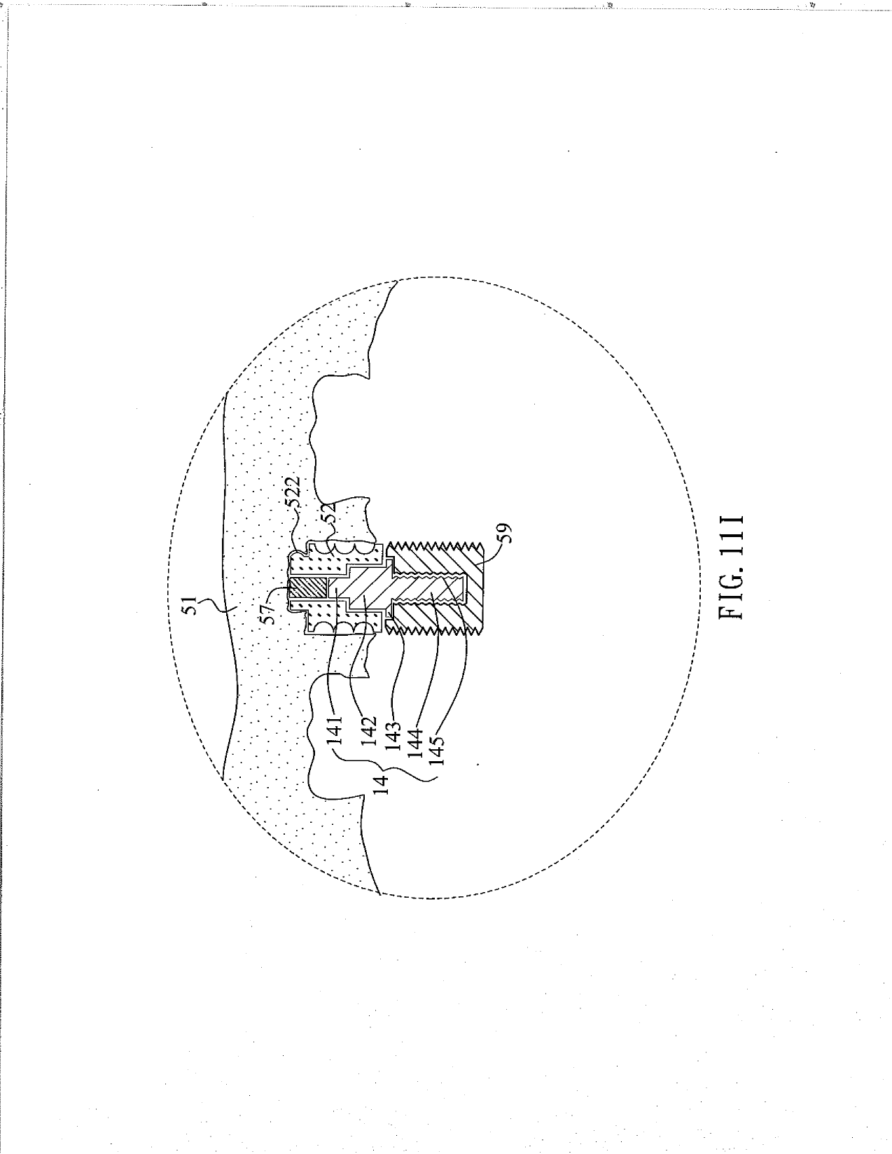

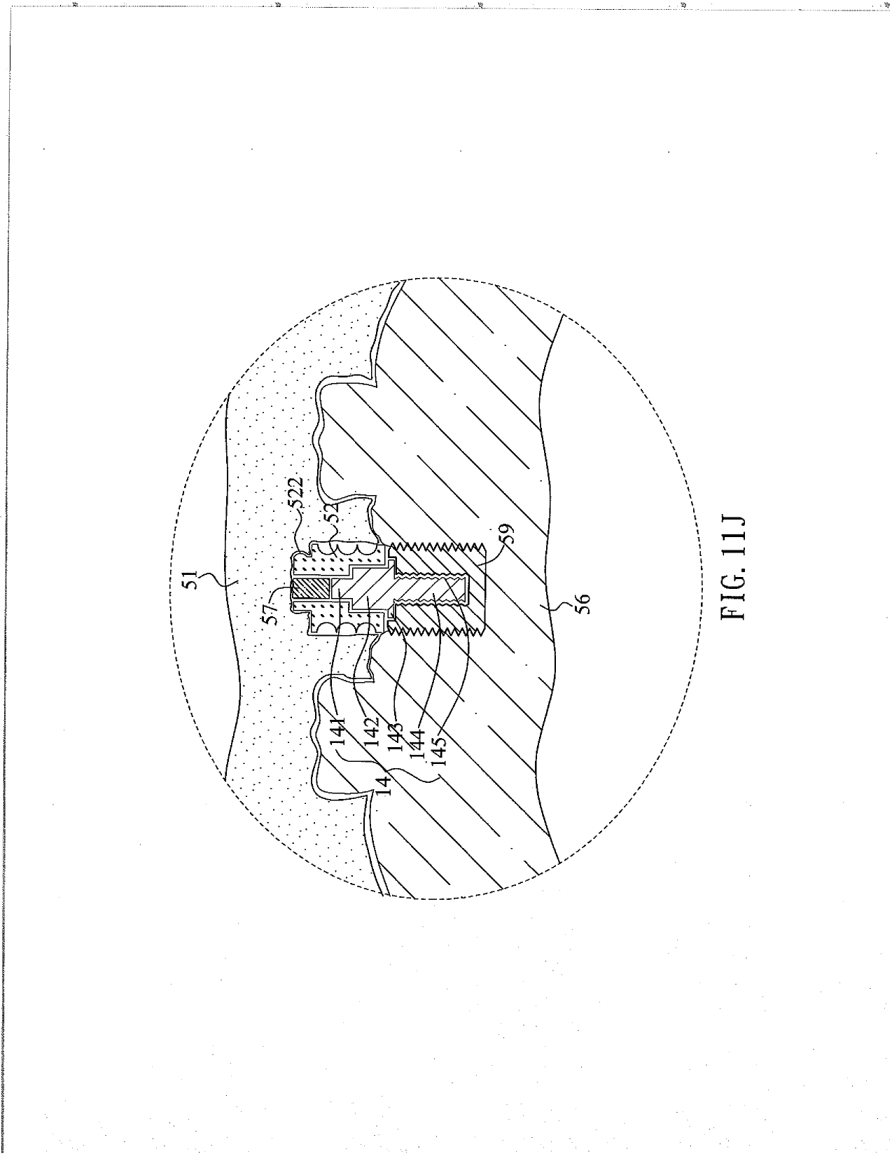

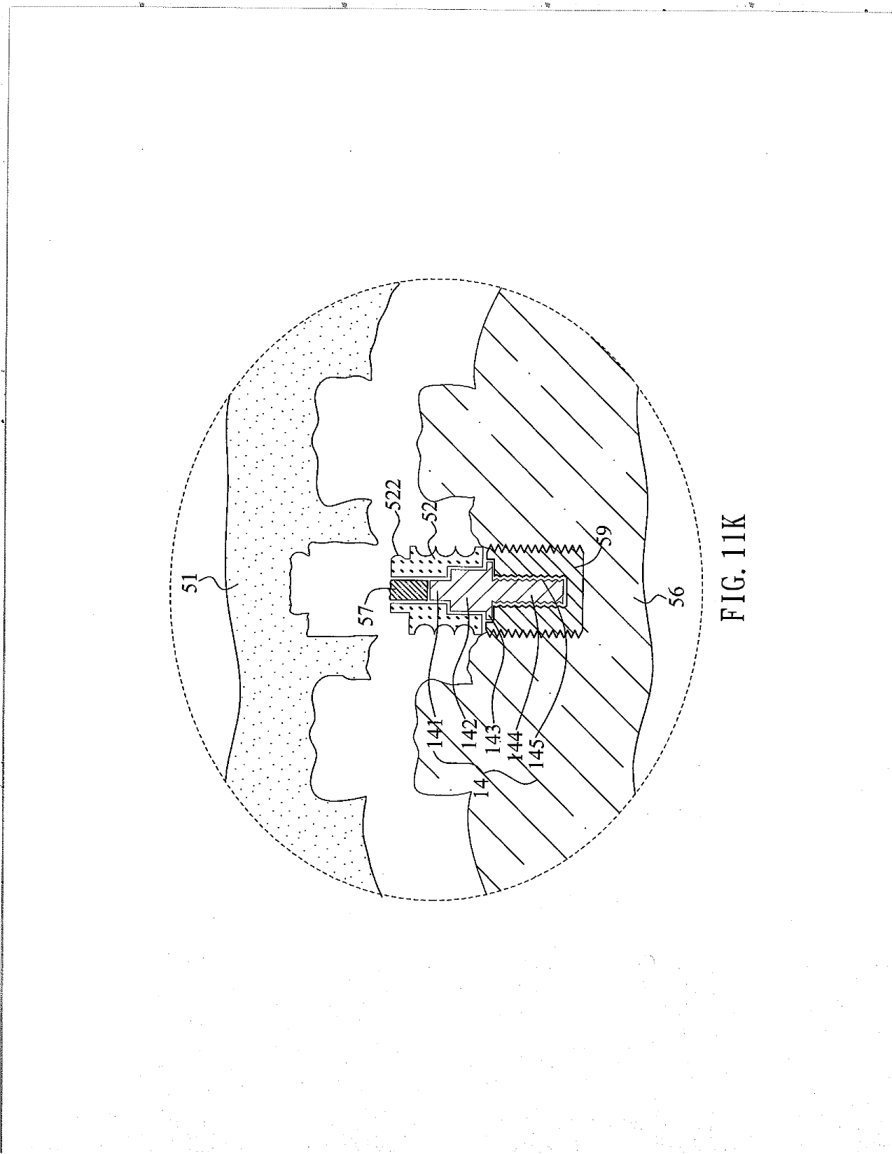

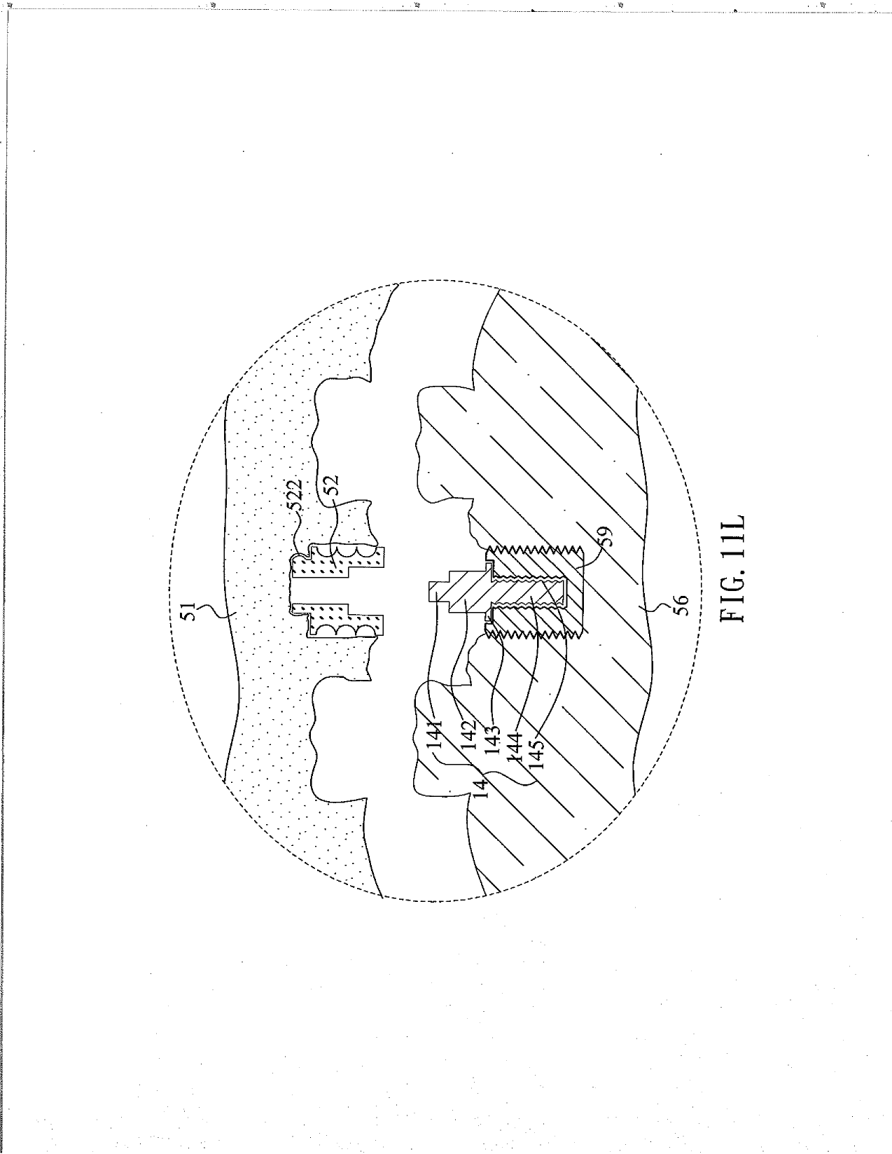

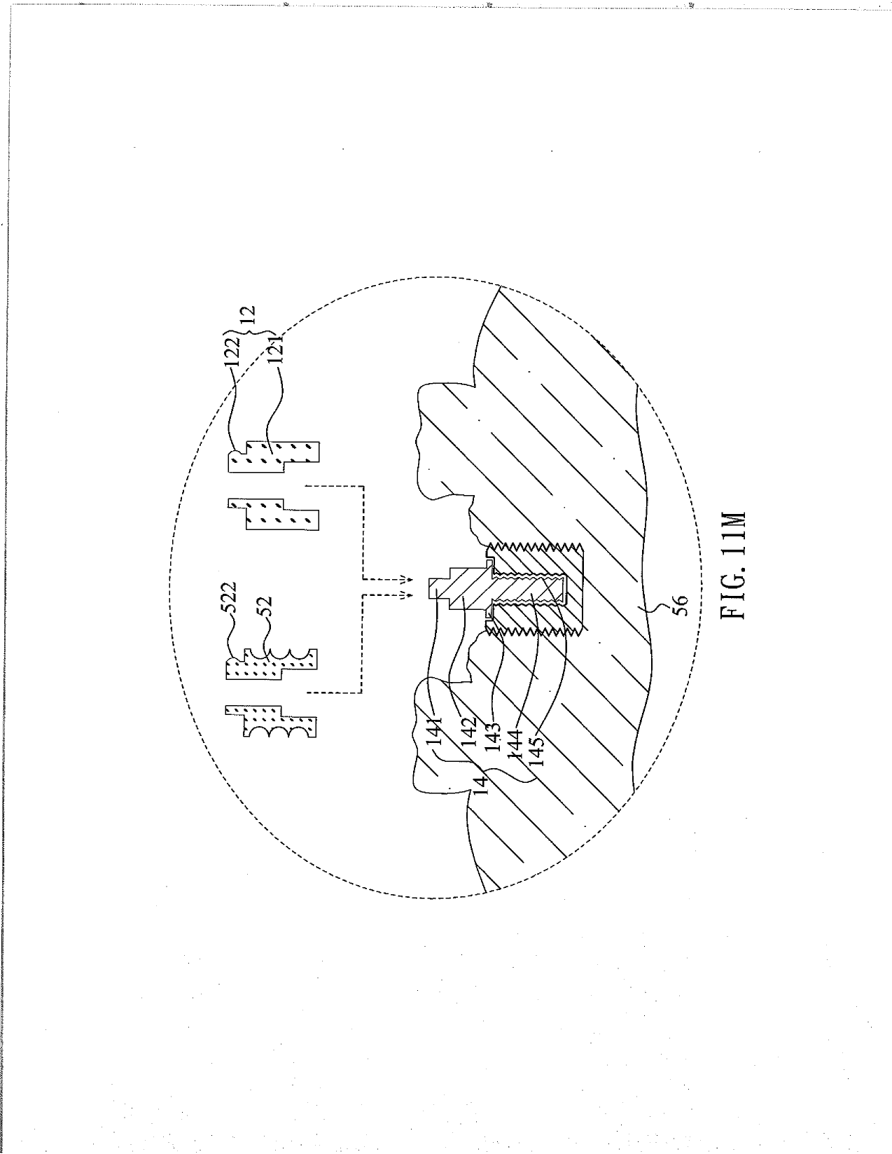

Please refer to FIG. 8 and FIG. 11A˜11M, the function or the purpose of the implanting suite 1 and the cap 12 is to achieve scan abutment, impression coping transferring, or UCLA abutment in dentistry. As shown in FIG. 8, the implanting method of the second embodiment has the following steps:

Step A11: placing the implant 9 in the underlying bone 82, and Step A12: providing with an implanting suite 1, in which the condition is demonstrated in FIG. 11A.

Step A2: inserting the implanting suite 1 into the implant 9, and engaging the fastening member 14 and the implant 9. After engagement, the condition is demonstrated in FIG. 11B. Similarly, the Step A12 may be progressed before/after the Step A11, or even concurrently progressed with the Step A11. The actions of the Step A11, A12, A2 in the second embodiment (FIG. 8) are similar or identical to the first embodiment (FIG. 7), therefore it is not be further addressed.

Step A3: selectively grinding the cap 12 in the mouth. As shown in FIG. 11C, Step A3 in this embodiment has the radial side (such as right side or left side) of the main body 121 ground; therefore the recognizing portion 122 located at upside of the cap 12 is remained, without being ground. The recognizing portion 122 remained may have functions for further cast modeling, mold taking or contour scanning. After the radial side of main body 121 is ground, the condition is demonstrated in FIG. 11D. Similar to the first embodiment (FIG. 7), Step A2 and Step A3 are exchangeable according to the practical dental clinic needs.

Step A4: sewing the gingiva 81 around the cap 12, to make appearance of the main body 121 around the gingiva 81 correspond to the gingiva 81 mutually (Step A4a), and selectively filling a filling material 57 into the inserting hole 123 to adhere the cap 12 and the fastening member 14 (Step A4b). If the cap 12 disclosed in FIG. 1 or FIG. 4 is utilized in Step A4b, the filling material 57 may be filled in the inserting hole 123 and the circumstance is demonstrated in FIG. 11D. If the cap 12 disclosed in FIG. 3 is utilized in Step A4b, the filling material 57 may be filled in the gap between the fastening member 14 and the inner wall of the inserting hole 123, or even the filling process is omitted. If the cap 12 disclosed in FIG. 2 is utilized in Step A4b, the filling of the filling material 57 may also be omitted because that the recognizing portion 122 is not passed through (close type) by the inserting hole 123

Step C5: 3D (3-Dimensions) oral scanning. Notice that the cap 12 and the fastening member 14 of the implanting suite 1 has already disposed in the mouth of patient after sewing Step A4a or the selective filling Step A4b is made. Therefore, as demonstrated in FIG. 11D, the contour of the tooth 84, the profile of the missing tooth, and the ground cap 12 with recognizing portion 122 may be directly scanned through the 3D oral scanner, and afterward the positioning/marking/labeling process is then made through recognizing portion 122. In this manner, dental crown or custom abutment is able to be designed and fabricated, or a working model (or working mold) is able to be achieved, to have the ceramic or porcelain material heaped on the working model. After the ceramic or porcelain material is heaped, the dental crown or the custom abutment is then done. Further notice that the scanning Step C5 of this embodiment (FIG. 8) may be done before/after healing of the gingiva 81 tissue, in which the healing process of the gingiva 81 tissue normally take 2˜3 months. In this manner, the embodiment including Step A11, A12, A2, A3, A4 and Step C5 is to serve as scan abutment in dentistry.

Except for the Step C5 made after Step A4, the Step B5 may be alternatively done after the Step A4 is progressed. The Step B5: taking mold through an impression material 51. The mold taken through the impression material 51 is demonstrated in FIG. 11E and FIG. 11F, in which the impression material 51 is downwardly moved to cover and encompass the tooth 84, gingiva 81 and the implanting suite 1, such that the downside profile of the impression material 51 may form a contour corresponded/identical to profile of the tooth 84, gingiva 81 and the implanting suite 1. Notice that the mold-taking Step B5 of this embodiment is fulfilled after the gingiva 81 is healed. Moreover, the mold taken means the impression material 51 been pressed on something and then the contour been recorded.

Afterward the Step B6 is progressed. Step B6: separating the impression material 51. The impression material 51 separated is demonstrated in FIG. 11G, in which downside of the impression material 51 has contour similar/identical to the contour of the tooth 84, gingiva 81 and the implanting suite 1. The FIG. 11G reveals that the cap 12 and the fastening member 14 are still retained on the underlying bone 82 because the cap 12 and the fastening member 14 are adhered through the filling material 57 (disclosed in Step A4b), and the fastening member 14 and the implant 9 are engaged/connected together. In other words, the cap 12 and the fastening member 14 may be fixed on the underlying bone 82, without separating, loosing or falling down, just because the fastening member 14 is tightly fitted with the inserting hole 123 of the cap 12 (in the circumstance of cap 12 disclosed in FIG. 2), plus the combination of the fastening member 14 and the implant 9.

Step B7: engaging an imitating cap 52, a fastening member 14, or a replica 59 to the impression material 51. As shown in FIG. 11H of the embodiment, the imitating cap 52, fastening member 14 and the replica 59 are simultaneously connected/combined with downside of the impression material 51. The “imitating cap 52” used here could be a structure similar to, analogous to, or identical to the cap 12; more descriptive, the imitating cap 52 and the cap 12 shall have identical recognizing portion disposed at upside and have the same height. Namely, the recognizing portion 122 of the cap 12 and the recognizing portion 522 of the imitating cap 52 have identical outer profile, identical azimuth, identical rotation, identical altitude and identical shape, and the height of the imitating cap 52 and the height of the cap 12 are the same. In preferable embodiment, the imitating cap 52 might further have a hole (not marked) similar to the inserting hole 123, such that the imitating cap 52 is able to connect with the positioning portion 142 of the fastening member 14 in specific orientation and specific azimuth. In practice, the imitation cap 52 could be fabricated by grinding the main body 121 of the cap 12 (note that the recognizing portion 122 can not be ground). If do so, the ground cap 12 (become the imitating cap 52) will not affect the followed scanning process or mold taking process, because the recognizing portion 122, 522 of the imitating cap 52 is remained. Additionally, the imitating cap 52 might also be the cap 12 taken from upside of the underlying bone 82, namely the cap 12 shown in the FIG. 11G is taken out and afterward is looked on as the imitating cap 52 shown in FIG. 11H. In this scenario, the imitating cap 52 is exactly the cap 12. Moreover, the fastening member 14 engaged to the impression material 51 in Step B7 could be a new fastening member 14 (i.e. non-used fastening member 14), instead of taken out from the implant 9 as demonstrated in FIG. 11G. Besides, the replica 59, may be so-called “Analog”, is similar to the structure of the implant 9 and therefore able to substitute the implant 9; in this manner, the replica 59 may be engaged to downside of the fastening member 14 or the imitating cap 52, so as to duplicate, imitate, simulate or represent the location, position and azimuth of the implant 9 relative to the underlying bone 82. Namely the replica 59 may copy or reproduce the physical relation of the underlying bone 82 and the implant 9.

Specifically, the engaging Step B7 may have the upside of the fastening member 14 engaged to downside of the imitating cap 52 and afterward have the replica 59 engaged to downside of the fastening member 14. Alternatively, the engaging Step B7 may have downside of the fastening member 14 engaged to inside of the replica 59 and afterward have the upside of the fastening member 14 engaged to/inserted into downside of the imitating cap 52. In order to ensure the combination/engagement of the imitating cap 52 and the fastening member 14, the further filling material 57 or sticking material may be utilized, to adhere the imitating cap 52 and the fastening member 14. After the imitating cap 52, fastening member 14 and the replica 59 are engaged to downside of the impression material 51, the condition is demonstrated in FIG. 11H and FIG. 11I.

Step B8: modeling the impression material 51, imitating cap 52, fastening member 14 or/and the replica 59. Here, the plaster, clay, gesso or mud might be utilized in the modeling process, and the “modeling” means mold/cast making, mold/cast fabricating, mold/cast coping, or mold/cast cloning. Normally, plaster is fluidized and became thick/dense, and then encompassed the impression material 51, the imitating cap 52, the fastening member 14 and the replica 59, such that the plaster may form the same profile/contour/appearance with the impression material 51, imitating cap 52, fastening member 14 and the replica 59. After modeling, a plaster cast 56 may be fabricated (as shown in FIG. 11J) and located beneath the impression material 51, the imitating cap 52, the fastening member 14 and the replica 59.

Step B9: separating the impression material 51 from the plaster cast 56 after the plaster cast 56 is hardened. Then, the imitating cap 52, fastening member 14 and the replica 59 is still retained on the plaster cast 56 (Step B102) if the imitating cap 52 and the fastening member 14 are adhered/connected through the filling material 57 in advance; in this manner, scenario of the impression material 51 separated is demonstrated in FIG. 11K, and the plaster cast 56 may have appearance/contour similar to or identical to the tooth 84 and the gingiva 81. Here, the plaster cast 56 may have the imitating cap 52 and the fastening member 14 firmly disposed on the plaster cast 56, through the replica 59 fixed on the plaster cast 56, through the fastening member 14 engaged to the replica 59, and through combination of the fastening member 14 and the imitating cap 52. Alternatively, the imitating cap 52 may be separated from the fastening member 14 along with the upward movement of the impression material 51, and the fastening member 14 and the replica 59 may be retained on the plaster cast 56 (Step B101) if the imitating cap 52 and the fastening member 14 are not adhered/connected in advance; in this manner, scenario of the impression material 51 separated is demonstrated in FIG. 11L, in which the imitating cap 52 may be disposed at downside of the impression material 51, and the fastening member 14 and the replica 59 may be disposed on the plaster cast 56. Further in the scenario of Step B101, another imitating cap 52 (could be new/non-used imitating cap 52) may be engaged to upside of the fastening member 14 (Step B111, shown in FIG. 11M), such that the plaster cast 56 may have both of the imitating cap 52 and the fastening member 14 disposed on the plaster cast 56. In some embodiments, the imitating cap 52 utilized in Step B111 could be the cap 12 disclosed in FIG. 1˜6, or the ground cap 12 disclosed in FIG. 11D, or the imitating cap 52 disclosed in FIG. 11H, or any structure with identical height to the cap 12 and identical profile/contour to the recognizing portion 122; all of these configurations of the imitating cap 52 may be fastened/engaged to the fastening member 14 disclosed in FIG. 11M. Summarily, the method of Step B5˜B102 or Step B5˜B111 are utilized for mold fabrication of the tooth 84, missing tooth, so as to produce the plaster cast 56 and serve as the “coping transfer” in dentistry or dental clinics.

After the Step B102 or Step B111 is made, then the Step B120 is able to be progressed. Step B120: forming wax on the imitating cap 52. As shown in FIG. 11K or FIG. 11M, “forming wax”, is so-call waxing in dentistry, may heap wax on the imitating cap 52 and then make the heaped wax shape into a particular contour. In this manner, the implanting suite 1 and the implanting method may serve as UCLA abutment in dentistry.

### 3rd Embodiment

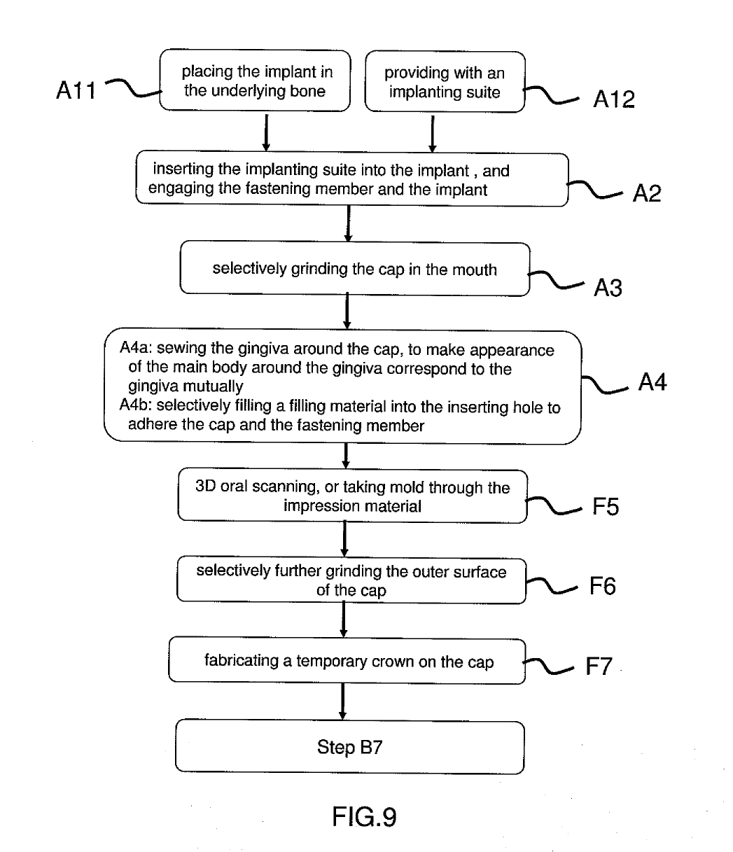

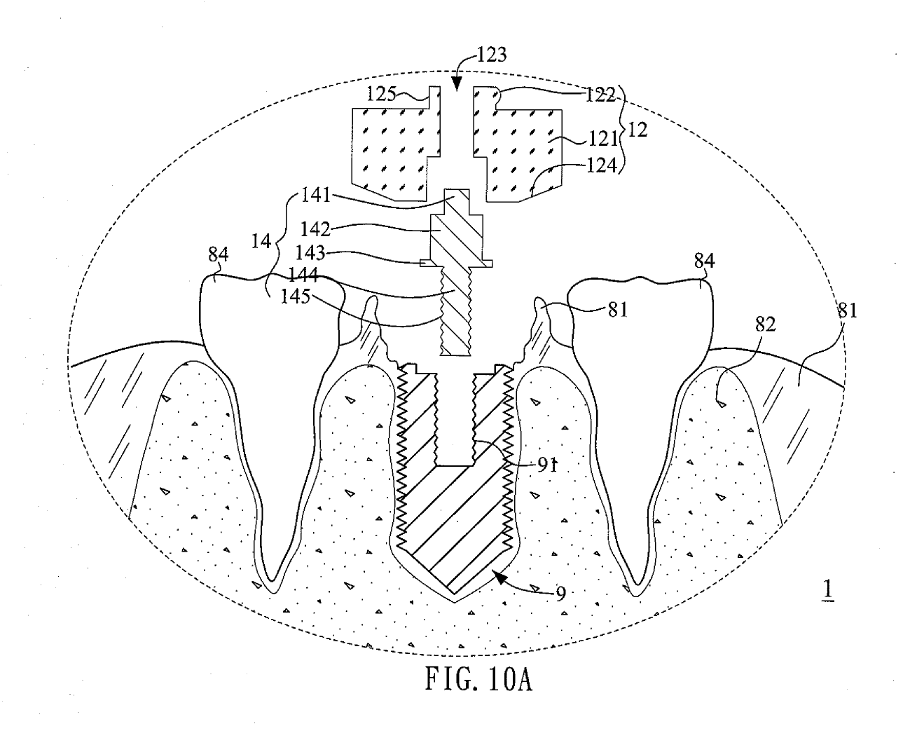

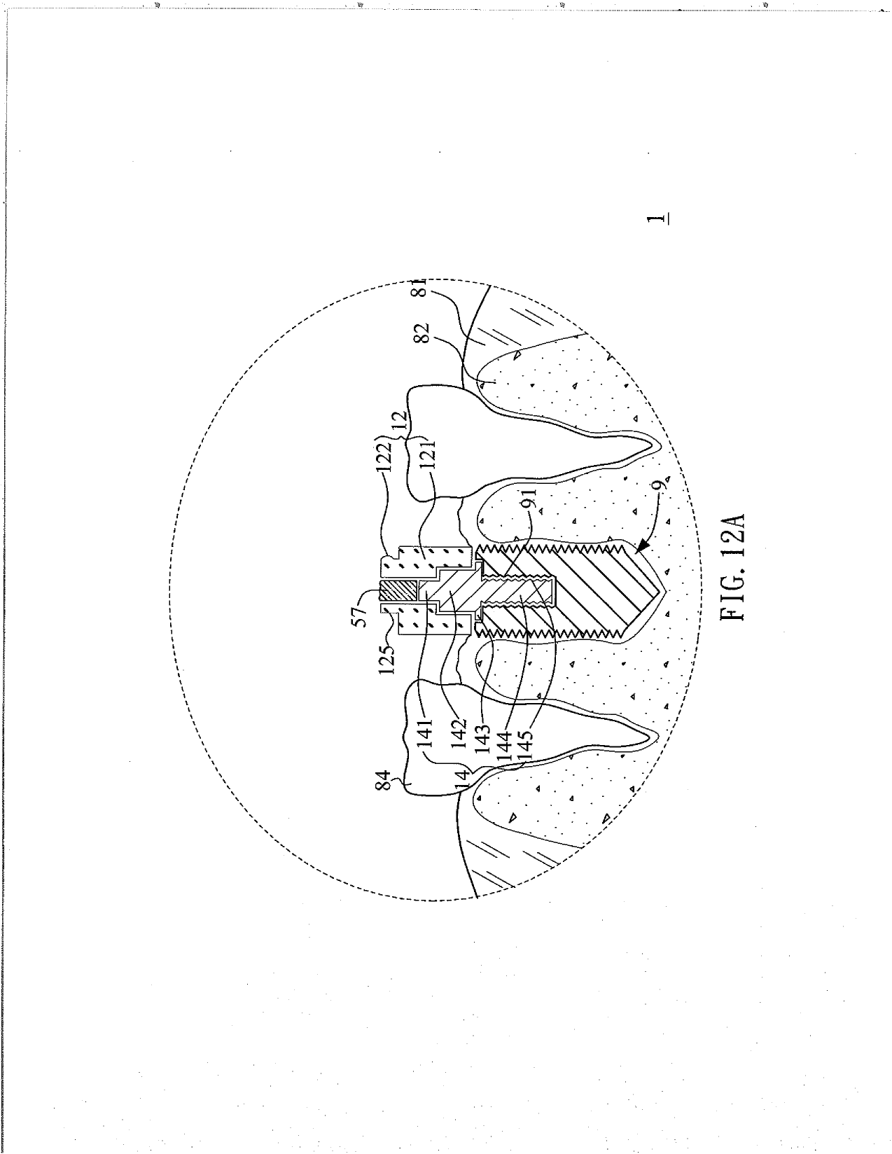

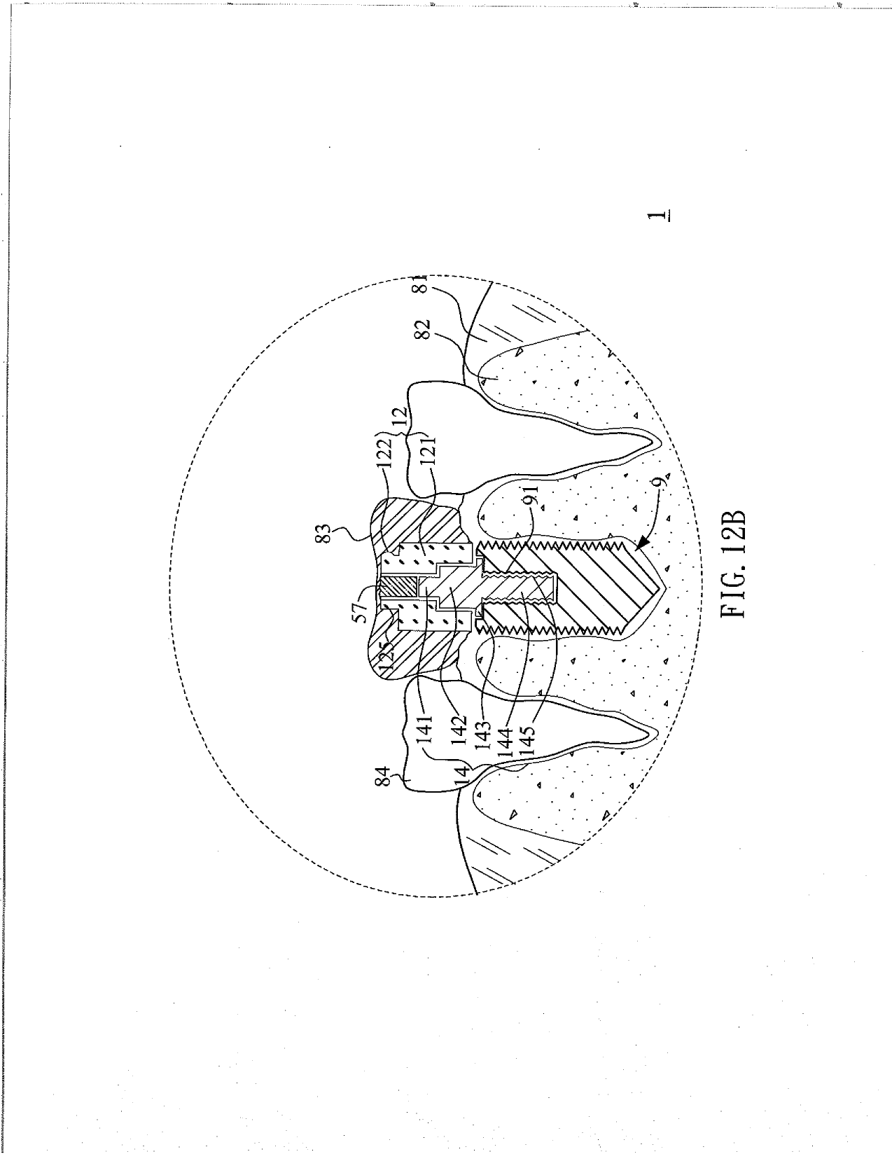

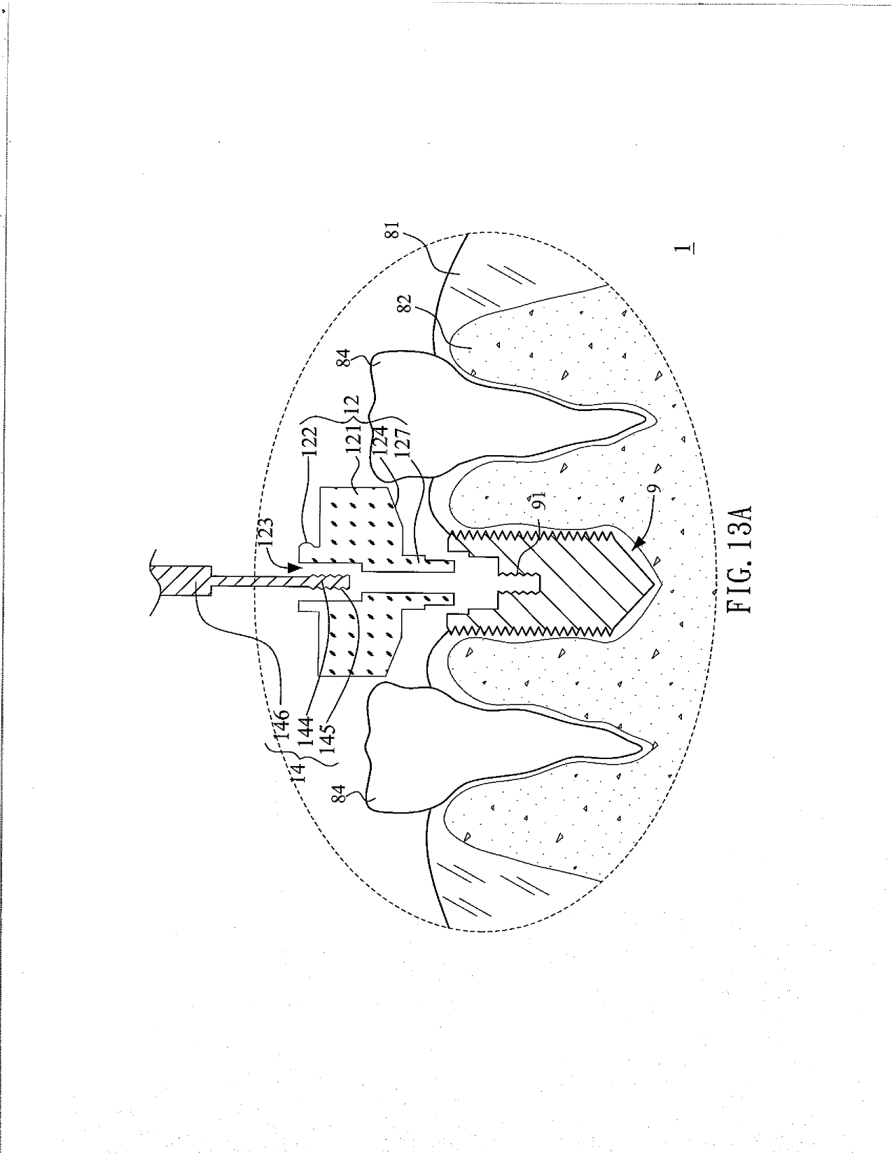

Please refer to FIG. 9 and FIG. 12A˜12B, the function or the purpose of the implanting suite 1 and the cap 12 is to achieve fabrication of temporary crown in dentistry. As shown in FIG. 9, the implanting method of the third embodiment has the following steps:

Step A11: placing the implant 9 in the underlying bone 82; Step A12: providing with an implanting suite 1 as disclosed in the present invention; Step A2: inserting the implanting suite 1 into the implant 9, and engaging the fastening member 14 and the implant 9; Step A3: selectively grinding the cap 12 in the mouth; Step A4: sewing the gingiva 81 around the cap 12, to make appearance of the main body 121 around the gingiva 81 correspond to the gingiva 81 mutually (Step A4a), and selectively filling a filling material 57 into the inserting hole 123 to adhere the cap 12 and the fastening member 14 (Step A4b). The Steps A11, A12, A2, A3, A4a and A4b are similar to or identical to the second embodiment (i.e. FIG. 8), therefore not addressed any more.

Step F5: 3D oral scanning, or taking mold through the impression material 51. The scanning process utilizes a 3D scanner device to directly scan the oral condition including the profile/contour of the tooth 84, missing tooth or occlusion/bite of the mouth. The taking mold process is already demonstrated in FIG. 11E, 11F and FIG. 11G. Notice that the scanning process or the mold taking process of Step F5 are both made before gingiva 81 is healed; in comparison with that the scanning process in Step C5 and the mold taking process in Step B5 (demonstrated in FIG. 8) are both made after the gingiva 81 is healed.

Step F6: selectively further grinding the outer surface of the cap 12. The cap 12 further ground here may have the dentist or the clinician assessed that whether the gingiva 81 is corresponded to outer contour of the cap 12. If the gingiva 81 is not corresponded to outer contour of the cap 12, then the Step F6 shall be made; on the contrary, the Step F6 may be omitted if the gingiva 81 has already corresponded to outer contour of the cap 12. Notice that the Step F6 and Step A3 could be simultaneously remained in the embodiment, no conflict existed. Specifically, the Step A3 may be roughly ground, and the Step F6 may be fine-tuning ground. In some embodiments, the Step A3 is omitted and afterward the Step F6 is made. In the progress of Step F6 made, to have the recognizing portion 122 ground is allowed, because outer profile/contour of the recognizing portion 122 and the cap 12 has already record (through 3D scanning or mold taking) in Step F5. Sometimes, the cap 12 installed/assembled on the implant 9 may cause the cap 12 protruding in comparison to the adjacent tooth 84; therefore the advantage of grinding recognizing portion 122 is that the cap 12 will not be too much protruding (compare to the adjacent tooth 84).

Step F7: fabricating a temporary crown 83 on the cap 12. FIG. 12A shows the temporary crown 83 is not yet fabricated, and FIG. 12B shows the temporary crown 83 is already fabricated. After the Step F7 is made (FIG. 12B), the temporary crown 83 may cover or encompass the cap 12 and the fastening member 14, such that the temporary crown 83 may help the patient eat or take food in a short time. In this manner, the cap 12 or the implanting suite 1 of the present invention may serve as a temporary abutment in dentistry or dental clinics.

With respect to the impression material 51 utilized in the embodiment of FIG. 9, it can be followed and progressed the Steps B7, B8, B9, B102, B101, B111, B120 as shown in FIG. 8. In this manner, the impression material 51 is able to model the contour of the tooth 84 and missing tooth, to fabricate the plaster cast 56.

Summarily, the implanting suite 1 and the implanting method of the present invention may serve as healing abutment, scan abutment, impression coping transferring, temporary abutment or UCLA abutment in dental prosthesis fabrication or dental restoration. Therefore, no need to purchase plurality of dentistry kits to satisfy different kinds of dental conditions, and hence multi functions in dentistry are achieved and the cost is decreased.

### 4th Embodiment

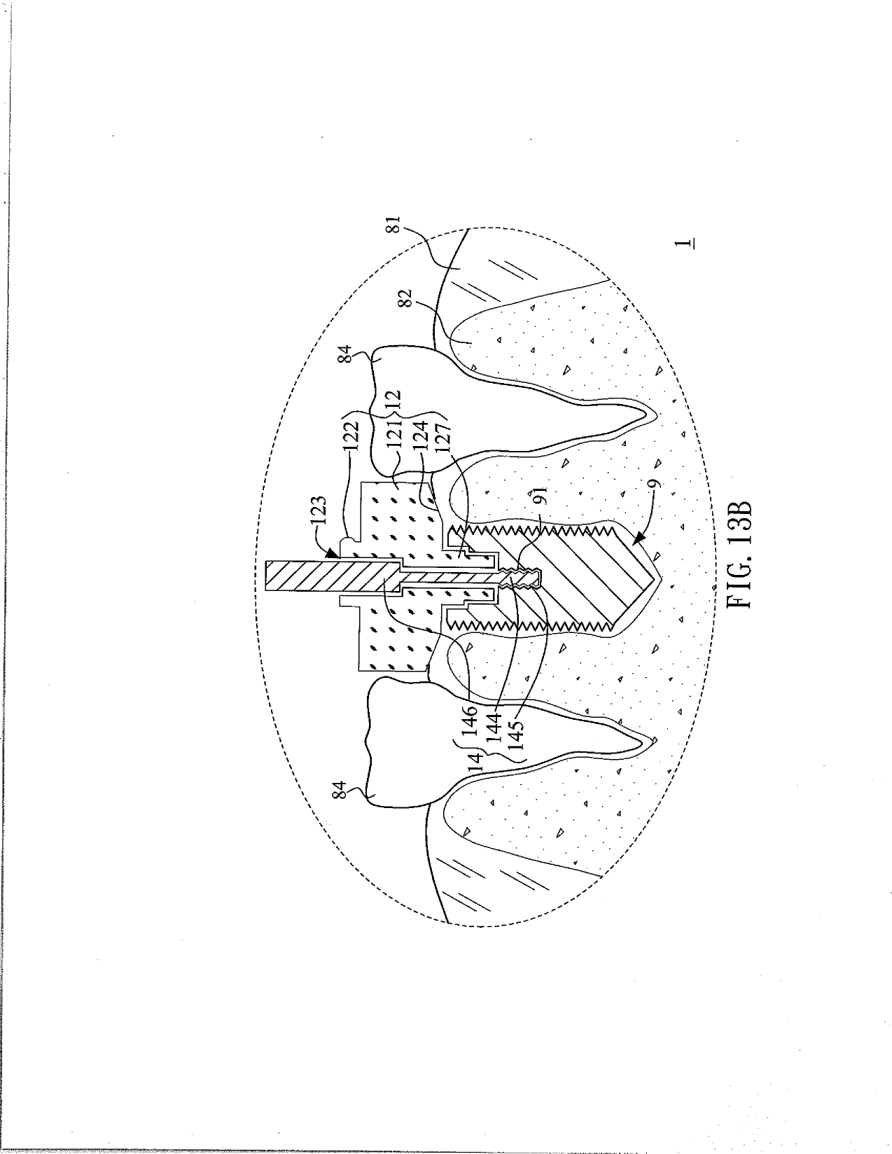

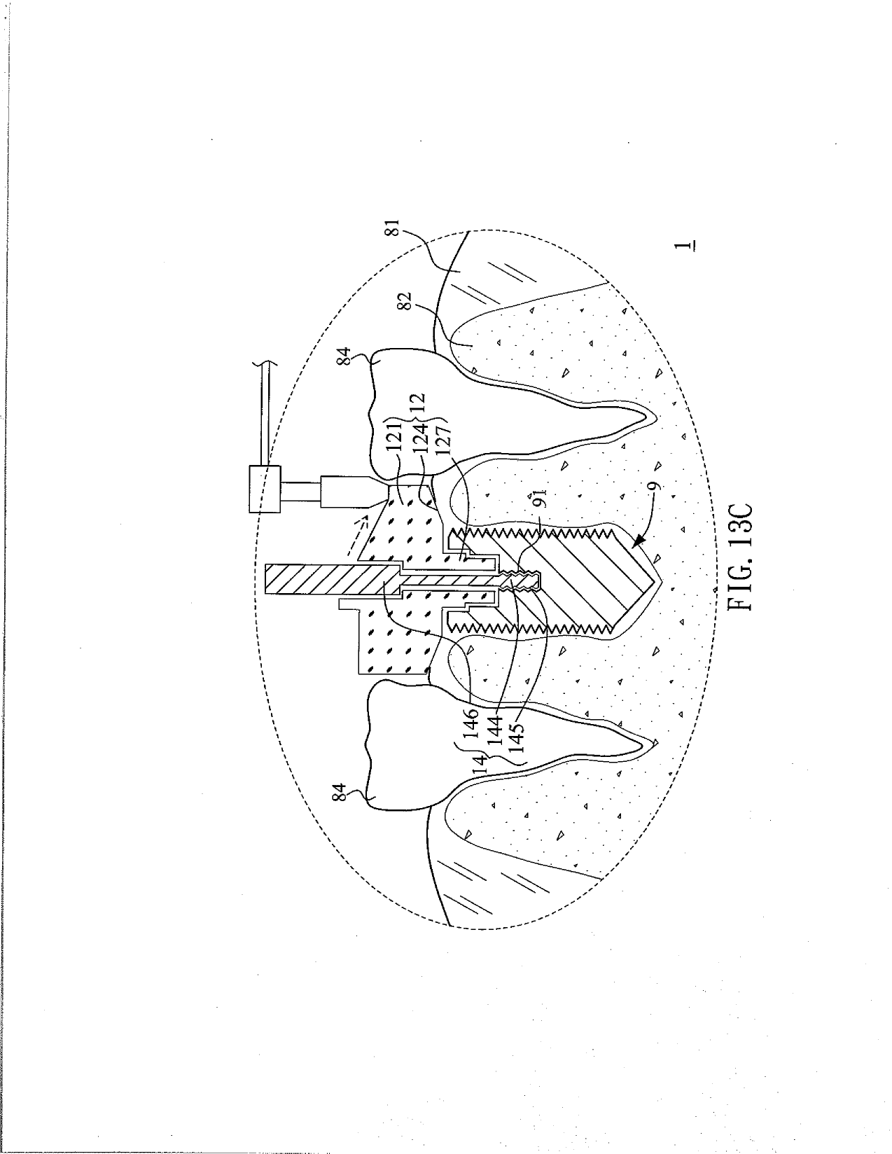

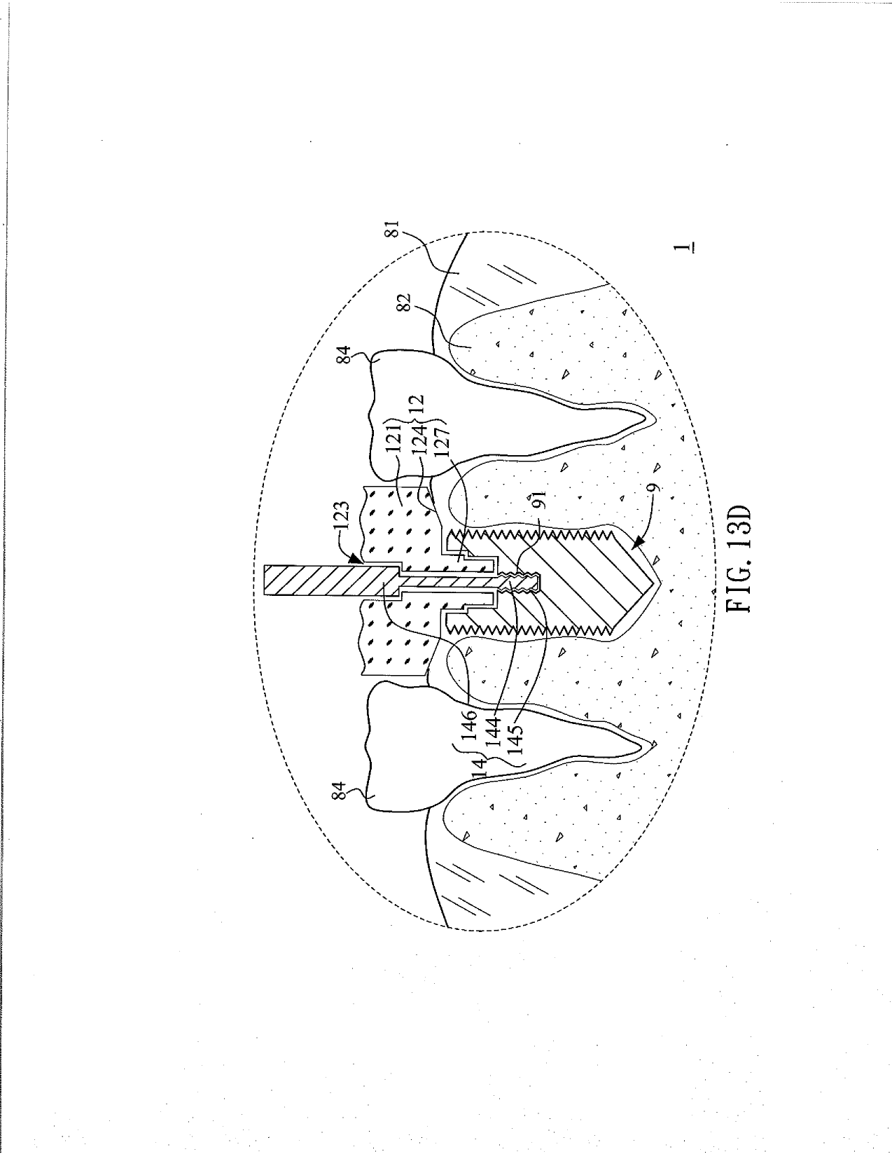

Next, some other configuration of implanting suite 1 is introduced. Please refer to FIG. 13A, the implanting suite 1 has a cap 12 and a fastening member 14. The cap 12 has a recognizing portion 122, an inserting hole 123, a fitting portion 127 and a main body 121. The inserting hole 123 is disposed in the main body 121 and communicated to exterior of the main body 121. The recognizing portion 122 is disposed at upside of the main body 121. In the preferable embodiments, the inserting hole 123 may be vertically passed through the main body 121, fitting portion 127 and the recognizing portion 122. The fitting portion 127, may be disposed at downside of the main body 121 and protruded downwardly, faces toward the implant 9 and therefore is detachably engaged to the implant 9. The fitting portion 127 forms stair-shaped (could be stagger or brick shaped) contour or appearance at the radial exterior of the fitting portion 127. The fastening member 14 has a abutting portion 146 and a connecting portion 144, in which the abutting portion 146 is disposed at upside of the fastening member 14 and the connecting portion 144 is disposed at downside of the fastening member 14. Thus the abutting portion 146 and the connecting portion 144 are respectively located at two axial ends of the fastening member 14. The fastening member 14 may be detachably and movably inserted into the inserting hole 123. When the fastening member 14 moved downwardly as shown in FIG. 13B, the abutting portion 146 will be disposed in the inserting hole 123 and abutted (i.e. contacted and retained) against the inserting hole 123, so as to further have the connecting portion 144 inserted into implant 9. Specifically, the implant 9 has a internal bore 91 inside; the connecting portion 144 has a thread 145 outside; the internal bore 91 may be detachably and selectively engaged to the thread 145 through screwing. Preferably, outer contour/profile of the abutting portion 146 and inner wall of the inserting hole 123 are matched/corresponded to each other, such that the abutting portion 146 may be approximately filled up the space inside the inserting hole 123 when the abutting portion 146 is inserted into the inserting hole 123. As shown in FIG. 13B, downside of the abutting portion 146 is stair-shaped contour, and inner wall of the inserting hole 123 is also a stair-shaped hole; thus the abutting portion 146 disposed inside the inserting hole 123 may be downwardly abutted against interior of the main body 121, such that a downward force is exerted to the main body 121 and the cap 12. As shown in FIG. 13A and FIG. 13B, when the cap 12, fastening member 14 and the implant 9 is fastened, firstly the fitting portion 127 of the cap 12 is needed to inserted into the implant 9, and secondly the connecting portion 144 of the fastening member 14 passes through the inserting hole 123 to downwardly engage with the internal bore 91 of the implant 9. In this manner, the engagement of the internal bore 91 and the thread 145 will ensure that the combination of the abutting portion 146 and the inserting hole 123 is fixed firmly, so as to further fasten the cap 12 and the implant 9. Therefore the cap 12 loosing or falling down from the implant 9 is prevented.

Moreover in this embodiment, the diameter of the cap 12 is greater than the cross-sectional width of the tooth 84; therefore volume of the main body 121 may be selectively ground according to the practical oral condition. Alternatively, diameter of the cap 12 might be smaller than cross-sectional width of the tooth 84, thus the cap 12 ground is absolutely not needed any more. Additionally, the cap 12 may further have an adapting face 124 disposed at downside of the cap 12. Specifically, the adapting face 124 is disposed at downside exterior of the main body 121, to neighbor with and correspond to the implant 9/gingiva 81. The adapting face 124 may be formed or fabricated to suit with the gingiva 81 tissue, such that the gingiva 81 tissue will not be squeezed or pressed by the cap 12. In the present invention, the adapting face 124 could be a flat plane, curved surface, lumpy surface or randomly rough and uneven surface. Next, the fitting portion 127 may be engaged to the implant 9 through a specific/particular orientation and specific/particular azimuth, such that the position/location and azimuth of the implant 9 and the cap 12 is able to be accurately identified and recognized. Here, specific/particular orientation and specific/particular azimuth means that the orientation and the azimuth of the fitting portion 127 engaged to can only be limited in a predetermined and pre-designed orientation/azimuth. In other words, the fitting portion 127 and the cap 12 cannot be inserted into the implant 9 until the predetermined and pre-designed orientation and azimuth of engagement is met (in this embodiment, the orientation is axial direction of the implant 9 or the cap 12).

Moreover, the configuration of FIG. 13A and FIG. 13B may be utilized in the implanting method of the present invention. Please simultaneously refer to FIG. 7, the implanting suite 1 disclosed in FIG. 13A and FIG. 13B may also serve as healing abutment, and its implanting method is addressed below:

Step A11: placing the implant 9 in the underlying bone 82; Step A12: providing with an implanting suite 1. As noted that the Step A11 can be progressed before/after the Step A12, or even concurrently progressed with the Step A12.

Step A2: inserting the implanting suite 1 into the implant 9, and engaging the fastening member 14 and the implant 9. The condition before/after the implanting suite 1 engaged with the implant 9 are demonstrated in FIG. 13A and FIG. 13B.

Step A3: selectively grinding the cap 12 in the mouth. As shown in FIG. 13C, upside of the main body 121 may be selectively ground. In order to serve as healing abutment, the cap 12 may have the upper axial end (i.e. recognizing portion 122) ground, such that the ground cap 12 may approximately at similar level/altitude to the adjacent tooth 84 (shown in FIG. 13D). Besides, the Step A2 and A3 are also exchangeable.

Step A4: sewing the gingiva 81 around the cap 12, to make appearance of the main body 121 around the gingiva 81 correspond to the gingiva 81 mutually (Step A4a), and selectively filling a filling material 57 into the inserting hole 123 to adhere the cap 12 and the fastening member 14 (Step A4b). As shown in FIG. 13A˜13D, the upper end of the abutting portion 146 is extended from inside of the inserting hole 123 toward outside of the inserting hole 123 when the fastening member 14 is inserted into the inserting hole 123. In this manner, upper end of the fastening member 14 is too long, and therefore the fastening member 14 needs to be removed and then the filling material 57 is able to be filled into the inserting hole 123 when Step A4b is made. Otherwise the upper end of the fastening member 14 is not protruded and extended outward, then the fastening member 14 may be retained on the implant 9 to engage with the cap 12 (no need to fill the filling material 57) when Step A4b is made. When the Step 4 is made, the implanting suite 1 may be able to serve as dental healing cap, to help the gingiva 81 tissue recovered.

### 5th Embodiment

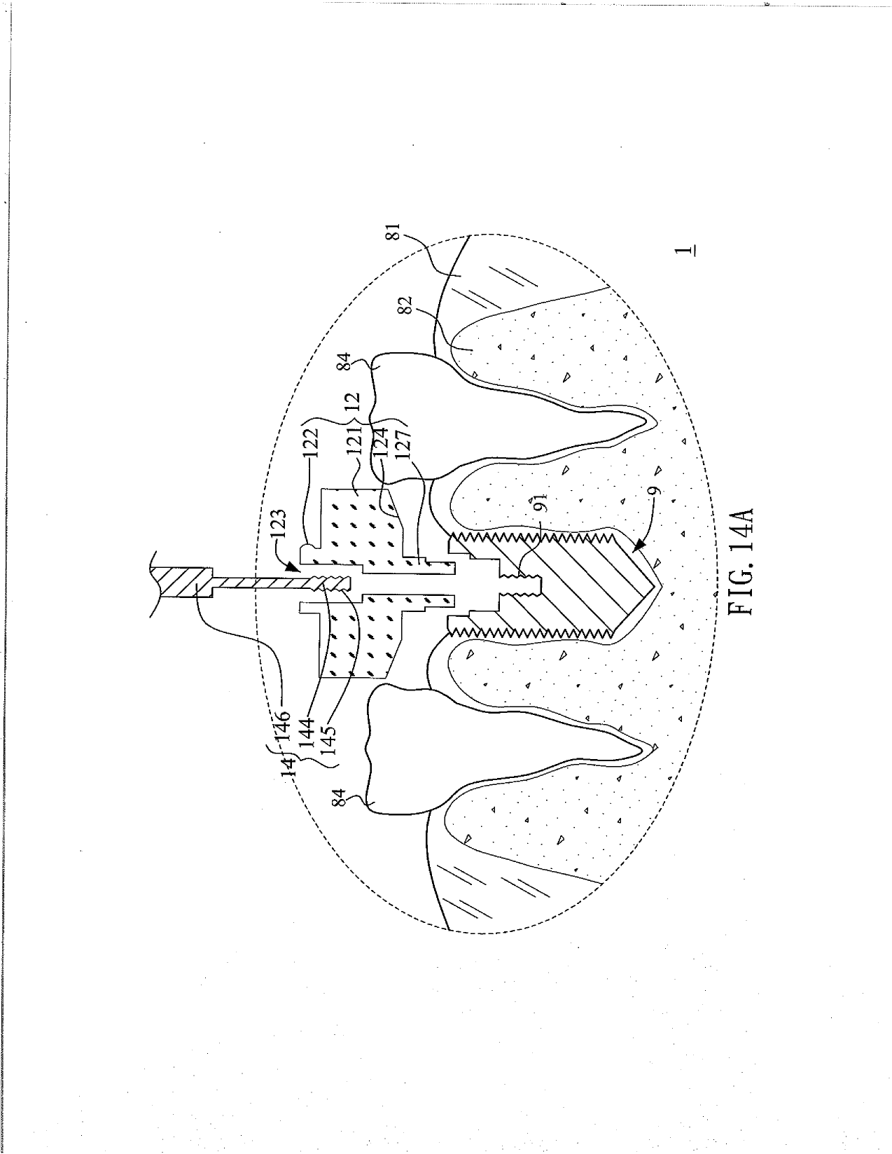

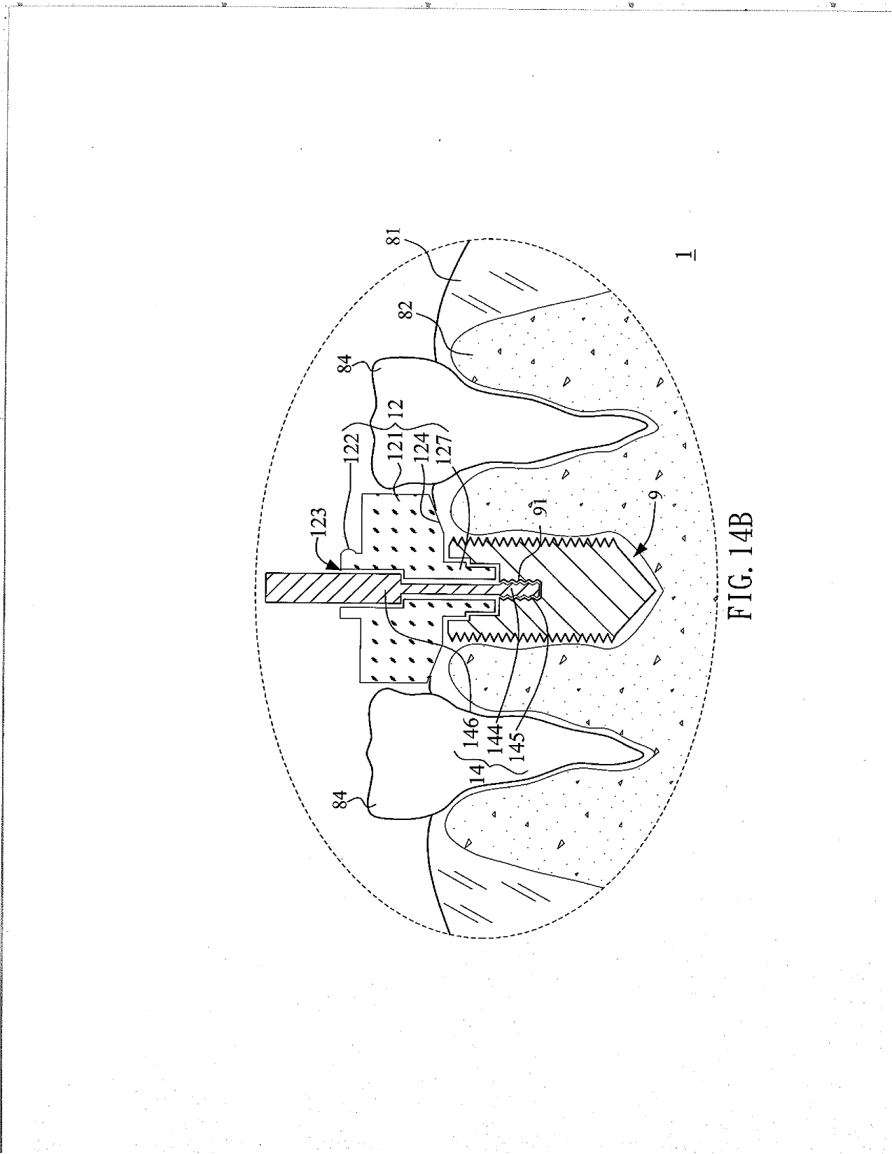

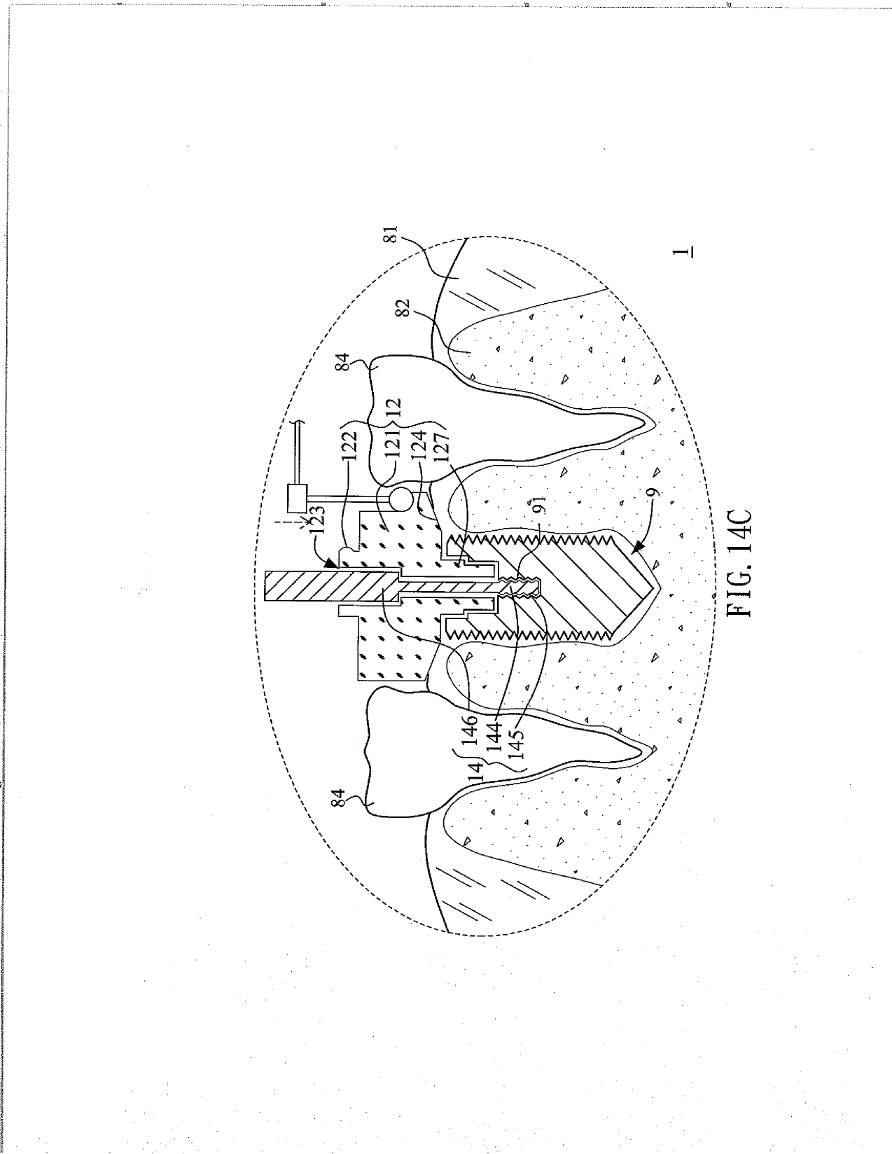

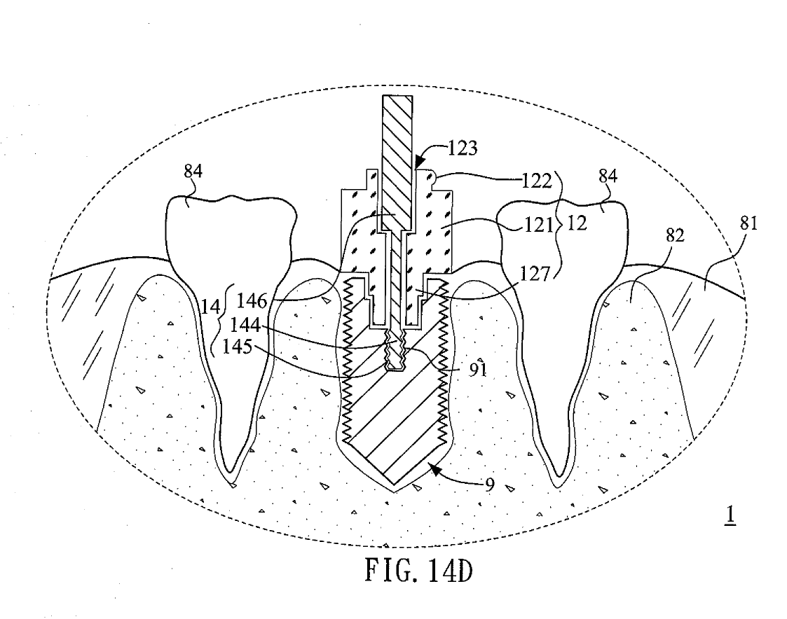

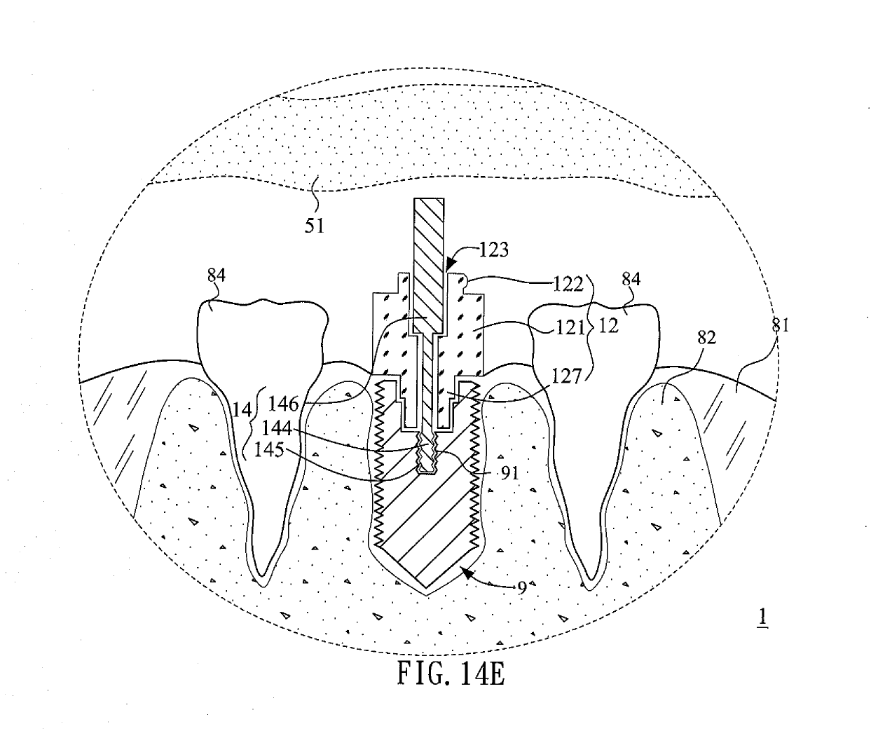

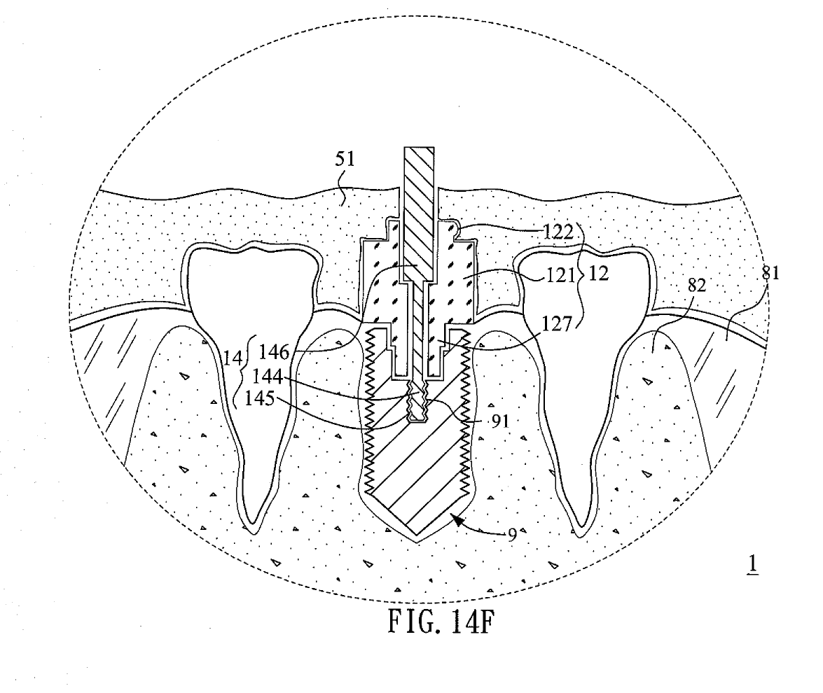

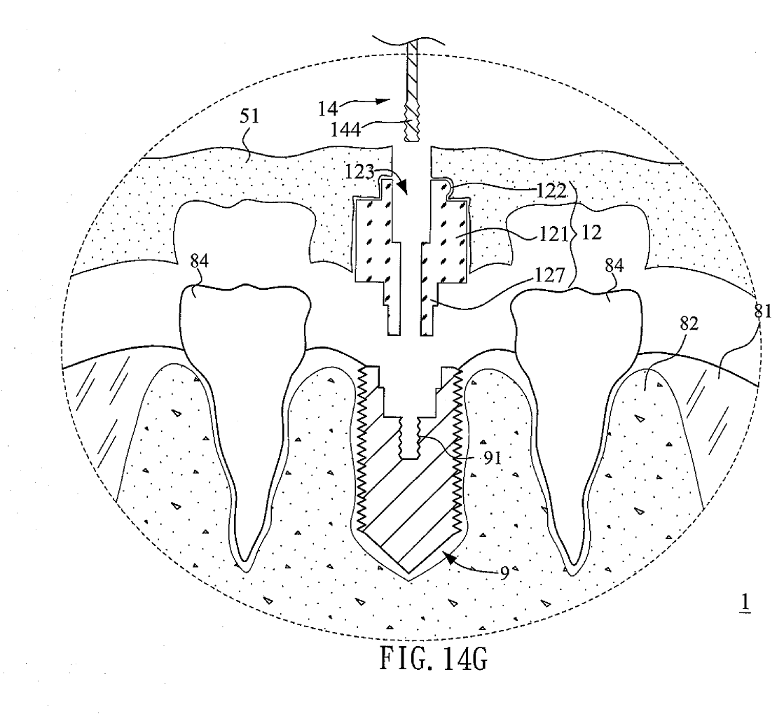

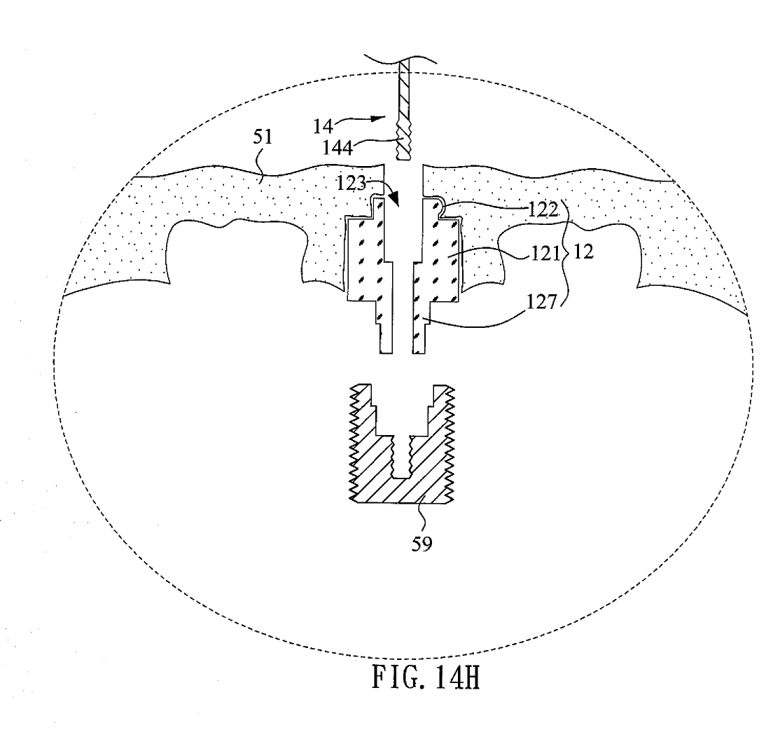

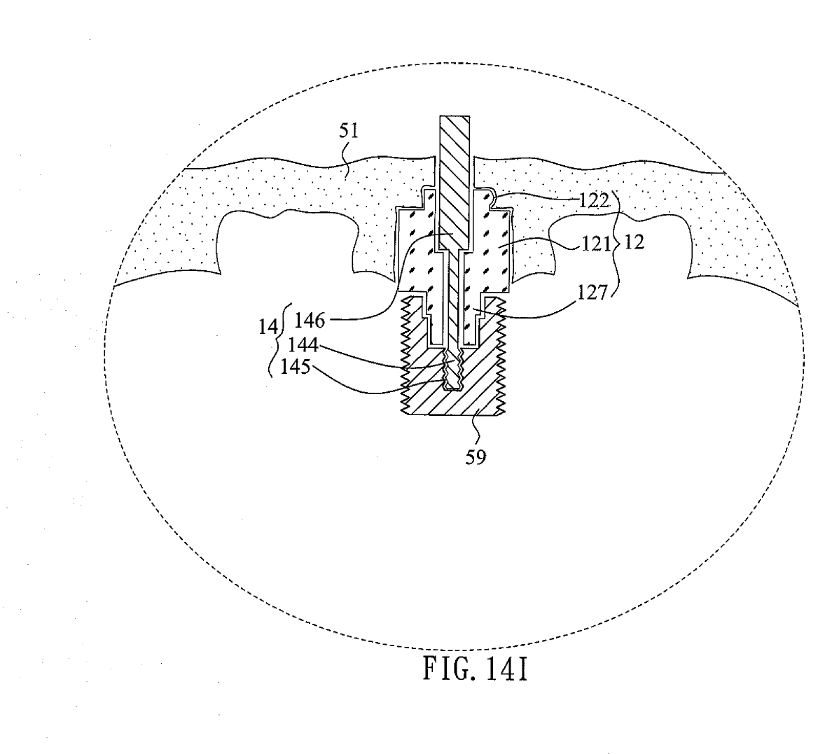

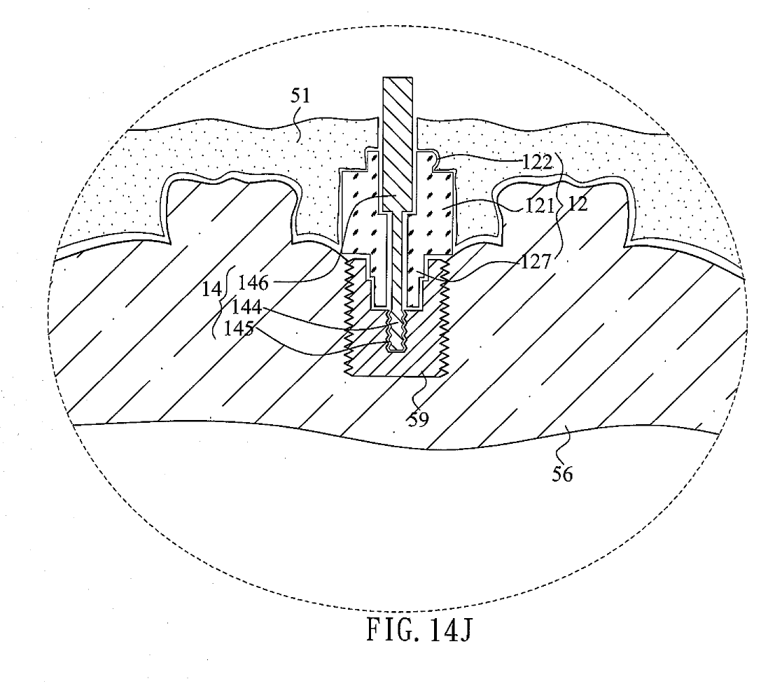

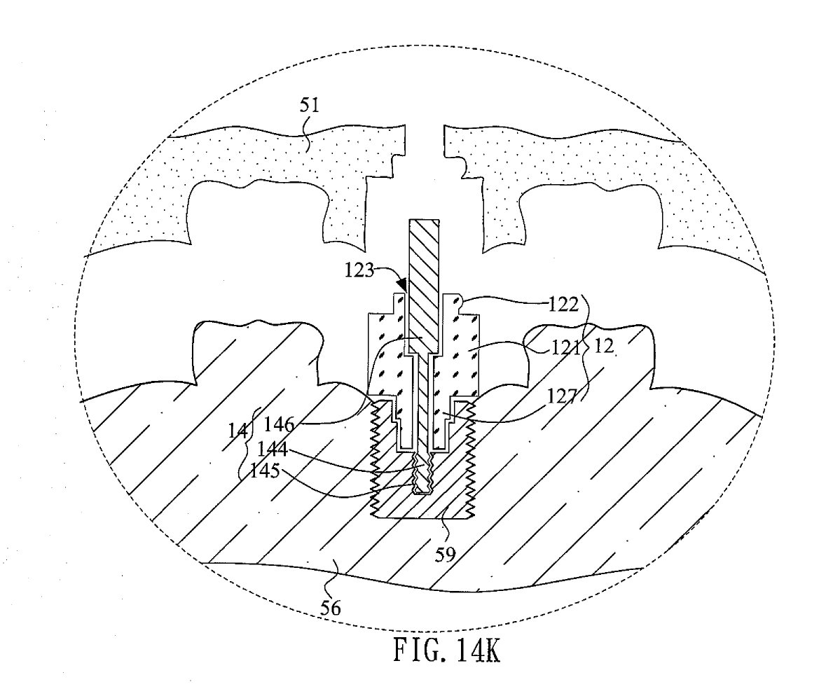

Please refer to FIG. 8 and FIG. 14A˜44B, in which the implanting suite 1 may be serve as scan abutment, impression coping transfer or UCLA abutment. The implanting method of the fifth embodiment has the following steps:

The conditions/actions of Step A11, A12 and Step A2 are demonstrated in FIG. 14A˜14B, and the process of the steps is addressed in second and fourth embodiment, no need to further described.

Step A3: selectively grinding the cap 12 in the mouth. As shown in FIG. 14C, only radial side (could be right/left side) of the cap 12 is ground, and the recognizing portion 122 is remained, such that the recognizing portion 122 and the ground cap 12 may be utilized in the followed scanning or mold taking process. FIG. 14D has shown the condition of the main body 121 ground.

Step A4: sewing the gingiva 81 around the cap 12, to make appearance of the main body 121 around the gingiva 81 correspond to the gingiva 81 mutually (Step A4a). Notice that the Step A4b is omitted in this embodiment.

Step C5: 3D oral scanning. After the sewing Step A4a, the implanting suite 1 has already been disposed in the mouth, and the cap 12 has the recognizing portion 122 disposed at upside of the cap 12, therefore contour/outer profile of the tooth 84 and the missing tooth may be directly scanned through 3D scanning device. In this manner, the positioning/marking/labelling process is then made through recognizing portion 122. In this manner, dental crown or custom abutment is able to be designed and fabricated, or a working model (or working mold) is able to be achieved, to have the ceramic or porcelain material heaped on the working model. After the ceramic or porcelain material is heaped, the dental crown or the custom abutment is then done. Thus, the purposes or functions of Step A11, A12, A2, A3, A4 and Step C5 for the present invention are served as dental scan abutment.

Except for the Step C5 made after Step A4, the Step B5 may be alternatively done after the Step A4 is progressed. The Step B5: taking mold through an impression material 51. The mold taken through the impression material 51 is demonstrated in FIG. 14E and FIG. 14F, in which the impression material 51 is downwardly moved to cover and encompass the tooth 84, gingiva 81 and the implanting suite 1, such that the downside profile of the impression material 51 may form a contour corresponded/identical to profile of the tooth 84, gingiva 81 and the implanting suite 1. As shown in FIG. 14F, upper end of the fastening member 14 is long, and therefore extended and protruded to upside of the impression material 51, after the impression material 51 is downwardly moved.

Step B6: separating the impression material 51. The impression material 51 separated is demonstrated in FIG. 14G, in which downside of the impression material 51 has contour similar/identical to the contour of the tooth 84, gingiva 81 and the implanting suite 1. In this embodiment, the separating Step B6 shall firstly have the fastening member 14 moved upward (specifically, screw to release and then upwardly move), and secondly have the impression material 51 and the cap 12 moved upward. This is so-call “Open Tray” method in dental clinics.

Step B7: engaging an imitating cap 52, a fastening member 14 or a replica 59 to the impression material 51. As shown in FIG. 14H and FIG. 14I of the embodiment, the replica 59 is firstly fastened to downside of the impression material 51 or downside of the cap 12, and afterward the fastening member 14 is secondly moved downward to pass through the inserting hole 123 of the cap 12. In this manner, the connecting portion 144 of the fastening member 14 is able to engage with the replica 59, so as to connect the impression material 51, cap 12 and the replica 59. The replica 59 is sometimes called “Analog” in dentistry. Besides, the replica 59 is preferably engaged with the cap 12 through a specific/particular orientation and azimuth (arbitrary rotation is prohibited), such that the followed modeling process will achieve accurate orientation and azimuth.

Step B8: modeling the impression material 51, imitating cap 52, fastening member 14 or/and the replica 59. After modeling, a plaster cast 56 may be fabricated (as shown in FIG. 14J) and located beneath the impression material 51, cap 12, fastening member 14 and the replica 59.

Step B9: separating the impression material 51 from the plaster cast 56 after the plaster cast 56 is hardened. The separating Step B9 may have the impression material 51 moved upward to separate from the cap 12 and the plaster cast 56. Alternatively, the separating Step B9 may also firstly have the fastening member 14 screwed to release, secondly have the impression material 51 and the cap 12 moved upward, thirdly have the cap 12 removed from the impression material 51, and finally have the cap 12 and the fastening member 14 engaged/combined with the replica 59, to dispose the cap 12 and the fastening member 14 on the plaster cast 56 (shown in FIG. 14K). After the Step B9 is made, the upper surface of the plaster cast 56 may have contour/outer profile of the tooth 84 and gingiva 81. Furthermore, the replica 59 is fixed by the plaster cast 56, and the fastening member 14 is mutually engaged with the replica 59, such that the cap 12 is able to be firmly fixed on the plaster cast 56. The cap 12 can be read/recognized/identified/distinguished through the recognizing portion 122, thus the plaster cast 56 fabricated in Step B5˜B9 may serve as “coping transfer” in dentistry because the plaster cast 56 has already recorded the contour/outer profile of the tooth 84 and the missing tooth. After Step B9 is made, waxing on the plaster cast 56 or cap 12 is able to be done; thus the implanting suite 1 may be served as UCLA abutment in dentistry or dental clinics

### 6th Embodiment

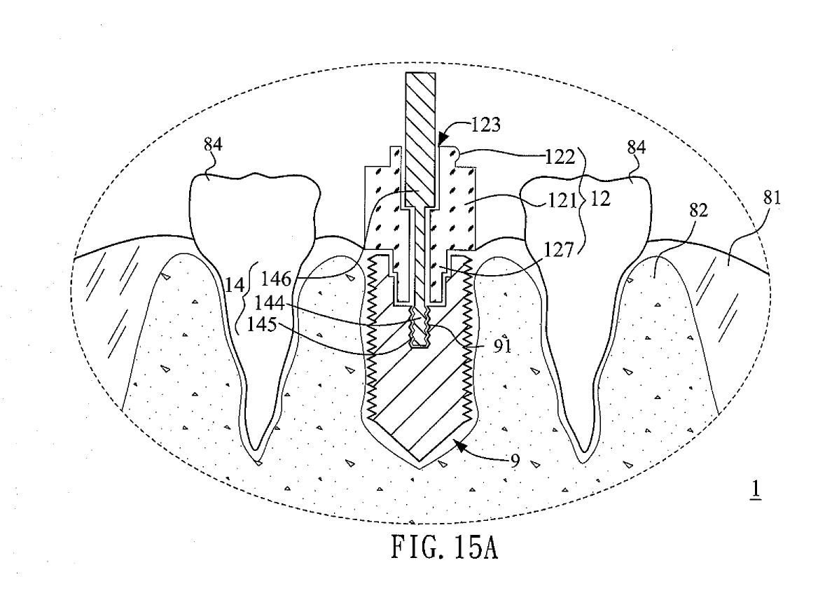

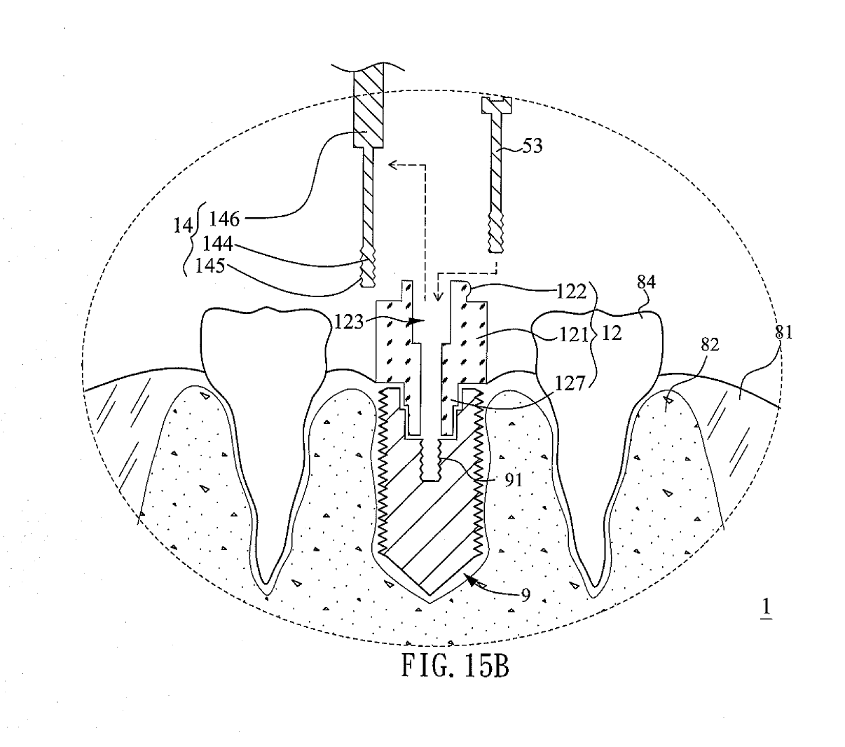

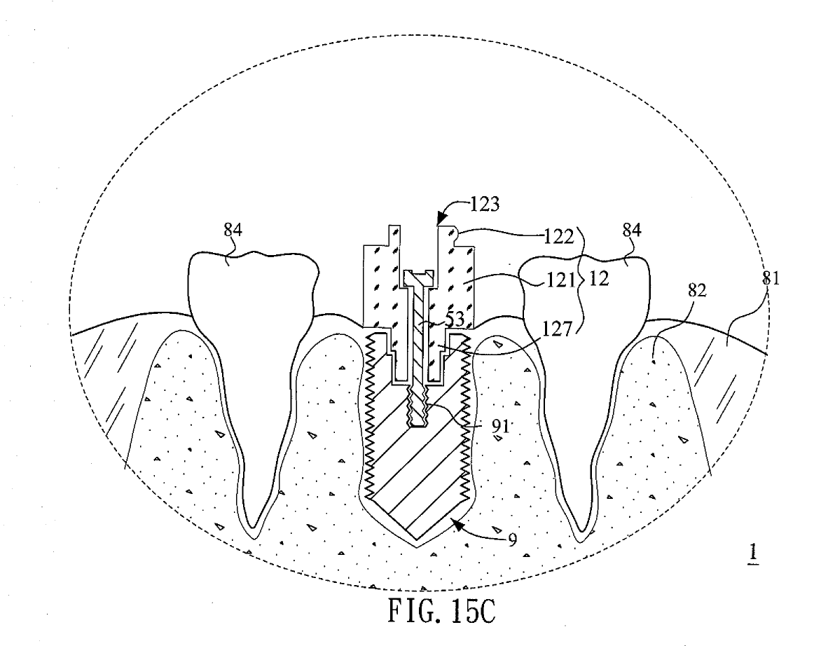

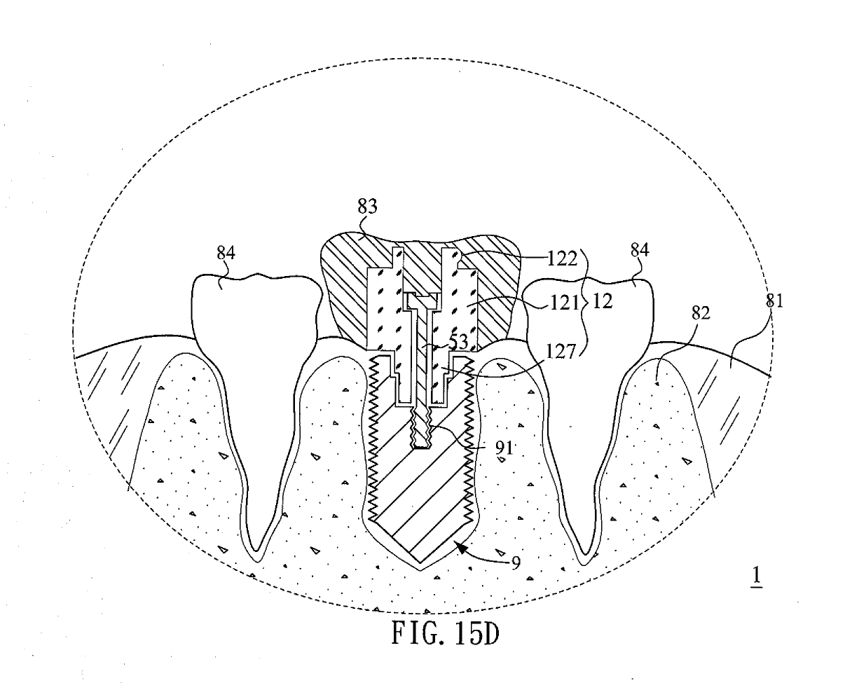

Please refer to FIG. 9 and FIG. 15A, the function of the implanting suite 1 and the implanting method are served as temporary crown. As shown in FIG. 9, the method of the sixth embodiment has the following steps:

Step A11, A12, A2, A3 and Step A4 have already addressed in the fourth and fifth embodiment. The FIG. 15A demonstrates the condition after the Step A4 is made.

Step F5: 3D oral scanning, or taking mold through the impression material 51. The scanning process utilizes a 3D scanner device to directly scan the oral condition including the profile/contour of the tooth 84, missing tooth or occlusion/bite of the mouth. The taking mold process is already demonstrated in FIG. 11E, 11F and FIG. 11G. Notice that the scanning process or the mold taking process of Step F5 are both made before gingiva 81 is healed; in comparison with that the scanning process in Step C5 and the mold taking process in Step B5 (demonstrated in FIG. 8) are both made after the gingiva 81 is healed.

Step F6: selectively further grinding the outer surface of the cap 12. The grinding could be roughly or fine-tuning. Besides, the Step F6 might be omitted.

Step F7: fabricating a temporary crown 83 on the cap 12. In this embodiment as shown in FIG. 15B, the fastening member 14 is longer, therefore the longer fastening member 14 is removed and a shorter screw 53 is substituted for the fastening member 14. The screw 53 is inserted into the inserting hole 123, so as to fasten the cap 12 and the implant 9. After the screw 53 fastened, the cap 12 is thus firmly fixed on the implant 9 without loosing or falling down, which is demonstrated in FIG. 15C. Finally as shown in FIG. 15D, a temporary crown 83 may be formed or fabricated on the cap 12 and the screw 53, such that the cap 12 of the implanting suite 1 may serve as temporary abutment.

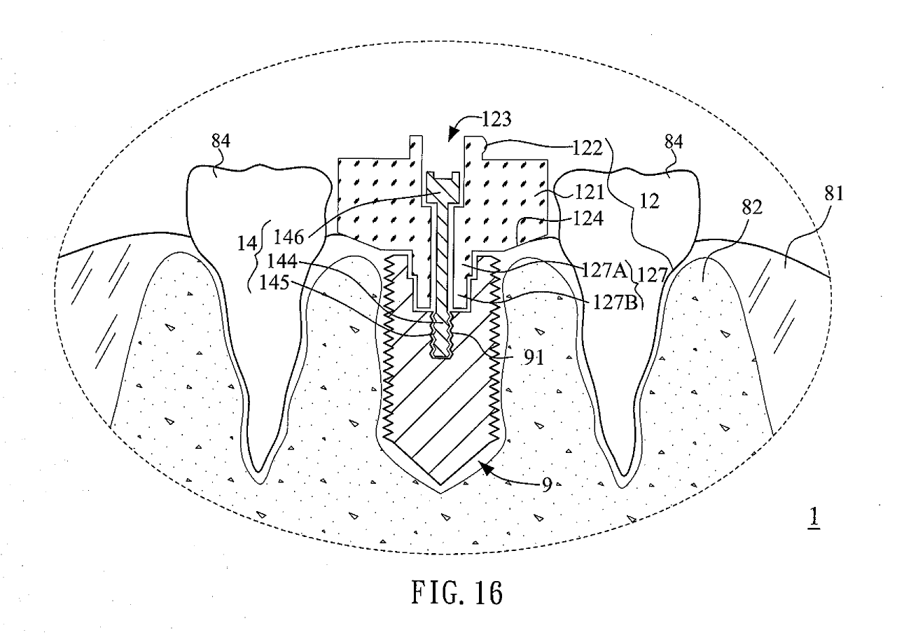

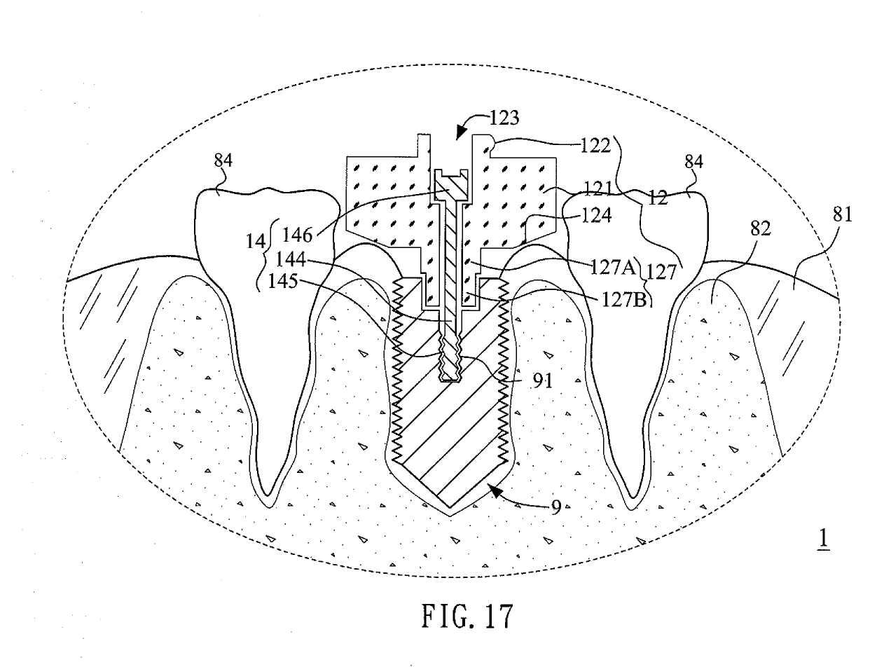

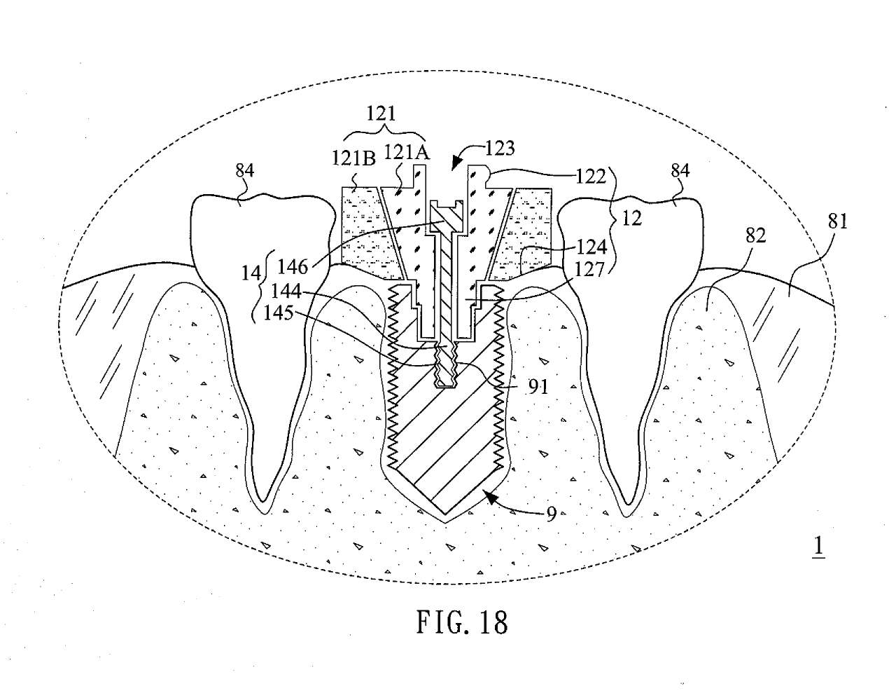

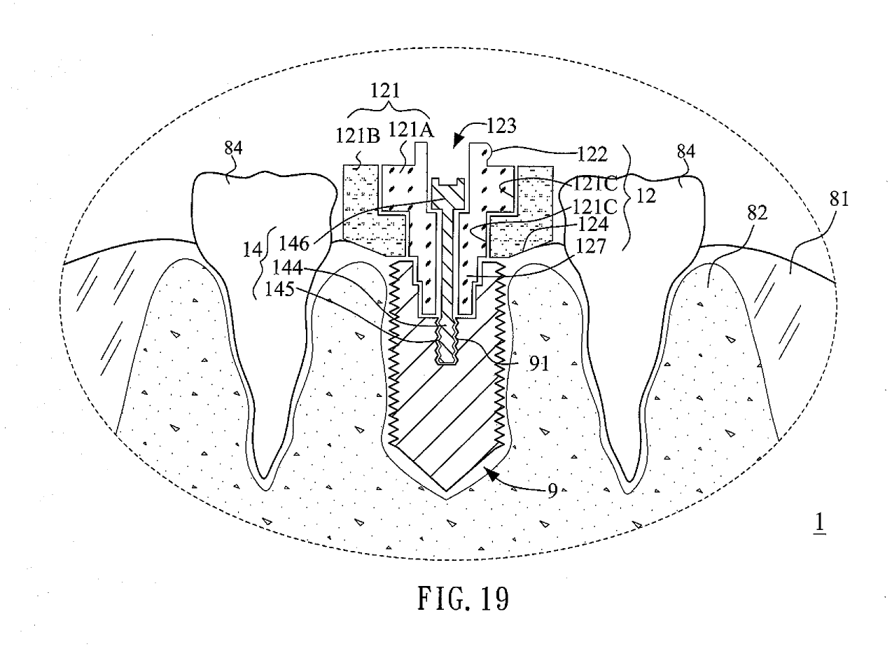

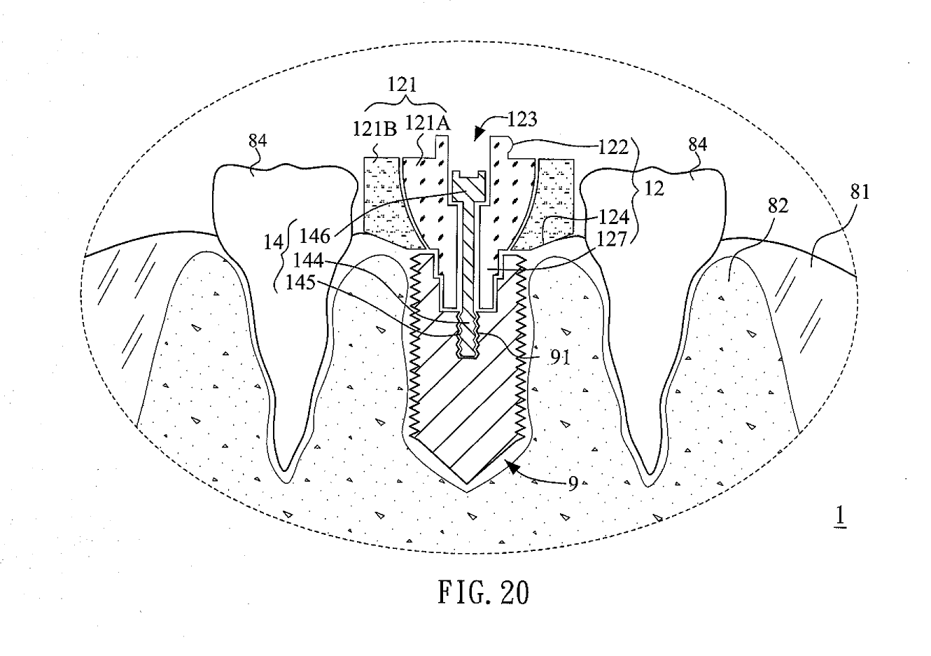

Similarly, the implanting suite 1 disclosed in the following FIG. 16˜24 may also be utilized in the implanting method disclosed in FIGS. 7˜9.

Please refer to FIG. 16, the abutting portion 146 of the fastening member 14, compare with the configuration in FIG. 13A and FIG. 13B, is shorter. Thus the abutting portion 146 may be caved in the inserting hole 123 when the abutting portion 146 is inserted into the inserting hole 123 of the cap 12. Moreover, the fitting portion 127 of the cap 12 has an upper segment 127A and a lower segment 127B, in which the upper segment 127A and the lower segment 127B are stair-shaped. When the cap 12 is fastened to the implant 9, the upper segment 127A and the lower segment 127B of the fitting portion 127 will be inserted into inside of the implant 9. Therefore the mechanical strength of the combination between the cap 12 and the implant 9 will be reinforced.

Please refer to FIG. 17, the fitting portion 127 of the cap 12 also has an upper segment 127A and a lower segment 127B. In this embodiment, the fitting portion 127 is engaged with the implant 9 through different site (i.e. different altitude) relative to the configuration of FIG. 16. Specifically, the cap 12 shown in FIG. 17 has the fitting portion 127 engaged with the implant 9 through the lower segment 127B; thus the lower segment 127B is inserted into inside of the implant 9 and the upper segment 127A is disposed above the implant 9. In comparison to FIG. 16, the cap 12 has the fitting portion 127 engaged with the implant 9 through the upper segment 127A and the lower segment 127B; thus the upper segment 127A and the lower segment 127B are inserted into inside of the implant 9 simultaneously. In this manner, the cap 12 may suit with implants 9 with different brands.

Please refer to FIG. 18, the main body 121 of the cap 12 may further has a prime portion 121A and an auxiliary portion 121B, in which the auxiliary portion 121B is disposed at radial exterior of the prime portion 121A and could be detachably engaged with the prime portion 121A. In this embodiment as shown in sectional view of FIG. 18, the contact site between the prime portion 121A and the auxiliary portion 121B forms a tilted straight line; thus the contact site between the prime portion 121A and the auxiliary portion 121B is absolutely a cone shape, and the radial outer surface of the prime portion 121A is also a cone shape. In this manner, the implanting suite 1 is engaged with the implant 9 through: firstly placing the auxiliary portion 121B at upside of the implant 9, secondly moving the prime portion 121A downward to have the fitting portion 127 inserted into the implant 9, and finally moving the fastening member 14 downward to pass through the inserting hole 123; therefore the connecting portion 144 disposed at downside of the fastening member 14 is able to be engaged and fastened with the internal bore 91 of the implant 9.

Please refer to FIG. 19, the contact site between the prime portion 121A and the auxiliary portion 121B is stair-shaped, therefore radial exterior of the prime portion 121A is formed by two pillars 121C which have different cross-sectional widths. Preferably, these two pillars 121C are cylinders with different radiuses. Note that the fastening process of prime portion 121A, auxiliary portion 121B and the fastening member 14 in this embodiment is similar to the process in FIG. 18.

Please refer to FIG. 20, the contact site between the prime portion 121A and the auxiliary portion 121B forms a curve.

Please refer to FIG. 21, the contact site between the prime portion 121A and the auxiliary portion 121B forms a slightly-tilted straight line, and the downside of the contact site (i.e. downside of the straight line) is adjacent to the adapting face 124. As shown in FIG. 21, downside of the prime portion 121A is equal to the diameter of the implant 9, thus the implanting suite 1 is easily taken out by hands. Additionally, the fitting portion 127 in this embodiment is caved in the cap 12, and the upside of the implant 9 has a convex 96 protruded outward; therefore upside of the implant 9 is able to be inserted into inside of the fitting portion 127 (also inserted into inside of the cap 12), so as to connect with the fitting portion 127.

Please refer to FIG. 22, the main body 121 is composed of a prime portion 121A and an auxiliary portion 121B. The auxiliary portion 121B encompasses the radial exterior of the prime portion 121A. As shown in sectional view of the FIG. 22, the contact site between the prime portion 121A and the auxiliary portion 121B forms a stair-shape. Besides, top area of the prime portion 121A is caved in the inserting hole 123, so as to be disposed beneath the top area of the auxiliary portion 121B. Moreover, the upper segment 127A and the lower segment 127B (i.e. fitting portion 127) are disposed at downside of the prime portion 121A; the cap 12 is inserted into the implant 9 through downside of the prime portion 121A. The bottom of the auxiliary portion 121B is abutted against and contacted with the upper segment 127A. In this manner, the auxiliary portion 121B and the prime portion 121A may be firmly fastened and combined without loosing or falling down. Besides, the inserting hole 123 is vertically passed through the prime portion 121A of the main body 121. After the cap 12 is downwardly moved to fastened with implant 9, the fastening member 14 may then be downwardly inserted into the inserting hole 123, such that the thread 145 disposed on the connecting portion 144 may be engaged with the internal bore 91 of the implant 9. Furthermore, the abutting portion 146 is abutted against the upside of the prime portion 121A, therefore the prime portion 121A and the cap 12 are hence clamped and confined. After the prime portion 121A and the cap 12 are confined, the abutting portion 146 of the fastening member 14 may be caved in the cap 12.

Please simultaneously refer to FIG. 23A, 23B and FIG. 24, the fitting portion 127 is disposed at downside of the prime portion 121A, so as to engage with the implant 9. In order to have the prime portion 121A (and the cap 12) fastened with the implant 9 in a specific azimuth, an anti-rotational element 128C is disposed at outer surface of the fitting portion 127, in which the anti-rotational element 128C could be hexagonal pillar (FIG. 23B), dot structure (FIG. 24), polyhedron, convex, pit, protrude, cave, recess or even other structure with irregular shape. In this manner, the implant 9 may correspondingly dispose a coupling structure to match with or fit to the anti-rotational element 128C, such that the prime portion 121A and the cap 12 may be fastened with the implant 9 through a specific azimuth. The specific azimuth means that the prime portion 121A may only be engaged with the implant 9 through a predetermined or pre-designed azimuth, and cannot be arbitrarily rotated along the first axle A1. In other embodiments, the anti-rotational element 128C may be disposed at the contact site between the fitting portion 127 and the implant 9 as disclosed in FIG. 16˜22, such that the cap 12 may be engaged with the implant 9 by a specific azimuth. Further refer to FIG. 23B and the enlarged diagram of the FIG. 23A, the main body 121 further has a coupling unit (could be more); the coupling unit in this embodiment is joint of concave 128A and extruding element 128B. The coupling unit is disposed at contact site of the prime portion 121A and the auxiliary portion 121B; namely the concave 128A is disposed at outer wall of the prime portion 121A, and the extruding element 128B is disposed at inner wall of the auxiliary portion 121B. The prime portion 121A and the auxiliary portion 121B may be engaged in a specific orientation/azimuth through the coupling unit; the prime portion 121A and the auxiliary portion 121B may also be selectively fastened and separated through the coupling unit. In practice, disposed location of the concave 128A and the extruding element 128B is exchangeable, and the coupling unit may also be some other configuration with functions of coupling, engaging, matching, fitting, or snap catching.

Additionally, the anti-rotational element 128C may be disposed at the corresponding site between cap 12 and head 141, or between positioning portion 142 and flange 143, as disclosed in FIG. 1˜6. Thus the cap 12 may be fastened with the fastening member 14 by a specific azimuth. The anti-rotational element 128C may be disposed at the corresponding site between fastening member 14 and implant 9 as disclosed in FIG. 1˜6, such that the fastening member 14 may be fastened with the implant 9 by a specific azimuth. Moreover, the anti-rotational element 128C may be further disposed at the contact site between replica 59 and cap 12, or between imitating cap 52 and fastening member 14, so as to have the replica 59 and the cap 12 fastened by specific azimuth (FIG. 14H˜14K), or have the replica 59 and the imitating cap 52 fastened by specific azimuth, or have the replica 59 and the fastening member 14 fastened by specific azimuth (FIG. 11H˜11M).

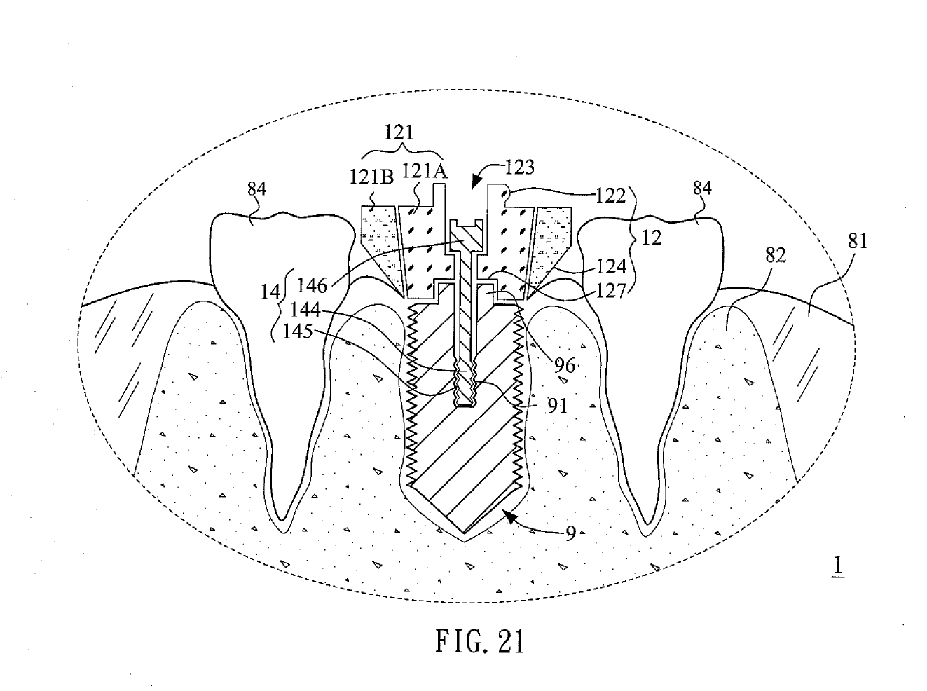

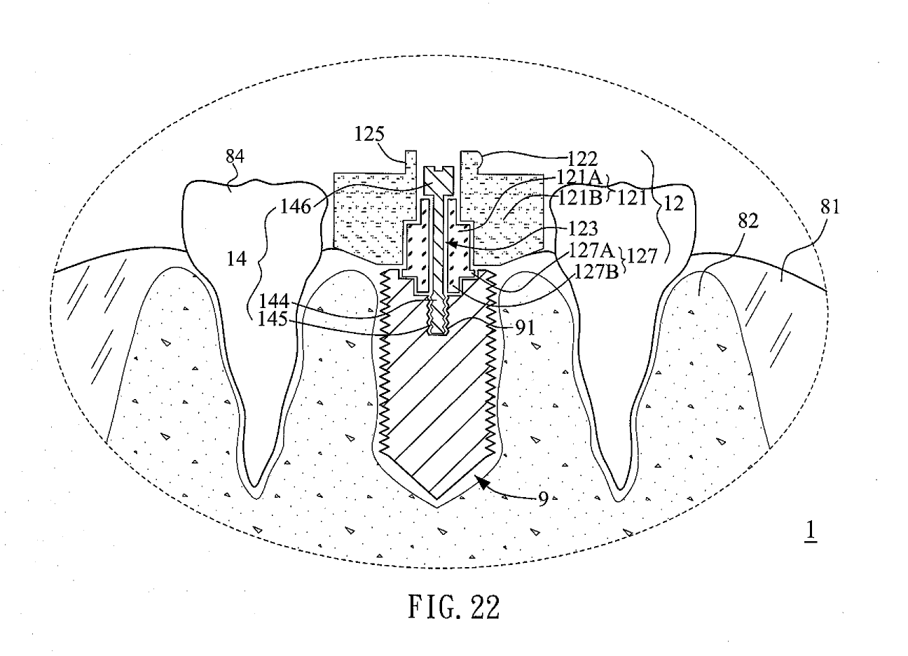

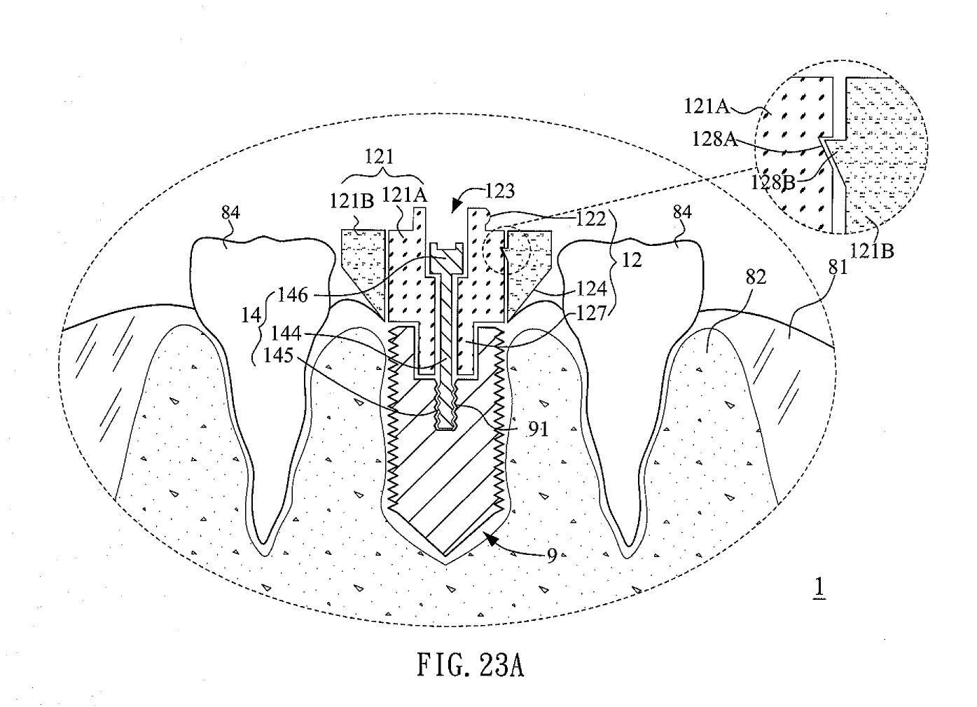

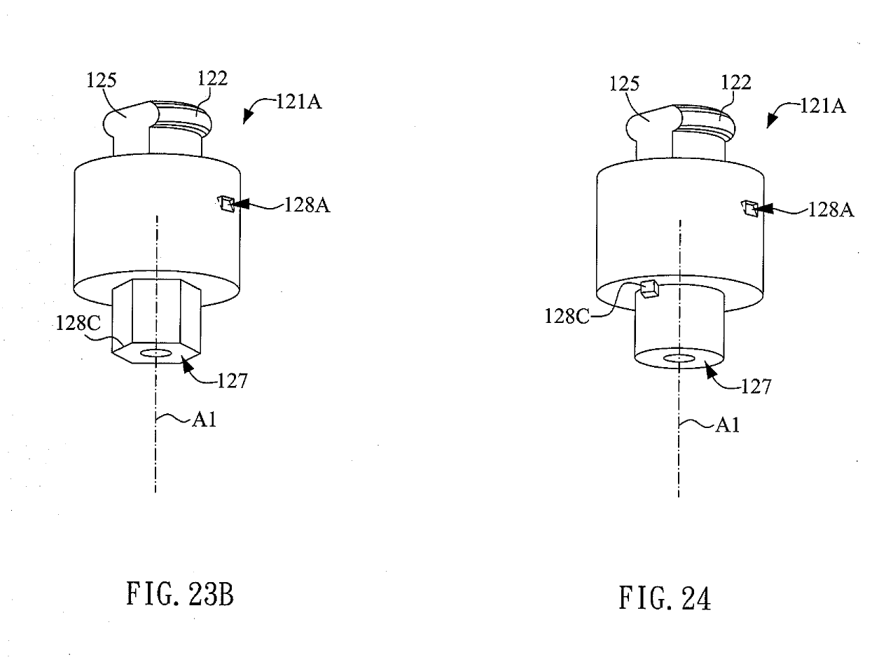

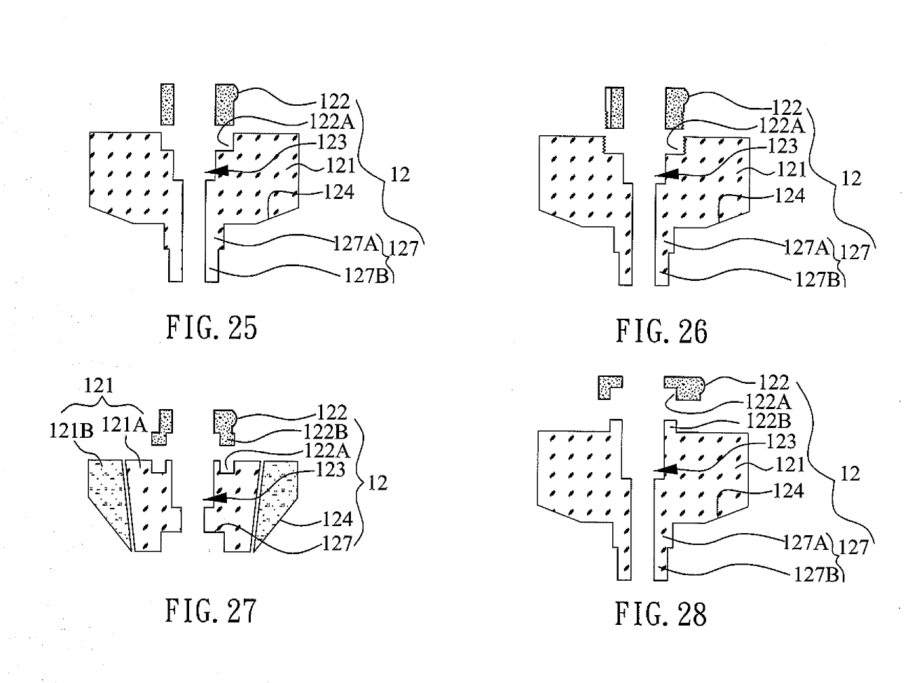

The cap 12 of the present invention may have some other configurations, for example, the recognizing portion 122 and the main body 121 may be detachably engaged. Please refer to FIG. 25, the cap 12 has a recess 122A disposed at neighbor of the inserting hole 123, such that the recognizing portion 122 may be detachably engaged with the main body 121. Specifically, downside of the recognizing portion 122 may be inserted into the recess 122A and then firmly fixed to the main body 121 if the recognizing portion 122 is moved downward. Preferably, the recognizing portion 122 further has the aforememtioned anti-rotational element 128C disposed at the location adjacent to, corresponded to, or contact with the recess 122A, such that the recognizing portion 122 may be engaged with the main body 121 by a specific azimuth.

Please refer to FIG. 26, the recognizing portion 122 and the main body 121 are detachable configuration; the recess 122A further has a internal bore (unmarked), and the recognizing portion 122 further has a thread (unmarked) disposed at the downside. Therefore the recognizing portion 122 may be downwardly moved and then screwed in the recess 122A through the engagement of the internal bore and the thread.

Please refer to FIG. 27, the main body 121 is composed of prime portion 121A and auxiliary portion 121B. The recognizing portion 122 may be detachably engaged with the prime portion 121A. The recognizing portion 122 has a convex 122B downwardly extended from the recognizing portion 122. The recess 122A is disposed at top of the prime portion 121A, and the recess 122A is not communicated with the inserting hole 123. When the recognizing portion 122 moves downwardly, the recognizing portion 122 may be firmly fixed on the main body 121 of the cap through the engagement of the recess 122A and the convex 122B. Similarly, the locations of the recess 122A and the convex 122B are exchangeable.

Please refer to FIG. 28, the recess 122A is disposed at inner downside of the recognizing portion 122, and the convex 122B is disposed at top of the main body 121 (adjacent to the inserting hole 123), hence the recognizing portion 122 may be firmly fixed to the main body 121 of the cap 12 through the engagement of the recess 122A and the convex 122B.

Note that, if the implanting suite 1 disclosed in FIG. 16˜24 are utilized in the methods disclosed in FIG. 7 or FIG. 9, the detailed action or process will be the same with the fourth embodiment (FIG. 7, FIG. 13A˜13D) or sixth embodiment (FIG. 9, FIG. 15A˜15D).

### 7th Embodiment

If the implanting suite 1 disclosed in FIG. 16˜24 are utilized in the method of FIG. 8, the processes of Step A11, A12, A2, A3, A4 and Step C5 are similar to the fifth embodiment (FIG. 14A˜14D). If the implanting suite 1 disclosed in FIG. 16˜24 are utilized in the Step B5˜B7 disclosed in FIG. 8, the method is so-called “Close Tray” modeling, in which the following steps are introduced:

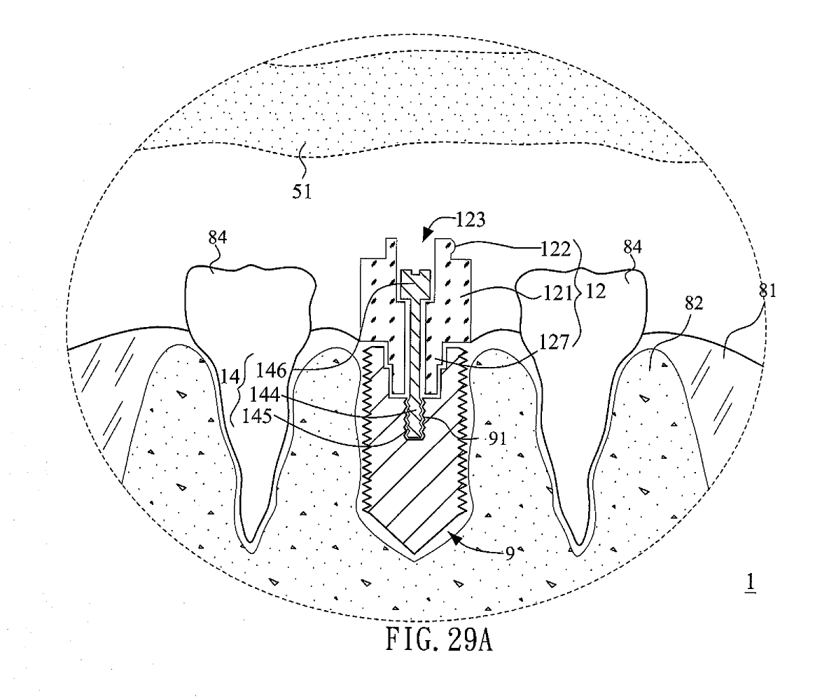

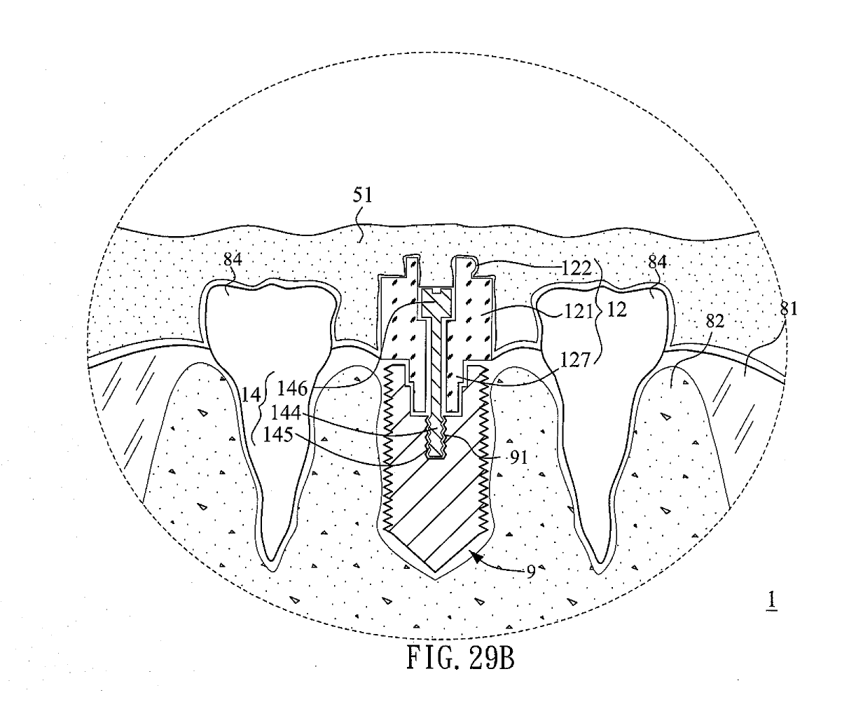

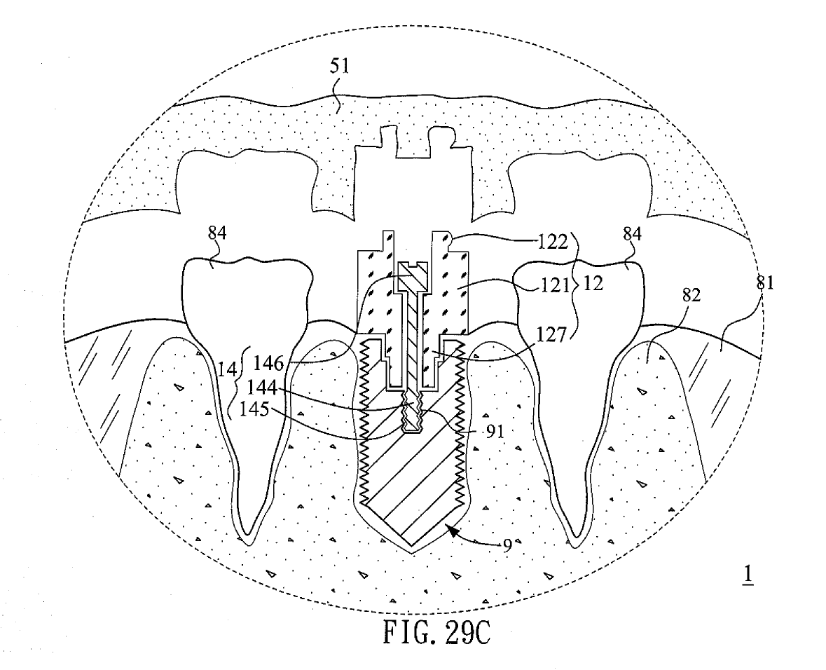

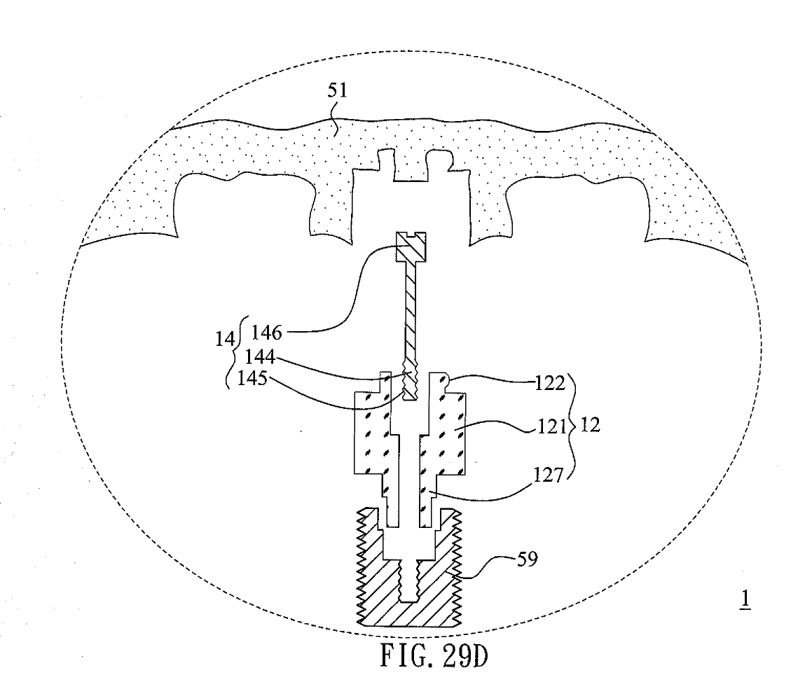

Step B5: taking mold through an impression material 51. The condition of mold taking is demonstrated in FIG. 29A, and the fastening member 14 is caved in the inserting hole 123 of the cap 12, and the impression material 51 is disposed at upper of the cap 12 and fastening member 14. As shown in FIG. 29B, the impression material 51 then is moved downward, such that the impression material 51 covers and encompasses the tooth 84, gingiva 81, cap 12 and the fastening member 14; afterward downside of the impression material 51 forms the contour/outer profile of the tooth 84, gingiva 81, cap 12 and the fastening member 14. Preferably, the location inside the inserting hole 123 and above the fastening member 14 may be further filled with the filling material (unmarked) before the impression material 51 is downwardly moved. In this manner, the impression material 51 entering the inserting hole 123, to adhere or seal the cap 12 and the inserting hole 123, is prevented and prohibited.

Step B6: separating the impression material 51. FIG. 29C shows that the impression material 51 is taken out. The fastening member 14 is firmly engaged the cap 12 with the implant 9. When the impression material 51 is moved upward, the cap 12 and the fastening member 14 will be separated from the impression material 51. After the impression material 51 is separated, the downside of the impression material 51 may have contour/outer profile of the tooth 84, gingiva 81, cap 12 and the fastening member 14.

Step B7: engaging an imitating cap 52, a fastening member 14 or a replica 59 to the impression material 51. In this embodiment, firstly the fastening member 14 is removed, and then the cap 12 and the implant 9 is separated; Secondly a cap 12, fastening member 14 and a replica 59 are combined and disposed at below of the impression material 51, which is shown in FIG. 29D. Lastly the cap 12, fastening member 14 and the replica 59 is inserted into downside of the impression material 51, shown in FIG. 29E, and therefore the replica 59 may be substituted for the implant 9 to achieve the following plaster modeling process (Step B8). Step B8 is already addressed, so no need to further described. Here, the replica 59 has similar structure with the implant 9, therefore can be utilized to combine with the cap 12 and fastening member 14, so as to duplicate, imitate, simulate or represent the location, position and azimuth of the implant 9 relative to the underlying bone 82. In this manner, the implant suite 1 disclosed in FIG. 16˜24 may be utilized in Step B5 B7 disclosed in FIG. 8, such that “Close Tray” method is achieved. Note that the implanting suite 1 disclosed in FIG. 16˜24 may be entirely utilized in all steps disclosed in FIG. 8.

### 8th Embodiment

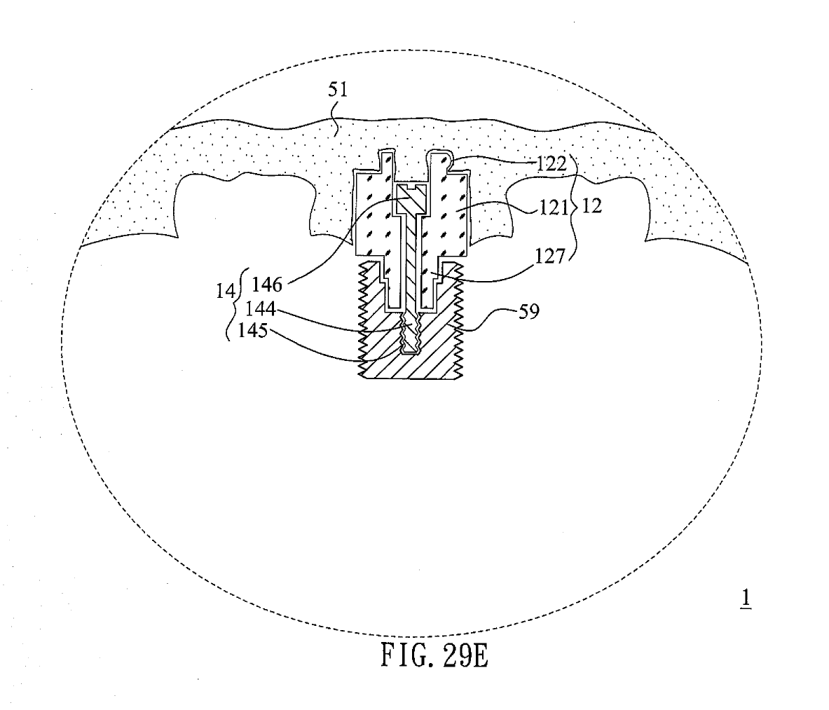

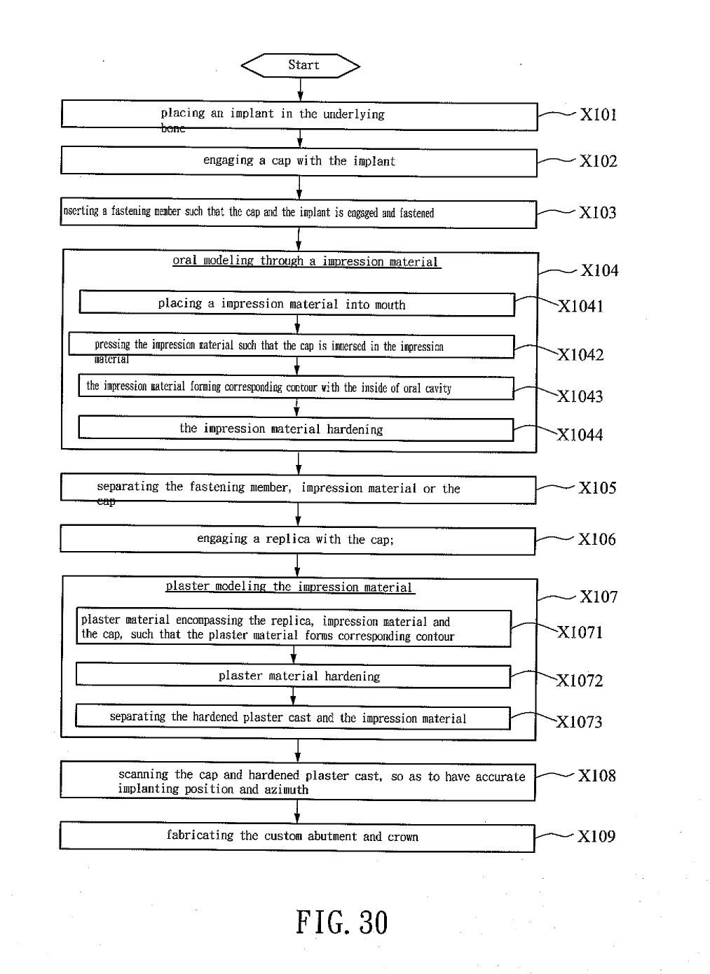

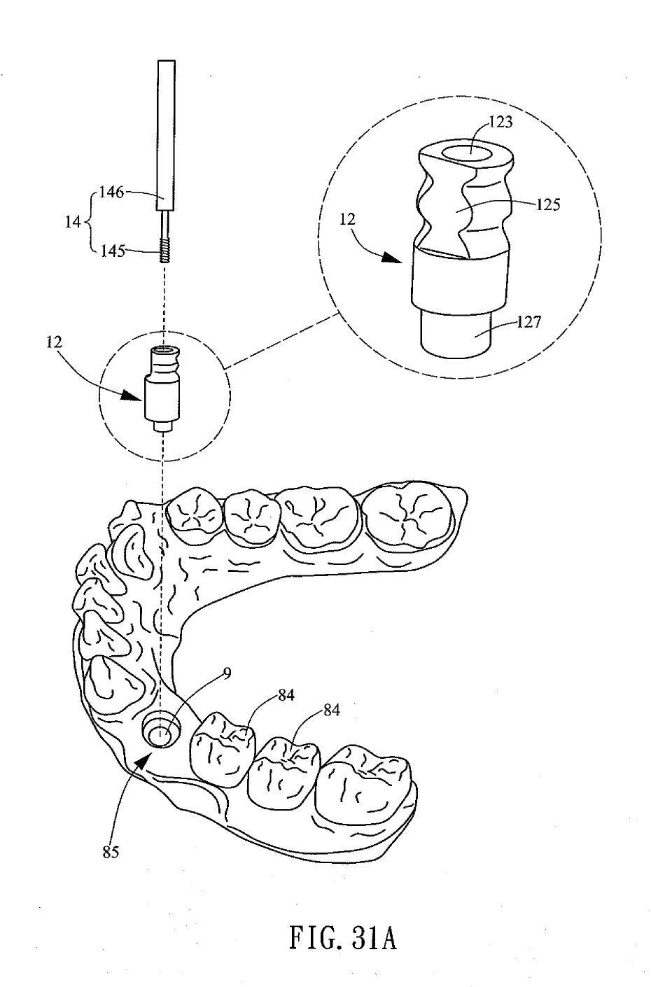

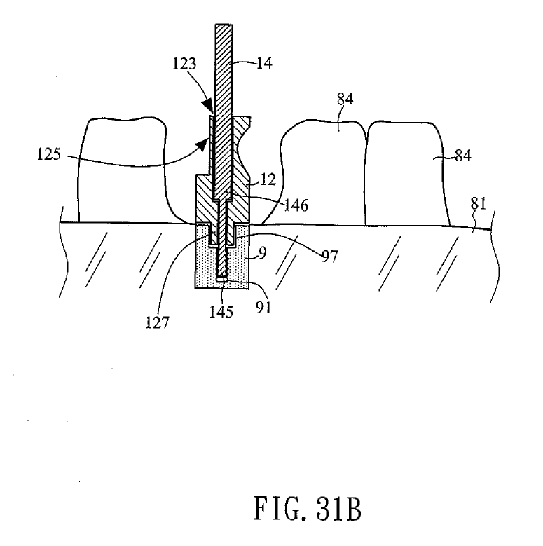

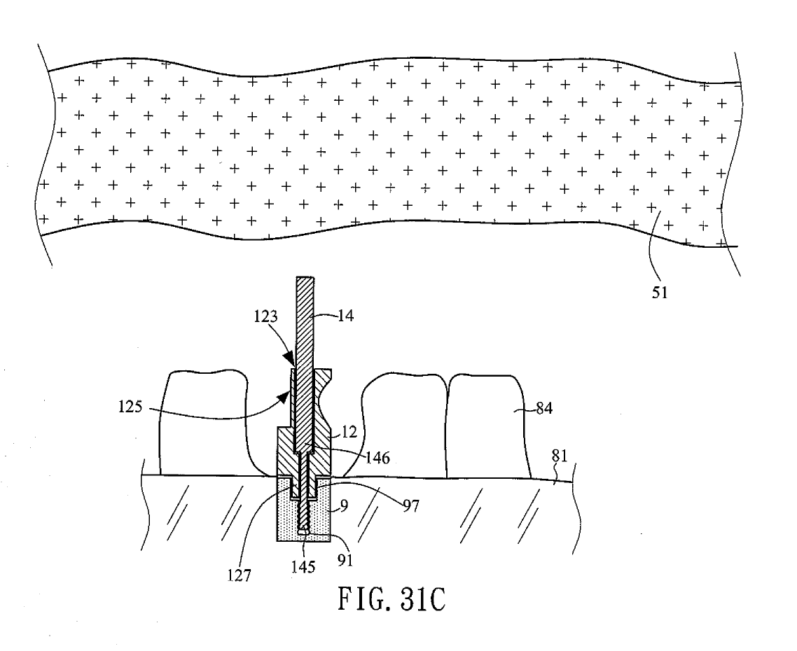

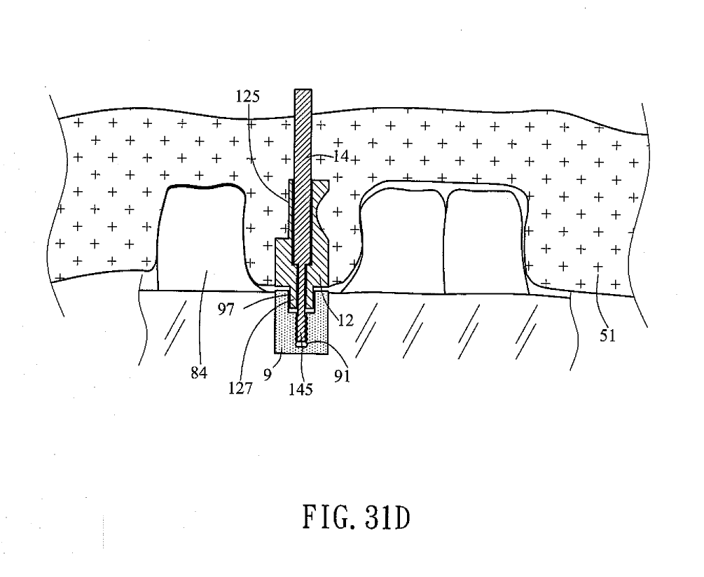

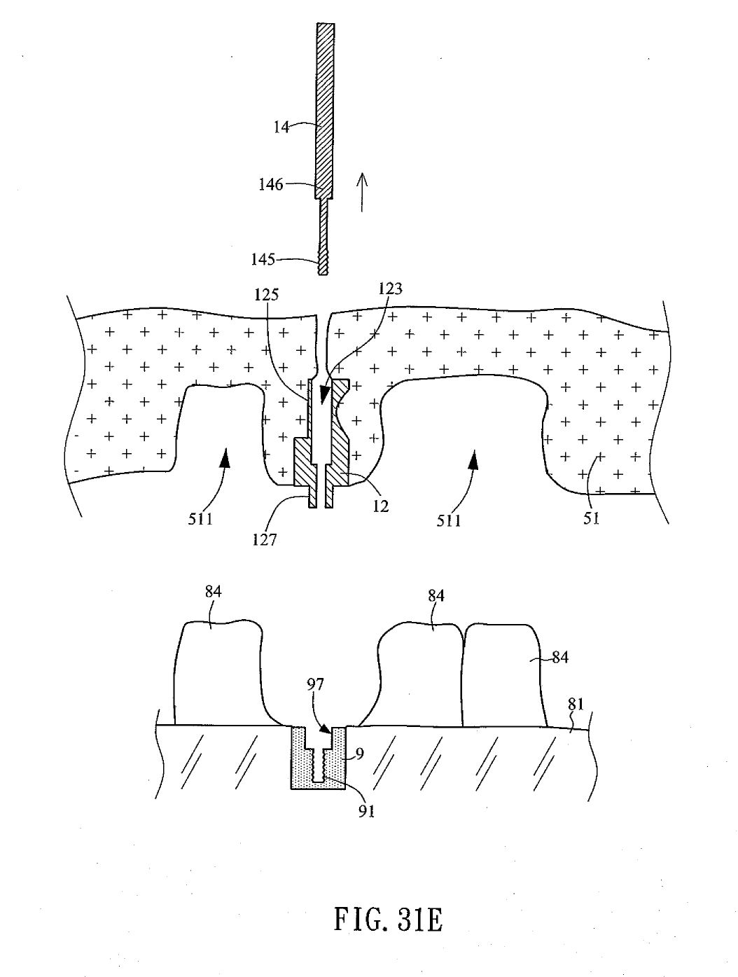

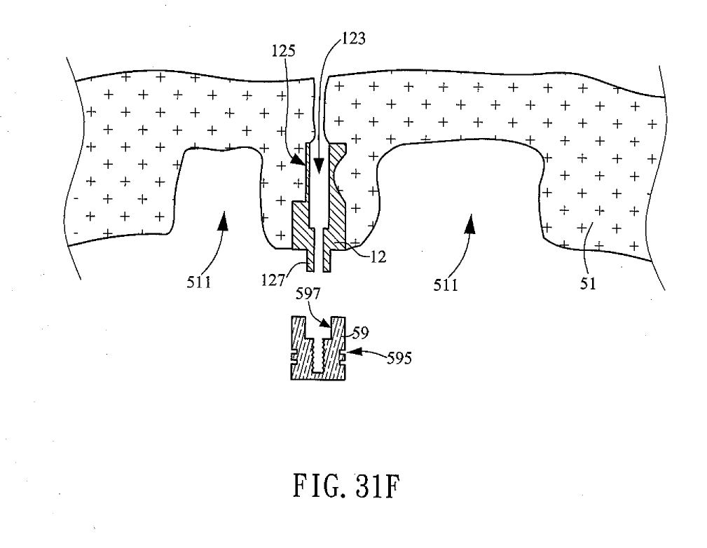

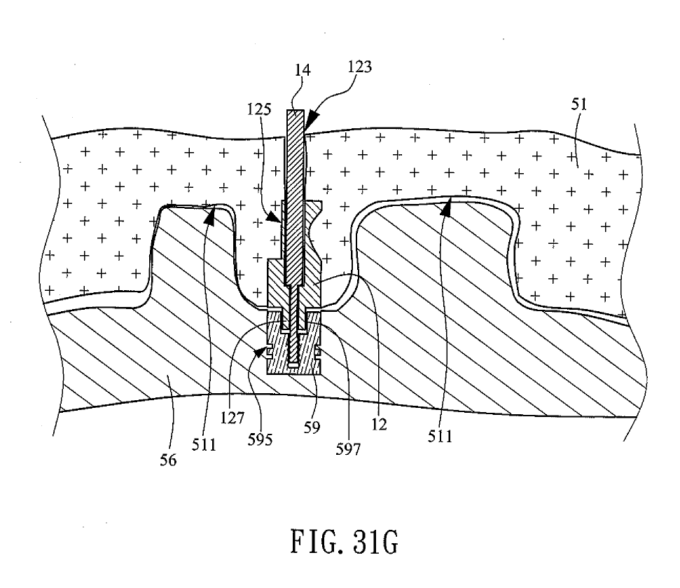

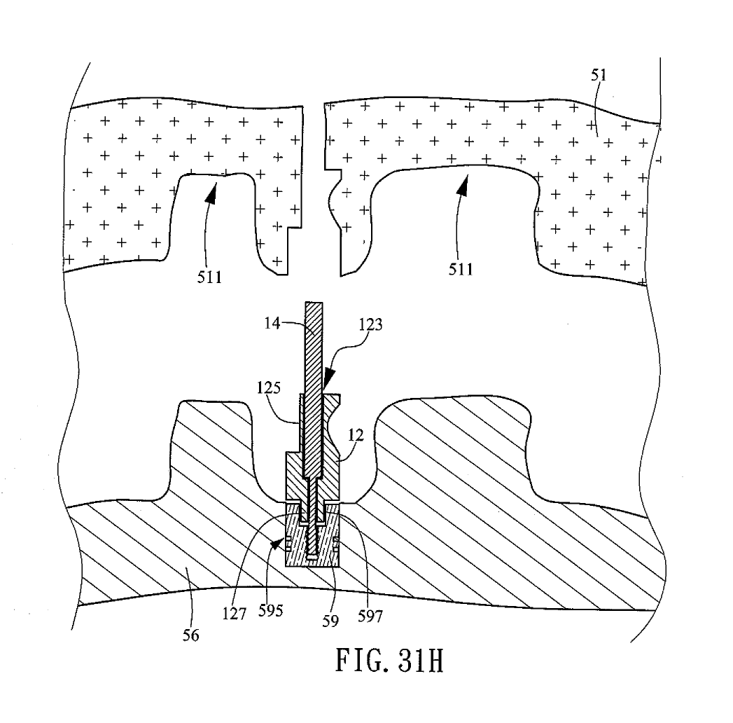

Please refer to FIG. 30 and FIG. 31A, a missing tooth 85 is in the mouth of patient, and the site of the missing tooth 85 has been placed an implant 9, such that the implant 9 is disposed in the underlying bone (Step X101). Then a cap 12 may be inserted into the implant 9, so as to engage with the implant 9 (Step X102). The fastening structure of the cap 12 and the implant 9 is shown in FIG. 31B, in which downside of the cap 12 is utilized to engage with the implant 9. Specifically, the cap 12 has a information area 125, a fitting portion 127 and an inserting hole 123. The information area 125 has a plane disposed at upside and outer exterior of the cap 12. In other embodiments, the information area 125 may be convex, cave, curve with convex and cave, or irregular shape. The fitting portion 127 is disposed at downside of the cap 12, and downwardly protruded against the cap 12. The inserting hole 123 is vertically passed through the cap 12; upside of the inserting hole 123 is adjacent to the information area 125, and downside of the inserting hole 123 is adjacent to the fitting portion 127. Namely the information area 125 and the fitting portion 127 are respectively disposed at two axial ends of the cap 12. Upside of the implant 9 has a recess 97 corresponded to the fitting portion 127, and downside of the implant 9 is closed type. The contour/outer profile of the fitting portion 127 is matched with the recess 97; therefore the fitting portion 127 of the cap 12 may be inserted into the recess 97 disposed at the upper part of the implant 9, so as to engage with the implant 9. Preferably, the fitting portion 127 inserted into the implant 9 presents tightly-fit. In other embodiments, the fitting portion 127 of the cap 12 engaged with the recess 97 of the implant 9 may take advantage of screwing (e.g. through a internal bore and a thread).

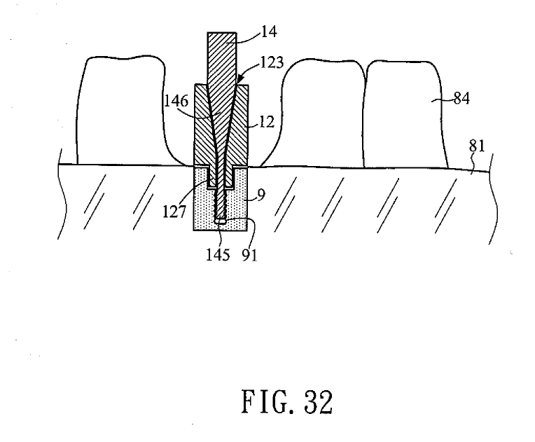

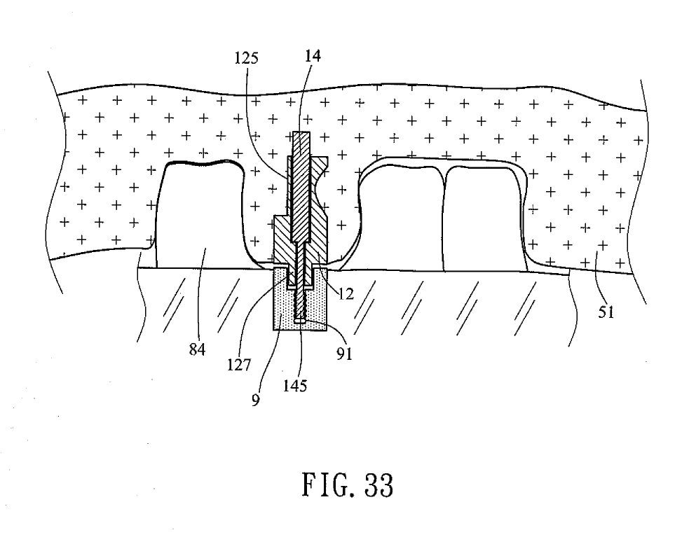

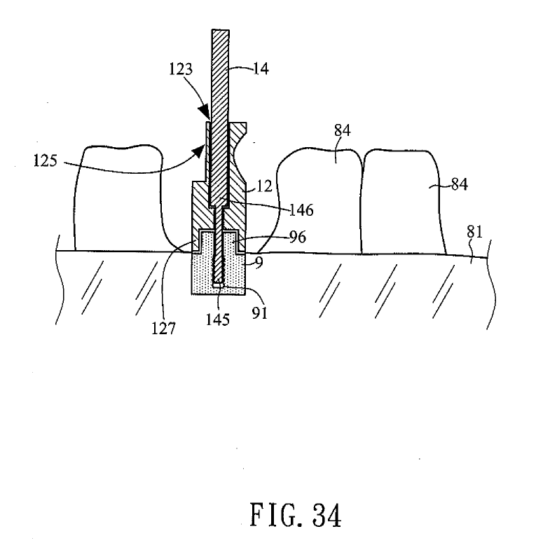

As shown in FIG. 31A˜31B, a fastening member 14 is inserted such that the cap 12 and the implant 9 is engaged and fastened (Step X103). In this embodiment, interior of the implant 9 has a internal bore 91, and the fastening member 14 has a thread 145 and a abutting portion 146. The thread 145 is disposed at downside of the fastening member 14, and the abutting portion 146 is disposed at radial exterior of the fastening member 14. Hence the thread 145 may be engaged with and fastened to the internal bore 91. In this manner, the fastening member 14 is passed through the cap 12 so as to fasten the implant 9 and the cap 12, through the engagement of the internal bore 91 and the thread 145. After fastening, the abutting portion 146 of the fastening member 14 may abut against and push the inner wall of the inserting hole 123 (shown in FIG. 31B); therefore the inner wall of the inserting hole 123 may clamp the abutting portion 146. Furthermore, the abutting portion 146 is stair-shaped, and the inner wall of the inserting hole 123 is also stair-shaped, therefore the outer wall of the abutting portion 146 is matched with the inner wall of the inserting hole 123. In other embodiments, the abutting portion 146 may be inverse-cone shaped as demonstrated in FIG. 32, in which upper volume of the abutting portion 146 is greater than lower volume. Correspondingly, the inner wall of the inserting hole 123 is also inverse-cone shaped, such that the inserting hole 123 may be matched with the abutting portion 146.

Next, oral modeling through an impression material 51 (Step X104). Note that the modeling process may be diversified, so is not limited in this embodiment disclosed. Preferably as shown in FIG. 31C, the oral modeling process may further have sub-steps including: placing a impression material 51 into the mouth of patient (Step X1041). Then the impression material 51 is disposed on the tooth 84. Afterward as shown in FIG. 31D, the impression material 51 is pressed such that the cap 12 is immersed in the impression material 51 (Step X1042). Therefore the impression material 51 may cover or encompass the tooth 84, cap 12 and the fastening member 14. Besides, the impression material 51 may be pressed by hands or by occlusion bite of the patient. In this manner, the impression material 51 may form a corresponding contour matching with the inside of the oral cavity (Step X1043). Lastly, the impression material 51 is hardened (Step X1044), and therefore the modeling Step X104 is made.

As shown in FIG. 31E, the fastening member 14, impression material 51 or/and the cap 12 is separated (Step X105). In this embodiment, the fastening member 14 is upwardly passed through the impression material 51 when the impression material 51 moved downwardly to cover the tooth 84, cap 12 and the fastening member 14. Besides, the separating Step X105 may be firstly screwed the fastening member 14 to have the internal bore 91 and the thread 145 detached, secondly have the fastening member 14 upwardly moved, thirdly have the fastening member 14 separated from the cap 12 and the implant 9, and lastly have the cap 12 and the hardened impression material 51 upwardly moved. After the cap 12 and the impression material 51 are upwardly moved and separated, the room 511 formed at downside of the impression material 51 will be matched with the contour/outer profile of the tooth 84 and gingiva 81.

As shown in FIG. 31F, a replica 59 is engaged with downside of the cap 12 (Step X106), such that the fitting portion 127 of the cap 12 is engaged to and fastened with the contacting site 597 of the replica 59. Note that the contour or outer profile of the contacting site 597 is preferably identical to the recess 97 of the implant 9. In this manner, the replica 59 may be substituted for the implant 9. Moreover, the replica 59 has at least one trough 595 disposed at outer wall, in which the number of the trough 595 may be a plurality; thus a plurality of troughs 595 may be regularly disposed at outer wall of the replica 59 (could also be irregularly disposed along the axial direction or radial direction).

As shown in FIG. 31G, the impression material 51 is plaster modeled (Step X107). In this embodiment, the impression material 51, cap 12, fastening member 14 and the replica 59 are simultaneously modeled. The modeling Step X107 may further has sub-steps: firstly fastening the cap 12 and the replica 59 through the fastening member 14; secondly encompassing the replica 59, impression material 51, fastening member 14 and the cap 12 through the plaster material, such that the plaster material may forms a corresponding contour matching with the impression material 51 and the replica 59 (Step X1071); thirdly hardening the plaster material (Step X1072); fourthly separating the hardened plaster cast 56 and the impression material 51 (Step X1073) as shown in FIG. 31H, and then the replica 59 is encompassed inside the plaster cast 56. In the meantime, the cap 12 is exposed to exterior of the plaster cast 56. Therefore, the replica 59 is firmly fixed on the plaster cast 56, and the cap 12 and the replica 59 is firmly fastened through the fastening member 14, such that the replica 59 and the cap 12 may be hence firmly fixed, without loosing or falling down. In the modeling process disclosed in FIG. 31G and FIG. 31H, the fastening member 14 is inserted to fasten the cap 12 and the replica 59. In other embodiments, the fastening member may be omitted; thus a tightly-fit or screw fastening between the cap 12 and the replica 59 could also be substituted, and therefore the modeling Step X107 may also be progressed.

After the modeling Step X107 is made, the plaster cast 56 is already had contour of the impression material 51, cap 12 and the replica 59. Comparative to FIG. 31C, the plaster cast 56 has already recorded, copied and then fabricated (i.e. modeled) the contour/position/orientation/azimuth of the tooth 84, gingiva 81 and the missing tooth 85. Additionally, the contour/position/orientation/azimuth of the implant 9 is also be cloned through the replica 59.

In this manner, 3D scanning device may directly scan the cap 12 and the hardened plaster cast 56, such that digital data regarding to the 3D contour of the plaster cast 56 is achieved through computer software, thus the contour of tooth 84, gingiva 81, underlying bone and missing tooth 85 is recorded and digitized. By the distinguishable information area 125, the contour recorded in the computer software is readable and recognizable, so as to have function of positioning. Afterward, the CAD/CAM software may do the “mapping”, which compare the recorded contour data and the information of the cap 12 (including data/contour of the information area 125). Thus, the cap 12 and the hardened plaster cast 56 are scanned, so as to have accurate implanting position and azimuth (Step X108). In this manner, the physical mold is then fabricated, so as to help the fabricating the custom abutment and crown (Step X109), and eventually the dental prosthesis is able to be precisely made.

Besides, the cap 12 of the implanting suite 1 could be plastic, so the cap 12 is single-use type. In this manner, the implanting suite 1 may have the cap 12 been directly utilized or worked on the cap 12. In a word, the implanting suite 1 may have plurality of functions served in dentistry or dental clinics. Additionally as shown in FIG. 32, downside of the implant 9 may be opened, i.e. the implant 9 is a through-type structure.

### 9th Embodiment

Please refer to FIG. 33 and Step X105 in FIG. 30, the fastening member 14 is shorter, thus upper end of the fastening member 14 is not upwardly passed through the impression material 51 when the cap 12 is immersed in the impression material 51, such that the impression material 51 cover and encompass the fastening member 14 and the cap 12. In this manner, the separating Step X105 may have the impression material 51 upwardly moved (the hardened impression material 51 may slightly deform), so as to separate the impression material 51 from the cap 12 and the fastening member 14. Meanwhile the cap 12 and the fastening member 14 are still retained on the gingiva 81 and the implant 9. Afterward the internal bore 91 and thread 145 are released, such that the fastening member 14 and the cap 12 are upwardly moved in order. Therefore, the cap may be put at downside of the impression material 51, which is shown in FIG. 31E.

### 10th Embodiment

Please refer to FIG. 34, the fitting portion 127 of the cap 12 is caved type, and the upside of the implant 9 has a convex 96. The fitting portion 127 and the convex 96 is matched, so that the cap 12 and the implant 9 may be engaged together.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A multi functional implanting suite for an implant utilized in tooth reconstruction, artificial tooth implanting or dental restoration, comprising:
a cap, having a main body, an inserting hole disposed in the main body and communicated to exterior of the main body, and a recognizing portion disposed around outside of the main body; and
a fastening member, having a positioning portion, a flange and a connecting portion, wherein the positioning portion and the connecting portion are respectively disposed at both axial ends of the fastening member, with the positioning portion detachably inserted into the inserting hole in specific orientation or specific azimuth, so that the flange is abutted against the main body and the connecting portion is detachably inserted into the implant.

2. The multi functional implanting suite of claim 1, wherein the flange is received in the main body when the positioning portion is inserted into the inserting hole, or the flange is received in the implant when the connecting portion is inserted into the implant.

3. The multi functional implanting suite of claim 1, further having an anti-rotational element disposed at the location between the fastening member and the implant, so that the fastening member is engaged to the implant in specific orientation or specific azimuth.

4. The multi functional implanting suite of claim 1, wherein the recognizing portion is detachably engaged to the main body.

5. A multi functional implanting suite for an implant utilized in a dental restoration, comprising:
a cap, having a main body, an inserting hole disposed in the main body and connected to exterior of the main body, a recognizing portion disposed at outside of the main body, and a fitting portion faced toward and detachably engaged to the implant; and
a fastening member having an abutting portion and a connecting portion, wherein the abutting portion and the connecting portion are respectively disposed at both axial ends of the fastening member, with the fastening member detachably inserted into the inserting hole, the abutting portion abutted against the inserting hole, and the connecting portion detachably inserted into the implant.

6. The multi functional implanting suite of claim 5, wherein the abutting portion is located in the inserting hole or located around one end of the inserting hole, or one end of the abutting portion is passed through inserting hole toward exterior of the inserting hole, when the fastening member is inserted in the inserting hole.

7. The multi functional implanting suite of claim 5, further has at least one anti-rotational element disposed on the fitting portion, such that the anti-rotational element is mated with the implant in a specific orientation or specific azimuth.

8. The multi functional implanting suite of claim 5, wherein the main body has a prime portion and an auxiliary portion disposed at radial exterior of the prime portion, such that the auxiliary portion is detachably mated with the prime portion.

9. The multi functional implanting suite of claim 8, wherein the main body has at least one coupling unit disposed around contact site of the prime portion and the auxiliary portion, such that the prime portion and the auxiliary portion is detachably fastened, positioned or orientated through the coupling unit.

10. The multi functional implanting suite of claim 5, wherein the recognizing portion is detachably engaged with the main body.

11. An implanting method for utilization of an implant suite of claim 5, comprising:
step A11: placing the implant in the underlying bone;
step A2: inserting the implanting suite into the implant, and engaging the fastening member and the implant;
step A3: selectively grinding the cap in the mouth;
step A4a: sewing the gingiva around the cap, to make appearance of the main body around the gingiva correspond to the gingiva mutually;
step A4b: selectively filling the filling material into the inserting hole to adhere the cap and the fastening member.

12. The implanting method of claim 11, wherein the step A2 has the cap engaged to the fastening member and then the connecting portion inserted into the implant; or the step A2 has the connecting portion inserted into the implant and then the cap engaged to the fastening member.

13. The implanting method of claim 12, wherein the fastening member is disposed in the inserting hole with tightly fitted.

14. The implanting method of claim 12, wherein the fastening member is screwed and fastened to the implant.

15. The implanting method of claim 11, further comprising the step of 3D oral scanning, or the step of taking mold through the impression material, or the step of fabricating a temporary crown on the cap, after step A4a or step A4b is progressed.

16. The implanting method of claim 15, wherein the following steps are further comprised after the temporary crown is fabricated:
step B7: engaging a replica, or the fastening member, or an imitating cap having the same contour with the recognizing portion and identical height to the cap, to the impression material;
step B8: modeling the impression material, imitating cap, fastening member or the replica;
step B9: separating the impression material from the cast after the cast is hardened.

17. The implanting method of claim 16, wherein the following step is further comprised after step B9 is progressed:
step B111: selectively engaging another imitating cap to the fastening member located on the cast.

18. The implanting method of claim 16, wherein the following step is further comprised after step B9 is progressed:
step B120: forming wax on the imitating cap.

19. The implanting method of claim 11, wherein the following steps are further comprised after step A4a or step A4b is progressed:
step B5: taking mold through a impression material;
step B6: separating the impression material;
step B7: engaging a replica, or the fastening member, or an imitating cap having the same contour with the recognizing portion and identical height to the cap, to the impression material;
step B8: modeling the impression material, imitating cap, fastening member or the replica;
step B9: separating the impression material from the cast after the cast is hardened.

20. The implanting method of claim 19, wherein the following step is further comprised after step B9 is progressed:
step B111: selectively engaging another imitating cap to the fastening member located on the cast.

21. The implanting method of claim 19, wherein the following step is further comprised after step B9 is progressed:
step B120: forming wax on the imitating cap.

22. The implanting method of claim 11, wherein the step A3 has the recognizing portion of the cap ground, or has outer surface of the main body ground.

23. An implanting method for utilization of an implant suite, comprising:
placing an implant in the underlying bone;
engaging a cap with the implant;
inserting a fastening member such that the cap and the implant is engaged and fastened;
oral modeling through a impression material;
separating the fastening member, impression material or the cap;
engaging a replica with the cap;
modeling the impression material.

24. The implanting method of claim 23, wherein the modeling step further comprises the following sub-steps:
placing a impression material into mouth;
pressing the impression material such that the cap is immersed in the impression material;
the impression material forming corresponding contour matching with the inside of oral cavity;
the impression material hardening.

25. The implanting method of claim 24, wherein one end of the fastening member is passed through the impression material or surrounded by the impression material after the cap is immersed in the impression material.

26. The implanting method of claim 23, wherein the modeling step further comprises the following sub-steps:
plaster material encompassing the replica such that the plaster material forms corresponding contour with the impression material;
the plaster material hardening;
separating the hardened cast and the impression material.

27. The implanting method of claim 23, wherein the fastening member, impression material or the cap separating step further comprises the following sub-steps:
separating the fastening member from the cap or from the implant;
separating the cap and the impression material.

28. The implanting method of claim 23, wherein the fastening member, impression material or the cap separating step further comprises the following sub-steps:
separating the impression material from the cap or from the fastening member;
orderly separating the fastening member and then the cap;
returning the cap to the impression material.
